(19) United States
(12) Patent Application Publication
(10) Pub. No.: US 2025/0147168 A1
(43) Pub. Date: May 8, 2025

(54) RADAR APPARATUS, METHOD FOR TRANSMITTING RADAR SIGNAL, AND RADAR SIGNAL PROCESSING APPARATUS

(71) Applicant: Panasonic Automotive Systems Co., Ltd., Kanagawa (JP)

(72) Inventor: Takaaki KISHIGAMI, Tokyo (JP)

(21) Appl. No.: 19/019,050

(22) Filed: Jan. 13, 2025

Related U.S. Application Data
(63) Continuation of application No. PCT/JP2023/036608, filed on Oct. 6, 2023.

(30) Foreign Application Priority Data
Nov. 30, 2022 (JP) 2022-191347

(51) Int. Cl. G01S 13/58; G01S 7/282; G01S 7/41

(52) U.S. Cl. CPC G01S 13/583; G01S 7/282; G01S 7/41

(57) ABSTRACT

A radar apparatus includes: transmission antennas including a first transmission antenna forming a first beam and a second transmission antenna forming a second beam different from the first beam; and transmission circuitry, which, in operation, performs multiplexing transmission of a transmission signal, to which a phase rotation corresponding to a combination of a Doppler shift amount and a code sequence has been applied, from the transmission antennas. In the apparatus, to each of the plurality of transmission antennas, the combination in which at least one of the Doppler shift amount or the code sequence is different is associated, and a first pattern of the Doppler shift amount and the code sequence that are assigned to the first transmission antenna is different from a second pattern of the Doppler shift amount and the code sequence that are assigned to the second transmission antenna.

### TECHNICAL FIELD

The present disclosure relates to a radar apparatus, a method for transmitting a radar signal, and a radar signal processing apparatus.

### BACKGROUND ART

Recently, a study of radar apparatuses using a radar transmission signal of a short wavelength including a microwave or a millimeter wave that can achieve high resolution has been carried out. Further, there has been a proposed radar apparatus, for example, in which a transmitter in addition to a receiver is provided with a plurality of antennas (array antenna), and which is configured to perform beam scanning through signal processing using the transmission and reception array antennas (which may also be referred to as a Multiple Input Multiple Output (MIMO) radar) (e.g., see Non-Patent Literature (hereinafter referred to as “NPL”) 1).

### CITATION LIST

### Patent Literature

PTL 1

Japanese Patent Application Laid-Open No. 2019-211388

PTL 2

U.S. Patent Publication No. 2022/0066012

PTL 3

Japanese Patent Application Laid-Open No. 2008-304417

PTL 4

Japanese Patent Application Laid-Open No. 2014-119344

PTL 5

Japanese Patent Application Laid-Open No. 2020-204603

PTL 6

Japanese Patent Application Laid-Open No. 2022-92247

### Non-Patent Literature

NPL 1
J. Li, and P. Stoica, “MIMO Radar with Colocated Antennas,” Signal Processing Magazine, IEEE Vol. 24, Issue: 5, pp. 106-114, 2007

NPL 2
M. Kronauge, H. Rohling, “Fast two-dimensional CFAR procedure,” IEEE Trans. Aerosp. Electron. Syst., 2013, 49, (3), pp. 1817-1823

NPL 3
Direction-of-arrival estimation using signal subspace modeling Cadzow, J. A.; Aerospace and Electronic Systems, IEEE Transactions on Volume: 28, Issue: 1 Publication Year: 1992, Page(s): 64-79

### SUMMARY OF INVENTION

However, methods for a radar apparatus (e.g., MIMO radar) to sense a target object (or a target object) have not been comprehensively studied.

A non-limiting embodiment of the present disclosure contributes to providing a radar apparatus, a method for transmitting a radar signal, and a radar signal processing apparatus that improve a detection accuracy for a target object.

A radar apparatus according to one exemplary embodiment of the present disclosure includes: a plurality of transmission antennas including a first transmission antenna that forms a first beam and a second transmission antenna that forms a second beam different from the first beam; and transmission circuitry, which, in operation, performs multiplexing transmission of a transmission signal from the plurality of transmission antennas, the transmission signal being a signal to which a phase rotation corresponding to a combination of a Doppler shift amount and a code sequence has been applied, in which,
to each of the plurality of transmission antennas, the combination in which at least one of the Doppler shift amount or the code sequence is different is associated, and a first pattern of the Doppler shift amount and the code sequence that are assigned to the first transmission antenna is different from a second pattern of the Doppler shift amount and the code sequence that are assigned to the second transmission antenna.

Note that these generic or specific exemplary embodiments may be achieved by a system, an apparatus, a method, an integrated circuit, a computer program, or a recoding medium, and also by any combination of the system, the apparatus, the method, the integrated circuit, the computer program, and the recoding medium.

According to an exemplary embodiment of the present disclosure, the sensing accuracy of a radar apparatus for a target object can be improved.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 illustrates an example of a coded Doppler multiplexing (coded Doppler Division Multiplexing (DDM)) transmission;

FIG. 2 illustrates an example of reception signals in coded Doppler multiplexing transmission;

FIG. 3 illustrates an example of a multi-beam transmission MIMO radar;

FIG. 4 illustrates an example of coded Doppler multiplexing transmission in a multi-beam transmission MIMO radar;

FIG. 5 is a block diagram showing a configuration example of a radar apparatus;

FIG. 6 illustrates an example of a transmission signal when using a chirp signal;

FIG. 7 illustrates an exemplary configuration of a Doppler shift amount and a code sequence;

FIG. 8 illustrates an example of coded Doppler multiplexing transmission;

FIG. 9 illustrates an example of reception signals in coded Doppler multiplexing transmission;

FIG. 10 illustrates an example of a multi-beam transmission MIMO radar;

FIG. 11 illustrates an example of coded Doppler multiplexing transmission;

FIG. 12 illustrates an example of coded Doppler multiplexing transmission;

FIG. 13 illustrates an example of coded Doppler multiplexing transmission;

FIG. 14 illustrates an example of coded Doppler multiplexing transmission;

FIG. 15 illustrates an example of reception signals in coded Doppler multiplexing transmission;

FIG. 16 is a flowchart illustrating an exemplary operation of separation of an coded Doppler multiplexed signal;

FIG. 17 illustrates an configuration example of a transmission antenna;

FIG. 18 illustrates an example of a MIMO antenna arrangement and a virtual reception antenna arrangement;

FIG. 19 illustrates an example of a MIMO antenna arrangement and a virtual reception antenna arrangement;

FIG. 20 illustrates an example of a multi-beam transmission MIMO radar;

FIG. 21 illustrates an example of a multi-beam transmission MIMO radar;

FIG. 22 illustrates an example of coded Doppler multiplexing transmission;

FIG. 23 illustrates an example of a multi-beam transmission MIMO radar;

FIG. 24 illustrates an example of a multi-beam transmission MIMO radar; and

FIG. 25 illustrates an example of a multi-beam transmission MIMO radar;

### DESCRIPTION OF EMBODIMENTS

### [Regarding Multi-Beam Radar]

For example, there is a method of configuring a MIMO radar using transmission antennas or reception antennas with a plurality of different directional characteristics (or simply referred to as “directivity”) in different main beam directions (hereinafter, also referred to as “beam direction,” “transmission beam direction,” or “reception beam direction”) (see, for example, PTL 1 or PTL 2).

Examples of the different directional characteristics of transmission antennas or reception antennas include directional characteristics with approximately the same beam width but different beam directions, directional characteristics with both different beam directions and beam widths, and directional characteristics with approximately the same beam direction but different beam widths.

In the following, a MIMO radar using a plurality of transmission antennas (e.g., transmission antennas forming different beams) having different directional characteristics as described above is referred to as a “multi-beam transmission MIMO radar.” Here, the multi-beam transmission MIMO radar includes a plurality of transmission antennas having different directional characteristics. The multi-beam transmission MIMO radar may be configured to include one or more transmission antennas of the same directivity.

In addition, in the following, a MIMO radar using a plurality of reception antennas (for example, reception antennas forming different beams) having different directional characteristics as described above is referred to as a “multi-beam reception MIMO radar.” Here, the multi-beam reception MIMO radar includes a plurality of reception antennas having different directional characteristics. The multi-beam reception MIMO radar may be configured to include one or more reception antennas of the same directivity.

Similarly, in the following, a MIMO radar using a plurality of transmission antennas and reception antennas having different directional characteristics as described above is referred to as “multi-beam transmission and reception MIMO radar” (or multi-beam MIMO radar).

For example, as a method of multiplexing transmission in a MIMO radar using a plurality of transmission antennas, time division multiplexing (TDM) transmission (for example, PTL 3) and Doppler division multiplexing (DDM) transmission (for example, PTL 4) are known.

Time-division multiplexing transmission or Doppler multiplexing transmission can separate the reflected waves corresponding to the transmission signals from a plurality of transmission antennas using the assigned transmission time or Doppler frequency domain. On the other hand, with time-division multiplexing transmission and Doppler multiplexing transmission, as the number of transmission antennas increases, the detection range of Doppler frequencies is likely to narrow. For example, in time-division multiplexing and Doppler multiplexing, the detectable Doppler frequency range is −1/(2Nt×Tr)≤fd<1/(2Nt×Tr), and the detection range of Doppler frequencies narrows inversely proportional to the number of transmission antennas. Here, Nt is the number of transmission antennas, and Tr is the transmission period of a transmission signal.

### [Regarding Coded Doppler Multiplexing Transmission]

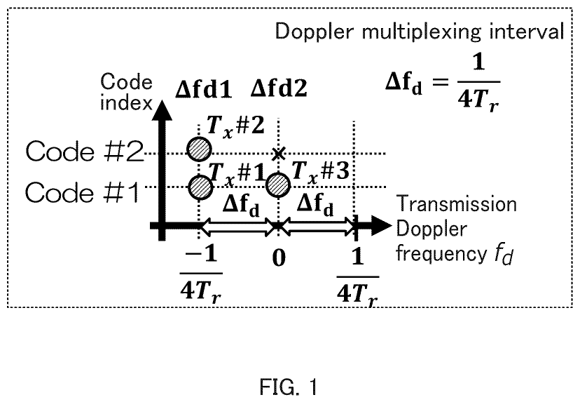

PTL 5 (for example, FIG. 1 of PTL 5) discloses a multiplexing transmission method that combines Doppler multiplexing and code multiplexing (hereinafter referred to as “coded Doppler multiplexing transmission” or “Coded DDM”).

FIG. 1 illustrates an example of the assignment of transmission Doppler frequencies and codes when radar transmission waves (for example, chirp signals) sent out for each transmission period Tr, and signals code-multiplexed with orthogonal codes (for example, code #1 and code #2) having a code length Loc=2 are transmitted to three transmission antennas (for example, Tx #1, Tx #2, and Tx #3) by using two Doppler multiplexed signals (for example, Δfd1 and Δfd2).

The phase rotation based on the code is performed, for example, by cyclically repeating the operation of applying the phase rotation to a chirp signal at a transmission period Loc×Tr (in FIG. 1, two transmission periods (2Tr)) for the code length. At this time, the phase rotation based on the Doppler multiplexed signal is constant in a transmission period of a code length (in FIG. 1, two transmission periods (2Tr)) to which a code for code length 2 is applied. For example, the phase rotation based on the Doppler multiplexed signal may be varied and applied every 2Tr transmission period.

For example, in FIG. 1, the transmission Doppler shift amounts to be assigned are set to Δfd1=−1/(4Tr) and Δfd2=0 [Hz], respectively. For example, since transmission Doppler shift amount Δfd1 is applied to each nth transmission period, phase rotation Φ₁(n)=ΔΦ₁×(floor(n/Loc)+1) is applied to the radar transmission wave (chirp signal). Further, since transmission Doppler shift amount Δfd2 is applied to each nth transmission period, phase rotation Φ₂(n)=ΔΦ₂×(floor(n/Loc)+1) is applied to the radar transmission wave (chirp signal). Here, ΔΦ₁=−π and ΔΦ₂=0. The Doppler multiplexing interval is Δf_{d}=1/(4Tr). Further, orthogonal codes with a code length of 2, such as code #1=[1, 1] and code #2=[1,−1], may be used. In FIG. 1, for example, DopCode #1=(Δfd1, code #1), DopCode #2=(Δfd1, code #2), and DopCode #3=(Δfd2, code #1) are assigned to transmission antennas Tx #1, Tx #2, and Tx #3, respectively, and are transmitted as coded Doppler multiplexed signals in which Doppler multiplexed signals and codes are combined. In addition, floor [x] is an operator for outputting the maximum integer that does not exceed real number x.

These simultaneously multiplexed signals are received by a radar apparatus (for example, a reception signal processor). The radar apparatus, for example, performs Doppler frequency analysis on the radar reflected wave reception signals in separate Doppler analyzers (for example, V-FFT #1 and V-FFT #2) for each transmission period of the code length, for example, the reception signal for each odd-numbered transmission period and the reception signal for each even-numbered transmission period, and separates and receives the multiplexed transmission signals by performing code demultiplexing and Doppler demultiplexing based on the output of the Doppler frequency analysis.

Here, since the radar apparatus (for example, the Doppler analyzer) uses reception signals of the transmission period of the code length (Loc=2 in FIG. 1) (2 transmission periods (2Tr) in FIG. 1), the Doppler frequency exceeding ±1/(2 Loc Tr)(±1/(4Tr) in FIG. 1) is detected by aliasing. Whether the radar reflected wave reception signal includes a component in the frequency range of aliasing is determined using, for example, an coded Doppler multiplexed signal (DopCode #4=(Δfd2, code #1) in FIG. 1) of a combination of an unused code to which no transmission antenna is assigned and a Doppler multiplexed signal, as disclosed in PTL 5. For example, whether the radar reflected wave reception signal includes a component in the frequency range of the aliasing is determined by utilizing the fact that the reception power of a signal obtained by performing code demultiplexing and Doppler demultiplexing on an coded Doppler multiplexed signal, which is a combination of an unused code to which no transmission antenna is assigned and a Doppler multiplexed signal, is approximately at the noise level.

As described above, the radar apparatus can detect the presence or absence of an aliasing signal by making the code multiplexing number between Doppler multiplexed signals non-uniform, performing multiplexing transmission from a plurality of transmission antennas, and detecting the reception signal level. Additionally, the radar apparatus can expand the Doppler frequency range (maximum Doppler) in which Doppler frequency can be detected without aliasing to +1/(2Tr), and also determine the transmission antenna.

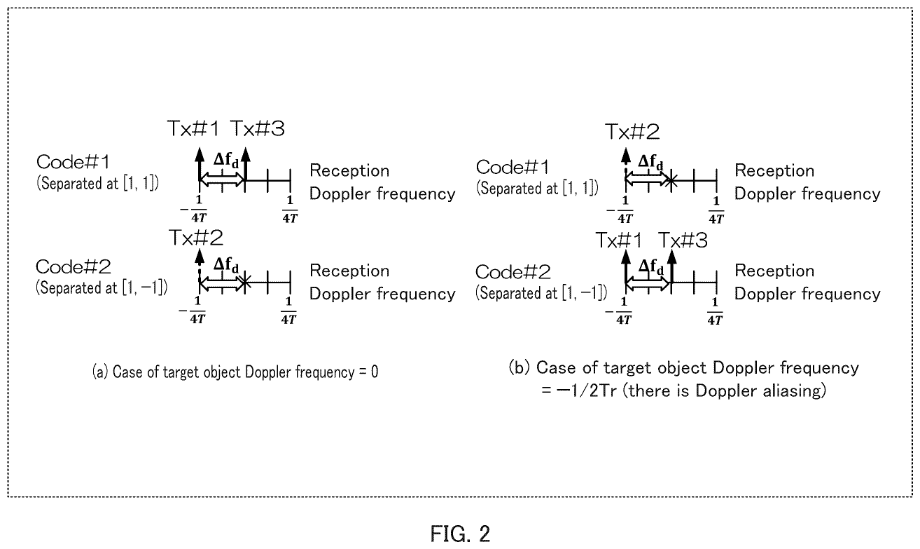

For example, part (a) in FIG. 2 illustrates the reception Doppler signals when the target object has a Doppler frequency fdtarget object=0 and the coded Doppler multiplexed signals illustrated in FIG. 1 are separated using code #1 and code #2, respectively. As illustrated at part (a) in FIG. 2, the reception Doppler multiplexed signal separated by code #1 is detected with a high reception level at two Doppler frequencies that match Doppler multiplexing interval Δf_{d} between Δfd1 and Δfd2, and the radar apparatus can determine these components as reception signals of Tx #1 and Tx #3. Further, as illustrated at part (a) in FIG. 2, one Doppler frequency with a high reception level is detected in the reception Doppler signal separated by code #2, and the reception level of the Doppler frequency in the Doppler frequency interval that matches the Doppler multiplexing interval Δf_{d} between Δfd1 and Δfd2 for the detected Doppler frequency is approximately the noise level. Therefore, the radar apparatus can determine that one component of the Doppler frequency with a high reception level is a reception signal of Tx #2. Further, the radar apparatus can determine the Doppler frequency of the target object because the deviation amount from the Doppler shift amount at the time of transmission for each transmission antenna is the Doppler frequency of the target object.

Further, for example, part (b) in FIG. 2 illustrates the reception Doppler signal when the target object has a Doppler frequency fdtarget object=−1/(2Tr) and the coded Doppler multiplexed signals illustrated in FIG. 1 are separated using code #1 and code #2. As illustrated at part (b) in FIG. 2, the reception Doppler signal separated by code #2 is detected with a high reception level at two Doppler frequencies that match the Doppler multiplexing interval Δf_{d} between Δfd1 and Δfd2, and the radar apparatus can determine these components as reception signals of Tx #1 and Tx #3. Further, as illustrated at part (b) in FIG. 2, one Doppler frequency with a high reception level is detected in the reception Doppler signal separated by code #1, and the reception level of the Doppler frequency in the Doppler frequency interval that matches the Doppler multiplexing interval Δf_{d} between Δfd1 and Δfd2 for the detected Doppler frequency is approximately the noise level. Therefore, the radar apparatus can determine that one component of the Doppler frequency with a high reception level is a reception signal of Tx #2.Further, the radar apparatus can determine the Doppler frequency of the target object because the deviation amount from the Doppler shift amount at the time of transmission for each transmission antenna becomes the Doppler frequency of the target object.

Note that, when the Doppler frequency of the target object is −1/(2Tr)≤fdtarget object<−1/(4Tr) or 1/(4Tr)≤fdtarget object<1/(2Tr), the Doppler analyzer (for example, V-FFT #1 and V-FFT #2) observes an aliasing Doppler frequency. At this time, the actual Doppler frequency differs from the Doppler frequency detected in the Doppler analyzer (V-FFT #1 and V-FFT #2) by a phase difference of 2π between the transmission periods of 2Tr, and thus, a x phase rotation is applied between the detection time differences Tr between V-FFT #1 and V-FFT #2. Accordingly, when the reception signal of Tx #2 is determined in the separation of code #1 as illustrated at part (b) in FIG. 2, the radar apparatus can determine that there is aliasing.

By such separation and reception processing of coded Doppler multiplexed signals, the radar apparatus can estimate the Doppler frequency of the radar reflected wave in the Doppler frequency range of ±1/(2 Tr). As described above, by performing coded Doppler multiplexing transmission, the detectable Doppler frequency range is expanded to ±½Tr. For example, the detectable Doppler frequency range is expanded by Nt times compared to that in PTL 3 or 4.

### [Regarding Application of Coded Doppler Multiplexing Transmission to Multi-Beam Transmission MIMO Radar]

As described above, a MIMO radar using coded Doppler multiplexing (for example, also referred to as “coded DDM”) is different from a MIMO radar using Doppler multiplexing transmission (DDM) in that a part of the Doppler frequency domain is not assigned to the transmission signal, and the MIMO radar performs separation processing of a Doppler multiplexed signal (hereinafter, referred to as “coded Doppler demultiplexing”) to estimate the Doppler frequency of a target object based on the reception power of the reception Doppler frequency of a reflected wave from the target object after code demultiplexing.

Therefore, the following can be assumed when applying coded Doppler multiplexing to a multi-beam transmission MIMO radar.

In a multi-beam transmission MIMO radar, for example, the reception level of a reflected wave may significantly vary depending on the beam direction (or transmission beam direction) and the target object direction. In a multi-beam transmission MIMO radar, the reflected wave reception level from the transmission antennas may vary significantly between when the beam direction and target object direction coincide with each other and when the beam direction and target object direction do not coincide. Therefore, in a multi-beam transmission MIMO radar, in the case of performing multiplexing transmission by using coded Doppler multiplexing, when the difference (or ratio) in the reflected wave reception levels between multi-beams in different beam directions is large, it may become difficult to perform Doppler demultiplexing using coded Doppler multiplexing. When Doppler demultiplexing becomes difficult, the detection performance of a target object in a MIMO radar may deteriorate, or the Doppler demultiplexing may be performed incorrectly, resulting in Doppler misestimation or deterioration in the angle measurement performance.

Hereinafter, an example in which Doppler demultiplexing is difficult in a multi-beam transmission MIMO radar that uses coded Doppler multiplexing will be described.

For example, a 4Tx MIMO radar including two transmission antennas in each of two beam directions will be described. For example, the number of transmission antennas corresponding to the respective two beam directions are represented as “N_{TxBeam #1}” and “N_{TxBeam #2}” (N_{TxBeam #1}=N_{TxBeam #2}=2).

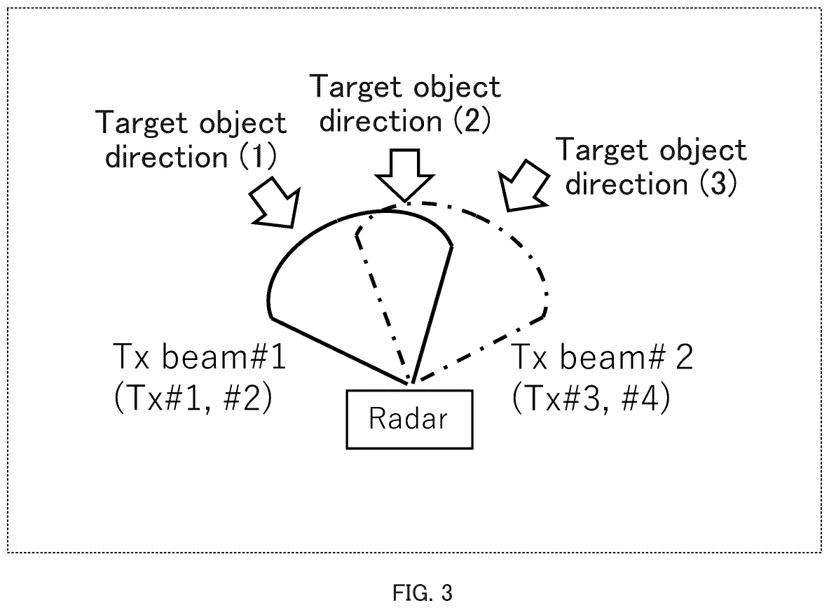

For example, a multi-beam transmission MIMO radar that forms transmission beams (TxBeam #1 and TxBeam #2) in two different directions using two of four transmission antennas Tx #1, Tx #2, Tx #3, and Tx #4 will be described as illustrated in FIG. 3. In FIG. 3, the transmission beam (beam direction) of Tx #1 and Tx #2 is referred to as TxBeam #1, and the transmission beam (beam direction) of Tx #3 and Tx #4 is referred to as TxBeam #2. Further, for example, the directional characteristics of the reception antenna may be omnidirectional, or may be substantially uniform within a viewing angle (field of view: FOV) covered by a plurality of transmission antennas having different directivities.

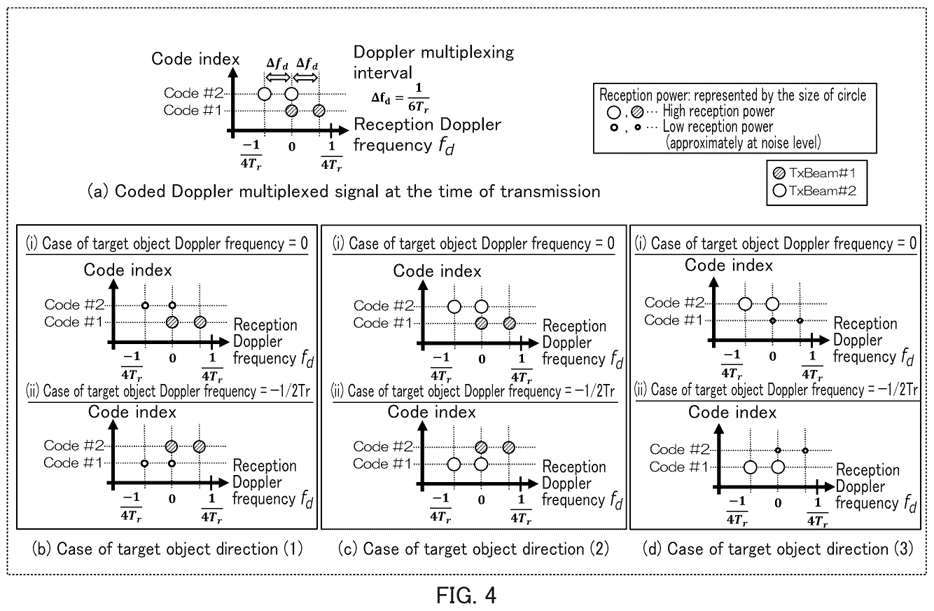

For example, a case where Doppler multiplexed signals coded with Doppler multiplexing number N_{DM}=3 and code multiplexing number N_{CM}=2 are assigned to four transmission antennas Tx #1, Tx #2, Tx #3, and Tx #4 as illustrated at part (a) in FIG. 4 will be described.

For example, when the target object direction is target object direction (1) illustrated in FIG. 3, the direction of the reflected waves corresponding to the radar transmission waves transmitted from Tx #1 and Tx #2 forming TxBeam #1 coincides with target object direction (1).

Therefore, as illustrated at part (b) in FIG. 4, the reception level (for example, the reflected wave reception level) of the reception signals corresponding to Tx #1 and Tx #2 that form TxBeam #1 becomes relatively high.

On the other hand, when the target object direction is target object direction (1) illustrated in FIG. 3, the direction of the reflected wave corresponding to the radar transmission wave transmitted from Tx #3 and Tx #4 that form TxBeam #2 does not coincide with target object direction (1), and target object direction (1) corresponds to the directional null direction of TxBeam #2 (hereinafter, also referred to as the null direction).

Therefore, for example, as illustrated at part (b) in FIG. 4, the reception level of the reception signal corresponding to Tx #3 and Tx #4 that form TxBeam #2 is lower than the reception level of the reception signal corresponding to TxBeam #1 (Tx #1 and Tx #2). For example, the reception level corresponding to TxBeam #2 may significantly differ from the reception level corresponding to TxBeam #1, and may become 10 dB or more lower depending on the beam directional characteristic in the null direction of TxBeam #2.

Further, for example, when the target object direction is an intermediate direction between the beam direction of TxBeam #1 and the beam direction of TxBeam #2, and the beam widths of both beams (each of which is about 3 dB or 6 dB of the beam) are in the direction of the overlapping area (for example, in the case of target object direction (2) illustrated in FIG. 3), the reflected wave corresponding to the radar transmission waves transmitted from Tx #1 and Tx #2 that form TxBeam #1 and the reflected waves corresponding to the radar transmission waves transmitted from Tx #3 and Tx #4 that form TxBeam #2 are received at substantially the same level, as illustrated at part (c) in FIG. 4.

Further, for example, when the target object direction is target object direction (3) illustrated in FIG. 3, the direction of the reflected waves corresponding to the radar transmission waves transmitted from Tx #3 and Tx #4 that form TxBeam #2 coincides with target object direction (3).

Therefore, as illustrated at part (d) in FIG. 4, the reception level (for example, the reflected wave reception level) of the reception signals corresponding to Tx #3 and Tx #4 that form TxBeam #2 becomes relatively high.

On the other hand, when the target object direction is target object direction (3) illustrated in FIG. 3, the direction of the reflected wave corresponding to the radar transmission waves transmitted from Tx #1 and Tx #2 that form TxBeam #1 does not coincide with target object direction (3), and target object direction (3) corresponds to the null direction of TxBeam #1. Therefore, for example, as illustrated at part (d) in FIG. 4, the reception level of the reception signals corresponding to Tx #1 and Tx #2 that form TxBeam #1 is lower than the reception level of the reception signals corresponding to TxBeam #2 (Tx #3 and Tx #4). For example, the reception level corresponding to TxBeam #1 may significantly differ from the reception level corresponding to TxBeam #2, and may become 10 dB or more lower depending on the beam directional characteristic in TxBeam #1.

For example, in a case as illustrated at part (c) in FIG. 4, the reception level of the reflected wave corresponding to the radar transmission wave transmitted from Tx #1 and Tx #2 that form TxBeam #1 and the reception level of the reflected wave corresponding to the radar transmission wave transmitted from Tx #3 and Tx #4 that form TxBeam #2 are substantially the same. Since the code multiplexing number between Doppler multiplexed signals is non-uniform, the multi-beam transmission MIMO radar can determine, based on the reception levels of these reception signals, which transmission antenna used for coded Doppler multiplexing transmission the detected Doppler frequency peak corresponds to. Further, at part (c) in FIG. 4, Doppler frequency fd of the target object reflected wave can be determined in the range of −1/(2Tr)≤fd<1/(2Tr).

On the other hand, in a case such as part (b) in FIG. 4 or part (d) in FIG. 4, the multi-beam transmission MIMO radar has difficulty in determining whether the reception level of the reflected waves corresponding to the radar transmission waves transmitted from Tx #1 and Tx #2 that form TxBeam #1 has decreased (for example, in the case of part (d) in FIG. 4) or whether the reception level of the reflected waves corresponding to the radar transmission waves transmitted from Tx #3 and Tx #4 that form TxBeam #2 has decreased (for example, in the case of part (b) in FIG. 4) based on the reception level of the reception signal, because the Doppler frequency of the target object is unknown.

Therefore, it is difficult for the multi-beam transmission MIMO radar to determine, based on the reception levels of these reception signals, which transmission antenna used for coded Doppler multiplexing transmission the detected Doppler frequency peak corresponds to. Therefore, it becomes difficult for the multi-beam transmission MIMO radar to separate the Doppler multiplexed signals, and it becomes difficult to determine Doppler frequency fd of the reflected wave (for example, referred to as “target object reflected wave”) from the target object within the range of −1/(2Tr)≤fd<1/(2Tr).

As described above, in the coded Doppler multiplexing, the coded Doppler demultiplexing processing is performed on the assumption that the reception levels of the reflected waves corresponding to respective transmission antennas are substantially the same, and that the reception level of the Doppler multiplexing interval, which is not Doppler multiplexed, is sufficiently low, approximately at the noise level. In a multi-beam transmission MIMO radar using coded Doppler multiplexing, as shown in (b) and part (d) in FIG. 4, there may be cases where the assumption in the separation processing of the coded Doppler multiplexing is broken (for example, when the reception level corresponding to a part of the beams decreases), potentially leading to errors in the coded Doppler demultiplexing processing.

In a non-limiting embodiment of the present disclosure, a method for improving the detection performance of a multi-beam transmission MIMO radar using coded Doppler multiplexing transmission will be described.

Embodiments according to exemplary embodiments of the present disclosure will be described below in detail with reference to the accompanying drawings. In the embodiments, the same constituent elements are identified with the same numerals, and a description thereof is omitted because of redundancy.

The following describes a configuration of a radar apparatus (for example, MIMO radar configuration) having a transmitting branch in which multiplexed different transmission signals are simultaneously sent from a plurality of transmission antennas, and a receiving branch in which the transmission signals are separated and subjected to reception processing.

Further, by way of example, a description will be given below of a configuration of a radar system using a frequency-modulated pulse wave such as a chirp pulse (e.g., also referred to as chirp pulse transmission (fast chirp modulation)). However, the modulation scheme is not limited to frequency modulation. For example, an exemplary embodiment of the present disclosure is also applicable to a radar system that uses a pulse compression radar configured to perform phase modulation or amplitude modulation on a pulse train to transmit a pulse train.

Further, the radar apparatus performs Doppler multiplexing transmission, for example. In addition, in the Doppler multiplexing transmission, the radar apparatus multiplexes and transmits signals by encoding (for example, performing code division multiplexing (CDM) on) the signals to which different phase rotations are applied, (for example, phase shifts, and the number of the phase rotations corresponds to the Doppler multiplexing number) (hereinafter, such signals are referred to as “Doppler multiplexed transmission signals,” and such multiplexing is referred to as “Coded Doppler Multiplexing”).

### [Configuration of Radar Apparatus]

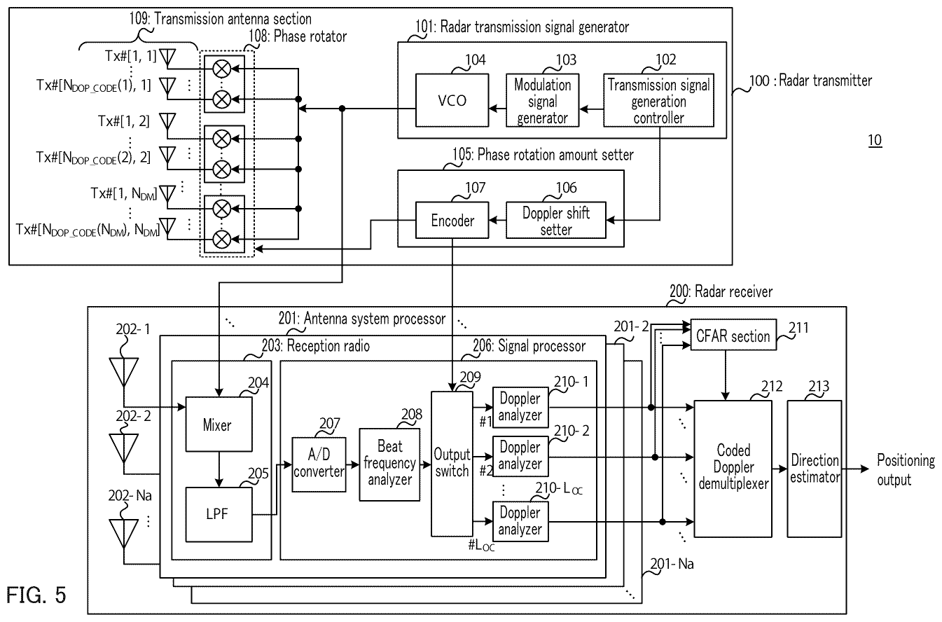

Radar apparatus 10 illustrated in FIG. 5 includes radar transmitter (transmission branch) 100 and radar receiver (reception branch) 200.

Radar transmitter 100 generates radar signals (radar transmission signals) and transmits the signals using transmission antenna section 109 (for example, a transmission array antenna) constituted by a plurality of transmission antennas (for example, Nt antennas) at a specified transmission period (hereinafter, referred to as “radar transmission period”).

Radar receiver 200 receives reflected wave signals, which are radar transmission signals reflected by a target object (not illustrated) using reception antenna section 202 (for example, a reception array antenna) including a plurality of reception antennas 202-1 to 202-Na. Radar receiver 200 performs signal processing on the reflected wave signals received by respective reception antennas, and outputs information (for example, positioning information) related to the estimation result by, for example, detecting the presence or absence of a target object or estimating the arrival distance, the Doppler frequency (for example, relative velocity), and the arrival direction of the reflected wave signal.

Note that radar apparatus 10 may be mounted on a mobile body such as a vehicle, and the positioning output (for example, information on the estimation result) of radar receiver 200 may be connected to a control apparatus ECU (Electronic Control Unit) (not illustrated) such as an advanced driver assistance system (ADAS) or an automatic driving system that enhances collision safety, and may be used for vehicle drive control or alarm call control.

Radar apparatus 10 may also be mounted on a relatively high structure (not illustrated), such as, for example, a roadside utility pole or traffic lights. Radar apparatus 10 may also be utilized, for example, as a sensor of a support system for enhancing the safety of passing vehicles or pedestrians, or as a sensor of a suspicious intrusion prevention system (not illustrated). The positioning output of radar receiver 200 may also be connected, for example, to a control device (not illustrated) in the support system or the suspicious intrusion prevention system for enhancing safety and may be utilized for an alarm call control or an abnormality detection control. The use of radar apparatus 10 is not limited to the above, and may also be used for other uses.

In addition, the target object is an object to be detected by radar apparatus 10. Examples of the target object include vehicles (including four-wheel and two-wheel vehicles), people, blocks, and curbs.

### [Configuration of Radar Transmitter 100]

Radar transmitter 100 includes radar transmission signal generator 101, phase rotation amount setter 105, phase rotator 108, and transmission antenna section 109. Note that, radar transmission signal generator 101, phase rotation amount setter 105, and phase rotator 108 may be collectively referred to as transmission circuitry.

Radar transmission signal generator 101 generates a radar transmission signal. Radar transmission signal generator 101 includes, for example, transmission signal generation controller 102, modulation signal generator 103, and Voltage Controlled Oscillator (VCO) 104. Hereinafter, the components of radar transmission signal generator 101 will be described.

Transmission signal generation controller 102 configures, for example, transmission signal generation timing for each radar transmission period, and outputs information on the configured transmission signal generation timing to modulation signal generator 103 and phase rotation amount setter 105 (e.g., Doppler shift setter 106). The radar transmission period is herein represented by Tr.

Modulation signal generator 103 periodically generates, for example, saw-toothed modulation signals based on the information on the transmission signal generation timing for each radar transmission period Tr inputted from transmission signal generation controller 102.

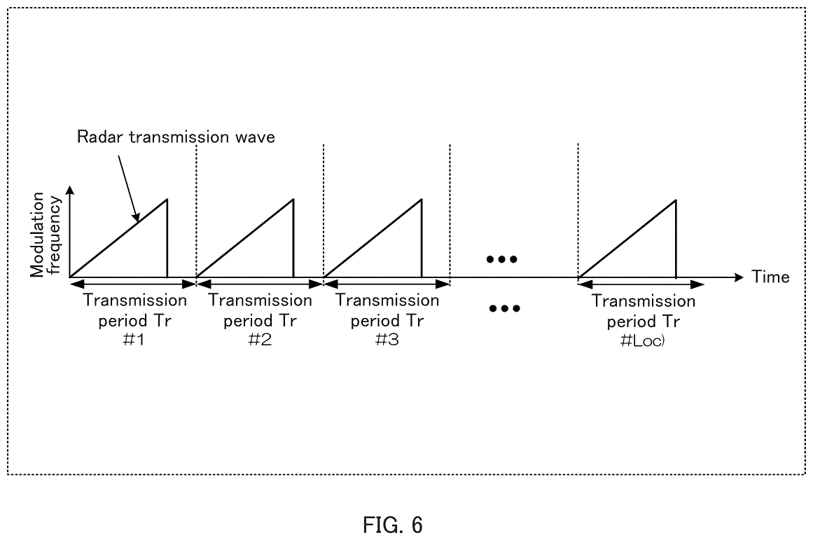

VCO 104 outputs frequency modulation signals (hereinafter, for example, referred to as frequency chirp signal or chirp signal) as radar transmission signals (radar transmission wave) as illustrated in FIG. 6, for example, to phase rotator 108 and radar receiver 200 (mixer 204 to be described later) based on the modulation signal inputted from modulation signal generator 103.

Phase rotation amount setter 105 configures a phase rotation amount (for example, the phase rotation amount corresponding to the coded Doppler multiplexing transmission) to be applied to a radar signal in phase rotator 108 for each radar transmission period Tr based on information on the transmission signal generation timing for each radar transmission period Tr inputted from transmission signal generation controller 102. Phase rotation amount setter 105 includes, for example, Doppler shift setter 106 and encoder 107.

Doppler shift setter 106 configures a phase rotation amount to be applied to a radar transmission signal (e.g., chirp signal) and corresponding to a Doppler shift amount, for example, based on the information on the transmission signal generation timing for each radar transmission period Tr.

Encoder 107 configures a phase rotation amount corresponding to coding, for example, based on the information on the transmission signal generation timing for each radar transmission period Tr. Encoder 107 calculates the phase rotation amount for phase rotator 108 based on, for example, the phase rotation amount outputted from Doppler shift setter 106 and the phase rotation amount corresponding to the coding, and outputs the phase rotation amount to phase rotator 108. Further, encoder 107 outputs, for example, information on code sequences used for coding (for example, elements of orthogonal code sequences) to radar receiver 200 (for example, output switch 209).

Phase rotator 108 applies the phase rotation amount inputted from encoder 107 to the chirp signal inputted from VCO 104, and outputs the signal after the phase rotation to transmission antenna section 109. For example, each of phase rotators 108 includes a phase shifter, a phase modulator, and the like (not illustrated). The output signal of phase rotator 108 is amplified to a specified transmission power and radiated into space from each transmission antenna. For example, the radar transmission signals are multiplexed and transmitted from a plurality of transmission antennas by each being assigned a phase rotation amount corresponding to a combination of a Doppler shift amount and an orthogonal code sequence.

Next, an example of a configuration method for the phase rotation amount in phase rotation amount setter 105 will be described.

Doppler shift setter 106 sets phase rotation amount φ_{ndm} for applying Doppler shift amount DOP_{ndm}, and outputs the phase rotation amount to encoder 107. Here, ndm=1 to N_{DM}. N_{DM} is the number of different Doppler shift amounts, and hereinafter is referred to as the “Doppler multiplexing number.”

In radar apparatus 10, since encoding by encoder 107 is used in combination, Doppler multiplexing number N_{DM} may be set to be smaller than number Nt of transmission antennas used for multiplexing transmission. Note that Doppler multiplexing number N_{DM} is two or more.

Doppler shift amounts DOP₁, DOP₂, . . . , DOP_{N_DM} (where “N_DM” is also represented as “N_{DM}”) may be, for example, set to even intervals or may be set to uneven intervals. Doppler shift amounts DOP₁, DOP₂, . . . , DOP_{N_DM} may be set to satisfy, for example, 0≤DOP₁, DOP₂, . . . , DOP_{N_DM}< (1/TrL_{oc}) in order to be used in combination with encoding by encoder 107 described later. Alternatively, Doppler shift amounts DOP₁, DOP₂, . . . , and DOP_{N_DM} may be set to satisfy, for example, Expression 1.

$$\begin{matrix}[ 1 ] & \\ \frac{- 1}{2 {T}_{r} {L}_{oc}} \leq {DOP}_{1} , {DOP}_{2} , ∼ , {DOP}_{N \_ DM} < \frac{1}{2 {T}_{r} {L}_{oc}} & ( Expression 1 )\end{matrix}$$

Further, for example, minimum Doppler shift interval Δf_{MinInterval} among Doppler shift amounts DOP₁, DOP₂, . . . , and DOP_{N_DM} may satisfy the following Expression 2. Note that the Doppler shift interval (also referred to as the Doppler multiplexing interval or the Doppler interval) may be defined as the absolute value of the difference between any two of Doppler shift amounts DOP₁, DOP₂, . . . , and DOP_{N_DM}. Here, Loc represents the number of code elements. For example, Loc represents the code length of a code used in encoder 107.

$$\begin{matrix}[ 2 ] & \\ 0 < Δ {f}_{MinInterval} \leq \frac{1}{{T}_{r} {N}_{DM} {L}_{oc}} & ( Expression 2 )\end{matrix}$$

Further, phase rotation amount φ_{ndm} for applying each of Doppler shift amounts DOP₁, DOP₂, . . . , DOP_{N_DM} may be assigned, for example, as in the following Expression 3.

$$\begin{matrix}[ 3 ] & \\ {ϕ}_{ndm} = 2 π {DOP}_{ndm} / ( \frac{1}{{T}_{r} {L}_{oc}} ) & ( Expression 3 )\end{matrix}$$

Note that, when a Doppler shift amount with an interval (even interval) of Δf_{MinInterval} is set (hereinafter, referred to as “even interval Doppler shift amount setting”), phase rotation amount φ_{ndm} for applying Doppler shift amount DOP_{ndm} is assigned, for example, as in the following Expression 4.

$$\begin{matrix}[ 4 ] & \\ {ϕ}_{ndm} = 2 π ( ndm - 1 ) Δ {f}_{MinInterval} / ( \frac{1}{{T}_{r} {L}_{oc}} ) & ( Expression 4 )\end{matrix}$$

Note that, the narrower the minimum Doppler shift interval Δf_{MinInterval} is, the more likely interference between Doppler multiplexed signals is to occur, and the more likely the target object detection accuracy is to be reduced (for example, deteriorated). Therefore, it is preferable to further widen the interval of the Doppler shift amounts within a range that satisfies the constraint condition of Expression 2. For example, when the equality holds in Expression 2 (for example, Δf_{MinInterval}=1/(TᵣN_{DM}L_{OC})), the interval in the Doppler domain between Doppler multiplexed signals can be maximized (hereinafter, referred to as “maximum even interval Doppler shift amount setting”). In this case, Doppler shift amounts DOP₁, DOP₂, . . . , and DOP_{N_DM} are equally divided into N_{DM} parts in a phase rotation range of 0 or more and less than 2π, and different phase rotation amounts are assigned to respective parts. For example, phase rotation amount φ_{ndm} for applying Doppler shift amount DOP_{ndm} is assigned as in the following Expression 5. Note that, in the following, the angle is expressed in radian.

$$\begin{matrix}[ 5 ] & \\ {ϕ}_{ndm} = \frac{2 π ( ndm - 1 )}{{N}_{DM}} & ( Expression 5 )\end{matrix}$$

In Expression 5, for example, in the case of Doppler multiplexing number N_{DM}=2, phase rotation amount φ₁ for applying Doppler shift amount DOP₁ is 0, and phase rotation amount φ₂ for applying Doppler shift amount DOP₂ is π. For example, phase rotation amount φ_{ndm} to which each Doppler shift amount DOP_{ndm} is applied is an even interval.

Note that the assignment of the phase rotation amounts for applying Doppler shift amounts DOP₁, DOP₂, . . . , and DOP_{N_DM} is not limited to such an assignment method. For example, phase rotation amounts φ₁, φ₂, . . . , φ_{N_DM} (where “N_DM” corresponds to N_{DM}) may be randomly assigned to Doppler shift amounts DOP₁, DOP₂, . . . , DOP_{N_DM} using an assignment table of phase rotation amounts.

Further, in the even interval Doppler shift amount setting, the phase rotation amount may be set as in the following Expression 6 by setting Δf_{MinInterval}=1/(Tᵣ(N_{DM}+Nᵢₙₜ)L_{OC}) in Expression 4. Here, Nᵢₙₜ is an integer value.

$$\begin{matrix}[ 6 ] & \\ {ϕ}_{ndm} = \frac{2 π ( ndm - 1 )}{{N}_{DM} + {N}_{int}} & ( Expression 6 )\end{matrix}$$

For each of phase rotation amounts φ₁ to φ_{N_DM} for applying N_{DM} Doppler shift amounts inputted from Doppler shift setter 106, encoder 107 sets one or a plurality of phase rotation amounts based on one or a plurality of orthogonal code sequences of N_{CM} or less. Further, encoder 107 sets the phase rotation amounts based on both the Doppler shift amounts and the orthogonal code sequences, for example, the “coded Doppler phase rotation amounts” for generating coded Doppler multiplexed signals, and outputs the coded Doppler phase rotation amounts to phase rotators 108.

An exemplary operation of encoder 107 will be described below.

For example, encoder 107 preferably uses code sequences with code number N_{CM} (N_{CM} is, for example, code multiplexing number) each having a code length Loc, which are mutually less correlated or uncorrelated, and uses, for example, orthogonal code sequences. Note that, code elements constituting an orthogonal code sequence are not limited to real numbers and may include complex number values.

Hereinafter, N_{CM} orthogonal code sequences each having code length Loc will be represented as Code_{ncm}={OC_{ncm}(1), OC_{ncm}(2), . . . , OC_{ncm}(Loc)}. OC_{ncm}(noc) represents the noc-th code element in the ncm-th orthogonal code sequence Code_{ncm}. Here, noc is an index of a code element, and noc=1 to Loc.

The orthogonal code sequence used in encoder 107 may be, for example, a Walsh-Hadamard code. Encoder 107 generates an orthogonal code sequence using a predetermined code length Loc capable of generating orthogonal code sequences with code number N_{CM}.

For example, in the case of N_{CM}=2, the code length Loc of the Walsh-Hadamard code is 2, and the orthogonal code sequences are Code₁={1, 1} and Code₂={1,−1}.

In encoder 107, the code multiplexing number (hereinafter referred to as the coded Doppler multiplexing number) when encoding Doppler multiplexed signals with ndm-th Doppler shift amount DOP_{ndm} inputted from Doppler shift setter 106 is represented as “N_{DOP_CODE}(ndm).” Here, ndm=1 to N_{DM}.

Encoder 107 sets coded Doppler multiplexing number N_{DOP_CODE}(ndm) such that the sum of coded Doppler multiplexing numbers N_{DOP_CODE}(1), N_{DOP_CODE}(2), . . . , and N_{DOP_CODE}(N_{DM}) when encoding Doppler multiplexed signals is equal to number Nt of transmission antennas used for multiplexing transmission, for example. Thus, radar apparatus 10 can perform multiplexing transmission (hereinafter, referred to as coded Doppler multiplexing transmission) in the Doppler domain and the code domain using Nt transmission antennas.

Further, encoder 107 may be configured to include different coded Doppler multiplexing numbers in a range of one or more to Ncm or less with respect to coded Doppler multiplexing numbers N_{DOP_CODE}(1), N_{DOP_CODE}(2), . . . , N_{DOP_CODE}(N_{DM}), for example, by using an even interval Doppler shift amount setting including a maximum even interval Doppler shift amount setting. For example, encoder 107 sets coded Doppler multiplexing number N_{DOP_CODE}(ndm) corresponding to at least one Doppler shift amount DOP_{ndm} to be smaller than N_{CM}, without setting the code number N_{CM} to Ncm for all coded Doppler multiplexing numbers. Thus, in a plurality of combinations of Doppler shift amounts DOP_{ndm} and orthogonal code sequences, the multiplexing number (coded Doppler multiplexing number) N_{DOP_CODE}(ndm) by the orthogonal code sequence associated with at least one Doppler shift amount DOP_{ndm} may be different from the coded Doppler multiplexing number associated with another Doppler shift amount. For example, encoder 107 sets non-uniformly the coded Doppler multiplexing numbers for the Doppler multiplexed signals. With this configuration, radar apparatus 10 can individually separate and receive signals to which coded Doppler multiplexing transmission is performed by a plurality of transmission antennas over a Doppler range of ±½Tr, for example, by the aliasing determination processing in the reception processing described later.

Encoder 107 sets coded Doppler phase rotation amount ψ_{ndop_code(ndm), ndm}(m) for phase rotation amount φ_{ndm} that applies n_{dm}-th Doppler shift amount DOP_{ndm} in mth transmission period Tr, as shown in the following Expression 7, and outputs the coded Doppler phase rotation amount to phase rotator 108.

$$\begin{matrix}[ 7 ] & \\ {ψ}_{ndop \_ code ( ndm ) , ndm} ( m ) = floor [ \frac{( m - 1 )}{L o c} ] \times {ϕ}_{ndm} + angle [ {OC}_{ndop \_ code ( ndm )} ( OC\_INDEX ) ] & ( Expression 7 )\end{matrix}$$

Here, the subscript “ndop_code(ndm)” represents an index equal to or less than coded Doppler multiplexing number N_{DOP_CODE}(ndm) for the phase rotation amounts φ_{ndm} that apply Doppler shift amounts DOP_{ndm}. For example, ndop_code(ndm)=1, . . . , N_{DOP_CODE}(ndm). Further, angle[x] is an operator that outputs the radian phase of real number x, and is, for example, angle[1]=0, angle[−1]=x, and angle[j]=π/2. The character “j” is an imaginary unit.

For example, as shown in Expression 7, coded Doppler phase rotation amount ψ_{ndop_code(ndm), ndm}(m) makes a phase rotation amount for applying Doppler shift amount DOP_{ndm} constant in a period of a transmission period of code length Loc used for encoding (for example, the first term in Expression 7), and applies a phase rotation amount corresponding to each of Loc code elements OC_{ndop_code(ndm)}(1), . . . , OC_{ndop_code(ndm)}(Loc) of Code_{ndop_code(ndm)} used for encoding (the second term in Expression 7).

Further, encoder 107 outputs, in each transmission period (Tr), orthogonal code element index OC_INDEX to radar receiver 200 (output switch 209 described below). OC_INDEX is an orthogonal code element index that indicates an element of orthogonal code sequence Code_{ndop_code(ndm)}, and is cyclically variable in a range of 1 to Loc for each transmission period (Tr) as in the following Expression 8.

$$\begin{matrix}[ 8 ] & \\ OC\_INDEX = mod ( m - 1 , Loc ) + 1 & ( Expression 8 )\end{matrix}$$

Here, mod(x, y) denotes a modulo operator and is a function that outputs the remainder after x is divided by y. Further, m=1 to Nc. Nc denotes the number of transmission periods used for radar positioning (hereinafter referred to as “radar-transmission-signal transmission times”). In addition, radar-transmission-signal transmission times Nc is set to an integer multiple of Loc (Ncode multiple). For example, Nc=Loc×Ncode.

Next, an example of a method for non-uniformly setting coded Doppler multiplexing number N_{DOP_CODE}(ndm) for Doppler multiplexed signals in encoder 107 will be described.

For example, encoder 107 sets orthogonal code sequence number (for example, code multiplexing number or code number) Ncm that satisfies the following condition. For example, orthogonal code sequence number N_{CM} and Doppler multiplexing number N_{DM} satisfy the following relationship with respect to number Nt of transmission antennas used for multiplexing transmission.

(Orthogonal code sequence number N_{CM})×(Doppler multiplexing number N_{DM})>Number Nt of transmission antennas used for multiplexing transmission

Next, an exemplary configuration of coded Doppler phase rotation amount ψ_{ndop_code(ndm),ndm} (m) will be described.

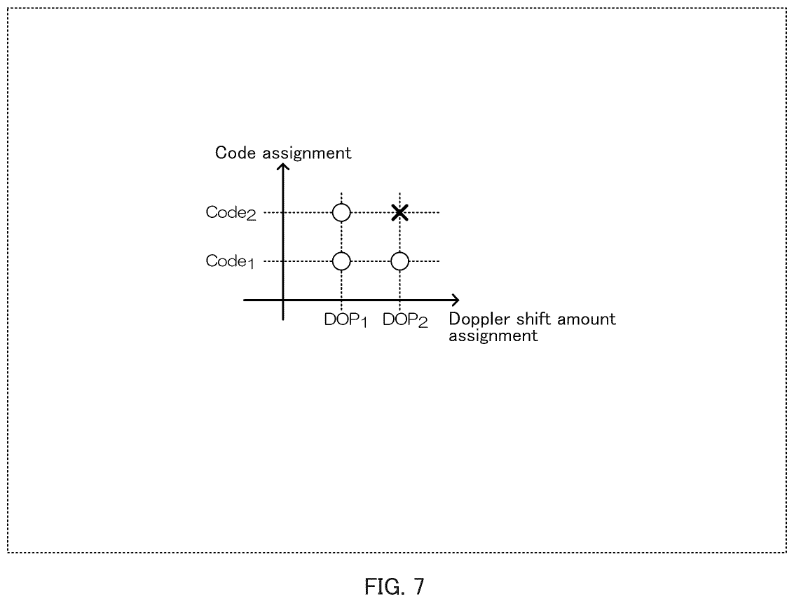

For example, a case where number Nt of transmission antennas used for the multiplexing transmission is 3, Doppler multiplexing number N_{DM} is 2, code multiplexing number N_{CM} is 2, and orthogonal code sequences Code₁={1, 1} and Code₂={1,−1} with code length Loc=2 are used in encoder 107 will be described. In this case, for example, when the coded Doppler multiplexing numbers are N_{DOP_CODE}(1)=1 and N_{DOP_CODE}(2)=2, as illustrated in FIG. 7, encoder 107 sets coded Doppler phase rotation amounts ψ_{1,1}(m), ψ_{1,2}(m), and ψ_{2,2}(m) and outputs the amounts to phase rotator 108. For example, when setting coded Doppler phase rotation amount ψ_{1,1}(m), encoder 107 performs the setting as in the following Expression 9. Note that, in FIG. 7, “∘” represents the Doppler shift amount and the orthogonal code that are used, and “x” represents the assignment of the Doppler shift amount and the orthogonal code that are not used.

$$\begin{matrix}[ 9 ] & \\ \{ {ψ}_{1 , 1} ( 1 ) , {ψ}_{1 , 1} ( 2 ) , {ψ}_{1 , 1} ( 3 ) , {ψ}_{1 , 1} ( 4 ) , {ψ}_{1 , 1} ( 5 ) , {ψ}_{1 , 1} ( 6 ) , {ψ}_{1 , 1} ( 7 ) , {ψ}_{1 , 1} ( 8 ) , … \} = \{ 0 , 0 , {ϕ}_{1} , {ϕ}_{1} , 2 {ϕ}_{1} , 2 {ϕ}_{1} , 3 {ϕ}_{1} , 3 {ϕ}_{1} , … \} & ( Expression 9 )\end{matrix}$$

Here, as an example, the phase rotation amount that applies Doppler shift amount DOP_{ndm} is set to φ_{ndm}=2π(ndm−1)/N_{DM} in Expression 5, and encoder 107 sets coded Doppler phase rotation amounts ψ_{1,1}(m), ψ_{1,2}(m), and ψ_{2,2}(m) by using the phase rotation amount φ₁ that applies Doppler shift amount DOP₁ set to 0, and the phase rotation amount φ₂ that applies Doppler shift amount DOP₂ set to, and outputs the amounts to phase rotator 108. Note that the phase rotation amount may be described in a range of 0 or more and less than 2× radians by performing a modulo operation with 2×.

For example, the number of phases used for the phase rotation amounts may be set to be smaller than number Nt of transmission antennas used for the multiplexing transmission, regardless of the value of number Nt of transmission antennas. Further, the number of phases used in the phase rotation amounts for applying the Doppler shift amounts may be equal to the number N_{DM} of Doppler shift amounts used in the multiplexing transmission.

Further, in the above example, the configuration of phase rotation amounts shown in the maximum even interval Doppler shift amount setting has been described. However, the configuration of the phase rotation amounts is not limited thereto, and the configuration of phase rotation amounts shown in the even interval Doppler shift amount setting (for example, Expression 6) may be used.

The foregoing description has been given of the configuration method for configuring phase rotation amounts in phase rotation amount setter 105.

In FIG. 1, phase rotator 108 applies a phase rotation amount to the chirp signal inputted from radar transmission signal generator 101 for each transmission period Tr based on coded Doppler phase rotation amount ψ_{ndop_code(ndm),ndm}(m) set in phase rotation amount setter 105. Here, ndm=1 to N_{DM}, and ndop_code(ndm)=1 to N_{DOP_CODE}(ndm).

The output (referred to as, for example, coded Doppler multiplexed signals) from each of Nt phase rotators 108 is amplified to a specified transmission power and then radiated into space from corresponding one of the Nt transmission antennas of transmission antenna section 109.

Hereinafter, phase rotator 108 that applies coded Doppler phase rotation amount ψ_{ndop_code(ndm),ndm}(m) will be referred to as “phase rotator PROT #[ndop_code(ndm), ndm].” Similarly, a transmission antenna that radiates the output of phase rotator PROT #[ndop_code(ndm), ndm] into space is also referred to as “transmission antenna Tx #[ndop_code(ndm), ndm].” Here, ndm=1 to N_{DM}, and ndop_code(ndm)=1 to N_{DOP_CODE}(ndm). Alternatively, the Nt transmission antennas are also referred to as Tx #1, Tx #2, . . . , and Tx #Nt. The coded Doppler phase rotation amounts applied to the radar transmission signals transmitted from transmission antennas Tx #1, Tx #2, . . . , and Tx #Nt can be associated by using a pre-known table or the like. For example, by determining (or detecting) coded Doppler phase rotation amount ψ_{ndop_code(ndm),ndm}(m), it is possible to determine (or detect) the transmission antenna.

For example, in the case of the example illustrated in FIG. 7, coded Doppler phase rotation amounts ψ_{1,1}, ψ_{1,2}(m), and ψ_{2,2}(m) are inputted to phase rotator 108 from encoder 107 for each transmission period.

For example, phase rotator PROT #[1, 1] outputs a signal exp[jψ_{1,1}(m)] cp(t) to which phase rotation amount ψ_{1,1}(m) is applied in the mth transmission period with respect to chirp signal cp(t) generated for each transmission period by radar transmission signal generator 101. The output of phase rotator PROT #[1, 1] is outputted from transmission antenna Tx #[1, 1]. Here, cp(t) denotes a chirp signal for each transmission period. Similarly, the output of phase rotator PROT #[1, 2] is output from transmission antenna Tx #[1, 2], and the output of phase rotator PROT #[2, 2] is output from transmission antenna Tx #[2, 2].

The above has described the exemplary configuration of coded Doppler phase rotation amount ψ_{ndop_code(ndm), ndm} (m).

Further, in the present embodiment, when coded Doppler multiplexing number N_{DOP_CODE}(ndm) for the Doppler multiplexed signals is set non-uniformly, the multiplexing number (for example, coded Doppler multiplexing number N_{DOP_CODE}(ndm)) of orthogonal code sequence Code_{ncm} corresponding to each Doppler shift amount DOP_{ndm} may vary in combinations of Doppler shift amounts DOP_{ndm} and orthogonal code sequences Code_{ncm}.

Further, in the present embodiment, when coded Doppler multiplexing number N_{DOP_CODE}(ndm) for the Doppler multiplexed signals is set uniformly, the multiplexing number (for example, coded Doppler multiplexing number N_{DOP_CODE}(ndm)) of orthogonal code sequence Code_{ncm} corresponding to each Doppler shift amount DOP_{ndm} may be the same in the combinations of Doppler shift amounts DOP_{ndm} and orthogonal code sequences Code_{ncm}.

In this case, the number of combinations of Doppler shift amounts DOP_{ndm} and orthogonal code sequences and the number of transmission antennas Nt may be the same (for example, N_{DM}× N_{CM}=Nt).

Further, in the present embodiment, transmission antennas Tx #1 to Tx #Nt may constitute a multi-beam transmission radar including transmission antennas with at least two different main beam directions (or beam directions). Transmission antennas Tx #1 to Tx #Nt may include a plurality of transmission antennas corresponding to different beam directions. Further, the transmission antennas Tx #1 to Tx #Nt may include a plurality of transmission antennas corresponding to the same beam direction.

For example, phase rotation amount setter 105 may add different coded Doppler phase rotation amounts ψ_{ndop_code(ndm), ndm} (m) to chirp signals for respective transmission antennas to which the chirp signals are transmitted, in consideration of the configurations of transmission antennas Tx #1 to Tx #Nt having different beam directions and output the signals. As a result, even when the reception power levels of the reflected waves differ significantly between reception signals corresponding to chirp signals transmitted from transmission antennas with different beam directions, radar apparatus 10 can separate the coded Doppler multiplexed signals, thereby improving the positioning performance and the radar detection performance of radar apparatus 10.

Hereinafter, an exemplary operation of phase rotation amount setter 105 in radar transmitter 100 will be described when a multi-beam transmission radar including transmission antennas with at least two different beam directions is configured.

In the following description, among the plurality of beam directions (or the plurality of beams) used in the multi-beam transmission MIMO radar, the first beam direction (or the beam) will be described as “B1” and the second beam direction (or the beam) will be described as “B2.” Further, for example, the multi-beam number of beam directions different to each other is described as “NB,” and the qth beam direction (or beam) is described as “Bq.” Q is an integer value within a number of different beam directions (e.g., a multi-beam number NB). For example, when multi-beam number NB is 2, q=1 or 2.

Further, for example, number Nt of transmission antennas is Nt≥3, Doppler multiplexing number N_{DM} is N_{DM}>2, code multiplexing number N_{CM} is N_{CM}≥2, and Nt<N_{DM}×N_{CM}.

Further, in transmission antenna section 109, the number of transmission antennas corresponding to beam direction B1 is N_{B1}, and the number of transmission antennas corresponding to beam direction B2 is N_{B2}. In this case, N_{B1}+N_{B2}=Nt. Further, the number of transmission antennas corresponding to beam direction Bq is denoted as N_{Bq}. N_{Bq}≥1, and the total number of transmission antennas with beam directions Bq is Nt.

Further, the Doppler multiplexing number assigned to the transmission antennas with beam direction B1 is denoted as N_{DM_B1}, and the Doppler multiplexing number assigned to the transmission antennas with beam direction B2 is denoted as N_{DM_B2}. Here, N_{DM_B1}, N_{DM_B2}≤N_{DM}.

Phase rotation amount setter 105 sets, for example, coded Doppler multiplexing number N_{DOP_CODE}(ndm) for the Doppler multiplexed signal non-uniformly, and further sets coded Doppler phase rotation amount ψ_{ndop_code(ndm), ndm} (m) to satisfy the following <Condition 1>. Here, ndm=1 to N_{DM}, and ndop_code(ndm)=1 to N_{DOP_CODE}(ndm).

### <Condition 1>

For example, the Doppler shift amount and the pattern of the code sequence (for example, a coded Doppler multiplexing pattern) assigned to the transmission antenna with beam direction B1 and the coded Doppler multiplexing pattern assigned to the transmission antenna with beam direction B2 are made different from each other. For example, for the transmission antennas with beam direction B1 and for the transmission antennas with beam direction B2, phase rotation amount setter 105 sets coded Doppler phase rotation amount ψ_{ndop_code(ndm), ndm}(m) that satisfies a condition of different Doppler multiplexing patterns (for example, assignment patterns of Doppler shift amounts), a condition of different code multiplexing patterns (for example, different code multiplexing numbers between Doppler multiplexed signals), or a condition of different patterns of Doppler multiplexing and code multiplexing.

For example, the condition of different Doppler multiplexing patterns (different Doppler multiplexing pattern condition) may be any one of the following conditions (for example, also referred to as “Condition 1A”).

(A-1) The Doppler multiplexing numbers corresponding to respective beam directions (for example, the Doppler multiplexing numbers of transmission signals transmitted from transmission antennas in respective beam directions) are the same (for example, N_{DM_B1}=N_{DM_B2}, provided N_{DM_B1}=N_{DM_B2}≥2), and the Doppler shift intervals (for example, the intervals of the Doppler shift amounts associated with the transmission antennas in respective beam directions) are different in respective beam directions.
(A-2) Doppler multiplexing numbers for respective beam directions are different (N_{DM_B1}≠N_{DM_B2}).
(A-3) When N_{DM_B1}≥3 and N_{DM_B2}≥3, when the same Doppler shift intervals are included in the Doppler shift intervals for respective beam directions, the orders of the Doppler shift intervals are different (cyclically mismatched).

Further, for example, the condition of different code multiplexing patterns (different code multiplexing pattern condition) may be any one of the following conditions (for example, also referred to as “Condition 1B”).

(B-1) The code intervals (for example, code index intervals) assigned to respective Doppler multiplexed signals are different (cyclically mismatched).
(B-2) The code multiplexing numbers assigned to respective Doppler multiplexed signals are different (cyclically mismatched).

Further, phase rotation amount setter 105 may set coded Doppler phase rotation amount ψ_{ndop_code(ndm), ndm}(m) to satisfy, for example, the following Condition 2.

### <Condition 2>

Signals transmitted from transmission antennas with the same beam direction are multiplexed and transmitted with a code multiplexing number that is non-uniform between Doppler multiplexed signals, and the code multiplexing number includes any number in a range of 1 or more to N_{CM}-1 or less. For example, in a plurality of combinations of the Doppler shift amounts and the code sequences, a code multiplexing number by the code sequence associated with at least one Doppler shift amount is different from a code multiplexing number by the code sequence associated with another Doppler shift amount, with respect to at least one transmission antenna with beam direction B1 and beam direction B2.

For example, in item A-3 of Condition 1, when a value of a plurality of intervals of the Doppler shift amounts assigned to the transmission antennas with beam direction B1 is the same as a value of a plurality of intervals of the Doppler shift amounts assigned to the transmission antennas with beam direction B2 (for example, combinations of Doppler shift intervals are the same), the order of the plurality of Doppler shift intervals corresponding to the transmission antennas with beam direction B1 on the Doppler frequency axis may be different from the order of the plurality of Doppler shift intervals corresponding to the transmission antennas with beam direction B2 on the Doppler frequency axis. For example, the combination of intervals included in an array (in which the intervals of the Doppler shift amounts assigned to the transmission antennas with beam direction B1 are arranged in ascending order on the Doppler frequency axis) coincide with the combination of intervals included in an array (in which the intervals of the Doppler shift amounts assigned to the transmission antennas with beam direction B2 are arranged in ascending order on the Doppler frequency axis), and the first array and the second array are different arrays in a circular permutation. When item A-3 of Condition 1 is satisfied, the Doppler shift intervals of the transmission antennas with beam direction B1 do not coincide with the Doppler shift intervals of the transmission antennas with beam direction B2 (become cyclically mismatched) even when one of them is cyclically shifted in the Doppler frequency domain.

Further, for example, in item B-1 of Condition 1, the order of the code sequences corresponding to the transmission antennas with beam direction B1 on the Doppler frequency axis may be different from the order of the code sequences corresponding to the transmission antennas with beam direction B2 on the Doppler frequency axis. For example, an array in which the indexes of the code sequences corresponding to the Doppler shift amounts assigned to the transmission antennas with beam direction B1 are arranged in ascending order on the Doppler frequency axis and an array in which the indexes of the code sequences corresponding to the Doppler shift amounts assigned to the transmission antennas with beam direction B2 are arranged in ascending order on the Doppler frequency axis are different arrays in a circular permutation. When item B-1 of Condition 1 is satisfied, the indexes of the code sequences corresponding to Doppler shift amounts of the transmission antennas with beam direction B1 do not coincide with the indexes of the code sequences corresponding to Doppler shift amounts of the transmission antennas with beam direction B2 (become cyclically mismatched) even when one of them is cyclically shifted in the Doppler frequency domain.

Further, for example, in item B-2 of Condition 1, the order of the code multiplexing number by the code sequence associated with the transmission antennas with beam direction B1 on the Doppler frequency axis may be different from the order of the code multiplexing number by the code sequences associated with the transmission antennas with beam direction B2 on the Doppler frequency axis. For example, an array in which the code multiplexing numbers corresponding to the Doppler shift amounts assigned to the transmission antennas with beam direction B1 are arranged in ascending order on the Doppler frequency axis and an array in which the code multiplexing numbers corresponding to the Doppler shift amounts assigned to the transmission antennas with beam direction B2 are arranged in ascending order on the Doppler frequency axis are different arrays in a circular permutation. When item B-2 of Condition 1 is satisfied, the code multiplexing numbers corresponding to the Doppler shift amounts of the transmission antennas with beam direction B1 do not coincide with the code multiplexing numbers corresponding to Doppler shift amounts of the transmission antennas with beam direction B2 (become cyclically mismatched) even when one of them is cyclically shifted in the Doppler frequency domain.

By satisfying Condition 1 with the setting of the coded Doppler phase rotation amount by phase rotation amount setter 105, radar apparatus 10 can separate Doppler multiplexed signals and prevent the degradation of positioning performance and radar detection performance even when the reception power levels of reflected waves vary significantly between reception signals from transmission antennas with different beam directions (an example will be described later).

Further, by satisfying Condition 2 with the setting of the coded Doppler phase rotation amount by phase rotation amount setter 105, the detectable Doppler frequency range in radar apparatus 10 becomes in the range of −1/(2Tr)≤fd<1/(2Tr), which can be expanded to a range equivalent to the Doppler detection range in the case of one transmission antenna (an example will be described later).

For example, in the coded Doppler multiplexing transmission by radar apparatus 10, both Condition 1 and Condition 2 may be satisfied, or Condition 1 may be satisfied and Condition 2 does not have to be satisfied. For example, the following three cases are given as cases in which Condition 1 is satisfied but Condition 2 is not satisfied.

### (Case 1)

Case 1 is a case that does not satisfy Condition 2 in either beam direction B1 or beam direction B2. In Case 1, the detectable Doppler frequency range fd depends on the target object direction and is within the range of −1/(2Tr)≤fd<1/(2Tr), −1/(2LocN_{DM_B1}Tr)≤fd<1/(2LocN_{DM_B1}Tr), or −1/(2LocN_{DM_B2}Tr)≤fd<1/(2LocN_{DM_B2}Tr). Here, when the Doppler multiplexed signal assigned between transmission antennas with beam direction B1 does not include an unused code, N_{DM_B1}=N_{B1}/Loc holds, and the detectable Doppler frequency range fd becomes a range of −1/(2N_{B1}Tr)≤fd<1/(2N_{B1}Tr). Similarly, when the Doppler multiplexed signal assigned between transmission antennas with beam direction B2 does not include an unused code, N_{DM_B2}=N_{B2}/Loc holds, and the detectable Doppler frequency range fd becomes a range of of −1/(2 N_{B2}Tr)≤fd<1/(2 N_{B2}Tr).

### (Case 2)

Case 2 is a case in which beam direction B2 does not satisfy Condition 2. In Case 2, the detectable Doppler frequency range fd depends on the target object direction and becomes a range of −1/(2Tr)≤fd<1/(2Tr) or in the range of −1/(2Loc N_{DM_B2}Tr)≤fd<1/(2Loc N_{DM_B2}Tr). For example, when the Doppler multiplexed signal assigned between transmission antennas with beam direction B2 does not include an unused code, N_{DM_B2}=N_{B2}/Loc holds, and the detectable Doppler frequency range fd becomes a range of −1/(2N_{B2}Tr)≤fd<1/(2N_{B2}Tr).

### (Case 3)

Case 3 is a case in which beam direction B1 does not satisfy Condition 2. In Case 3, the detectable Doppler frequency range fd depends on the target object direction and becomes a range of −1/(2Tr)≤fd<1/(2Tr) or in the range of −1/(2Loc N_{DM_B1}Tr)≤fd<1/(2Loc N_{DM_B1}Tr). For example, when the Doppler multiplexed signal assigned between transmission antennas with beam direction B1 does not include an unused code, N_{DM_B1}=N_{B1}/Loc holds, and the detectable Doppler frequency range fd becomes a range of −1/(2N_{B1}Tr)≤fd<1/(2N_{B1}Tr).

In all the cases 1 to 3, the detectable Doppler frequency range can be expanded beyond the Doppler detection range of −1/(2 Nₜ Tr)≤fd<1/(2 Nₜ Tr), namely in the case of even interval Doppler multiplexing.

Hereinafter, an exemplary configuration the coded Doppler phase rotation amount in phase rotation amount setter 105 will be described. Hereinafter, the interval of the Doppler shift amounts to be applied to Tx #n1 and Tx #n2 will be referred to as the Doppler shift interval “Δfd (n1, n2).” Here, Δfd (n1, n2) represents the interval (DOPₙ₂−DOPₙ₁) between Doppler shift amount DOPₙ₂ applied to Tx #n2 and Doppler shift amount DOPₙ₁ applied to Tx #n1 as a reference. Note that, when Doppler shift interval Δfd(n1, n2) is a negative value (for example, when (DOPₙ₂−DOPn1)<0), the Doppler shift interval Δfd(n1, n2) is calculated using Δfd(n1, n2)=1/(Loc Tr)−Δfd(n1, n2) in consideration of aliasing in a range of −1/(2 Loc Tr) or more and less than 1/(2 Loc Tr) which is an observation range in the Doppler analyzer, and is represented as a positive value.

### <Exemplary Configuration 1>

Exemplary configuration 1 is an exemplary configuration of the coded Doppler phase rotation amounts when Condition 1 (a case of satisfying the different code multiplexing pattern condition) and Condition 2 are satisfied.

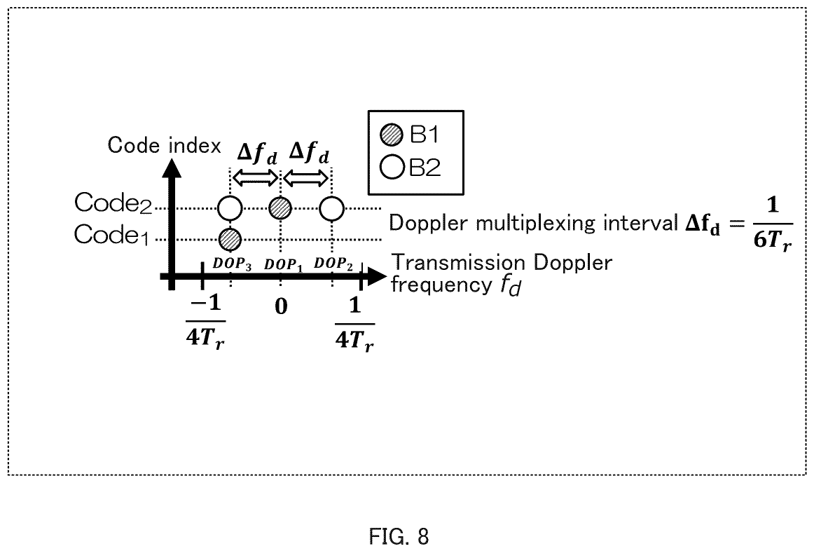

FIG. 8 illustrates an exemplary configuration of the coded Doppler phase rotation amounts in phase rotation amount setter 105 when number Nt of transmission antennas is 4, N_{B1} is 2, and N_{B2} is 2.

In FIGS. 8, Tx #1 and Tx #2 are transmission antennas with beam direction B1, and Tx #3 and Tx #4 are transmission antennas with beam direction B2. In FIG. 8, the shaded circles represent the assignment of coded Doppler multiplexed signals for the transmission antennas (Tx #1 and Tx #2) with beam direction B1, and the white circles represent the assignment of coded Doppler multiplexed signals for the transmission antennas (Tx #3 and Tx #4) with beam direction B2.

Further, in FIG. 8, Doppler multiplexing number N_{DM} is 3, and Doppler shift setter 106 may set three Doppler shift amounts DOP₁, DOP₂, and DOP₃ using, for example, the maximum even interval Doppler shift amount setting shown in Expression 5. In FIG. 8, phase rotation amount φ₁ applying Doppler shift amount DOP₁=0 is 0, phase rotation amount φ₂ applying Doppler shift amount DOP₂=Δfd is 2π/3, and phase rotation amount φ₃ applying Doppler shift amount DOP₃=−Δfd is 4π/3 (φ₃ may be −2π/3). As illustrated in FIG. 8, the interval (also referred to as Doppler multiplexing interval, Doppler shift interval, or Doppler interval) Δfd between the Doppler multiplexed signals is an even interval, and Δfd=1/(6Tr).

Further, in FIG. 8, code multiplexing number N_{CM} is 2, and encoder 107 uses, for example, Code₁={1, 1} and Code₂={1,−1}, which are orthogonal code sequences of Walsh-Hadamard codes with code length Loc=2. Note that, the following exemplary configurations 2 to 5 also have code multiplexing number N_{CM}=2, and the same codes are used.

In FIG. 8, number Nt of transmission antennas is 4, Doppler multiplexing number N_{DM} is 3, and code multiplexing number N_{CM} is 2, and since Nt<N_{DM}×N_{CM}, phase rotation amount setter 105 can set coded Doppler multiplexing number N_{DOP_CODE}(ndm) for the Doppler multiplexed signal non-uniformly (where ndm=1 to N_{DM}).

As illustrated in FIG. 8, in encoder 107, the settings of the coded Doppler multiplexing numbers for the Doppler multiplexed signals with the three Doppler shift amounts DOP₁, DOP₂, and DOP₃ inputted from Doppler shift setter 106 are N_{DOP_CODE}(1)=1, N_{DOP_CODE}(2)=1, and N_{DOP_CODE}(3)=2, respectively. As described above, phase rotation amount setter 105 sets non-uniformly the coded Doppler multiplexing numbers for the Doppler multiplexed signals as N_{DOP_CODE}(1)=N_{DOP_CODE}(2)≠N_{DOP_CODE}(3).

Further, in FIG. 8, Doppler shift setter 106 assigns, to transmission antennas Tx #1 and Tx #2 with beam direction B1, Doppler multiplexed signals with, for example, Doppler shift amounts DOP₁ and DOP₃ among the Doppler multiplexed signals with Doppler multiplexing number N_{DM}=3 (N_{DM_B1}=2). Further, encoder 107 assigns Code₂ and Code₁ to the Doppler multiplexed signals with Doppler shift amounts DOP₁ and DOP₃ assigned to transmission antennas Tx #1 and Tx #2 with beam direction B1, respectively. For example, phase rotation amount setter 105 sets coded Doppler phase rotation amounts ψ_{2, 1}(m) and ψ_{1, 3}(m) for respective transmission antennas Tx #1 and Tx #2 with beam direction B1.

Further, in FIG. 8, Doppler shift setter 106 assigns, to transmission antennas Tx #3 and Tx #4 with beam direction B2, Doppler multiplexed signals with, for example, Doppler shift amounts DOP₂ and DOP₃ among the Doppler multiplexed signals with Doppler multiplexing number N_{DM}=3 (N_{DM_B2}=2). Further, encoder 107 assigns Code₂ and Code₂ to the Doppler multiplexed signals with Doppler shift amounts DOP₂ and DOP₃ assigned to transmission antennas Tx #3 and Tx #4 with beam direction B2, respectively. For example, phase rotation amount setter 105 sets coded Doppler phase rotation amounts ψ_{2,2}(m) and ψ_{2,3}(m) for respective transmission antennas Tx #3 and Tx #4 with beam direction B2.

In FIG. 8, the Doppler multiplexing numbers that Doppler shift setter 106 assigns to the transmission antennas with beam direction B1 and the transmission antennas with beam direction B2 are N_{DM_B1}=N_{DM_B2}=2, and the numbers are the same. Further, the Doppler intervals of the Doppler multiplexed signals assigned to transmission antennas Tx #1 and Tx #2 with beam direction B1 are Δfd(1,2)=2Δfd and Δfd(2,1)=Δfd, and the Doppler intervals of the Doppler multiplexed signals assigned to transmission antennas Tx #3 and Tx #4 with beam direction B2 are Δfd(3,4)=Δfd and Δfd(4,3)=2Δfd, and the intervals are the same.

Accordingly, the setting of the coded Doppler phase rotation amounts illustrated in FIG. 8 does not match any of the different Doppler multiplexing pattern condition in Condition 1A.

Further, in FIG. 8, the codes assigned to the transmission antennas with beam direction B1 for the corresponding Doppler multiplexed signals with Doppler shift amounts DOP₁, DOP₂, and DOP₃ are [Code₂, no assignment, Code₁], and the code multiplexing number assigned to each Doppler multiplexed signal is 0 or 1.

Hereinafter, the code indexes assigned to transmission antennas with beam direction B1 for the corresponding Doppler multiplexed signals with Doppler shift amounts DOP₁, DOP₂, and DOP₃ will be described as “CodeIndex_B1=(2, *, 1).” In CodeIndex_B1, “*” represents a case where no code is assigned. Further, when a plurality of codes is assigned to one Doppler multiplexed signal, the codes are represented using “&.” For example, when Code₁ and Code₂ are assigned to one Doppler multiplexed signal, the notation “1&2” is used. The code index is also referred to as a “code interval.”

Further, hereinafter, the code multiplexing numbers assigned to transmission antennas with beam direction B1 for the corresponding Doppler multiplexed signals with Doppler shift amounts DOP₁, DOP₂, and DOP₃ will be described as “N_Code_B1=(1, 0, 1)” (in the case of FIG. 8).

In FIG. 8, the codes assigned to the transmission antennas with beam direction B2 for the corresponding Doppler multiplexed signals with Doppler shift amounts DOP₁, DOP₂, and DOP₃ are [No assignment, Code₂, Code₂], and the code multiplexing number assigned to each Doppler multiplexed signal is 0 or 1. Note that, similar to beam direction B1, the code indexes assigned to transmission antennas with beam direction B2 for the corresponding Doppler multiplexed signals with Doppler shift amounts DOP₁, DOP₂, and DOP₃ will be described as “CodeIndex_B2=(*, 2, 2).” Further, the code multiplexing numbers assigned to transmission antennas with beam direction B2 for the corresponding Doppler multiplexed signals with Doppler shift amounts DOP₁, DOP₂, and DOP₃ will be described as “N_Code_B2=(0, 1, 1).”

As described above, the code multiplexing numbers assigned to Doppler multiplexed signals for the transmission antennas with beam direction B1 and the transmission antennas with beam direction B2 are N_Code_B1=(1, 0, 1) and N_Code_B2=(0, 1, 1), respectively, and are cyclically matched, and thus, item B-2 of Condition 1 is not satisfied.

On the other hand, the code indexes assigned to Doppler multiplexed signals for the transmission antennas with beam direction B1 and the transmission antennas with beam direction B2 are CodeIndex_B1=(2,*,1) and CodeIndex_B2=(*,2,2), respectively, and are different (or cyclically mismatched, which hereinafter will be referred to as different code INDEX intervals).

Further, when the Doppler frequency of the target object is −1/(2Tr)≤fdtarget object<−1/(4Tr) or 1/(4Tr)≤fdtarget object<1/(2Tr), Doppler analyzer 210 described later observes an aliasing Doppler frequency. In this case, the code indexes are CodeIndex_B1_alias=(1, *, 2) and CodeIndex_B2_alias=(*, 1, 1), which are different (cyclically mismatched). Thus, in the example of FIG. 8, the code indexes become cyclically mismatched and the code intervals are different in a range of the Doppler frequency of the target object of −1/(2Tr)≤fdtarget object<−1/(2Tr). Accordingly, since the code intervals to be respectively assigned to Doppler multiplexed signals are different between the multi-beams, item B-1 of Condition 1 is satisfied, and the different code multiplexing pattern condition is met.

Thus, the setting of the coded Doppler phase rotation amounts illustrated in FIG. 8 is an exemplary configuration that satisfies Condition 1.

Further, in FIG. 8, the code multiplexing number assigned to each Doppler multiplexed signal in the transmission antenna with beam direction B1 is N_Code_B1=(1, 0, 1), and the code multiplexing number assigned to each Doppler multiplexed signal in the transmission antenna with beam direction B2 is N_Code_B2=(0, 1, 1). Both are multiplexed and transmitted with a code multiplexing number that is non-uniform between Doppler multiplexed signals, and the code multiplexing number is included in a range of 1 or more to N_{CM}−1 or less.

Thus, in the example of FIG. 8, the signals transmitted from the transmission antennas in the same beam direction (for example, each of beam directions B1 and B2) are multiplexed and transmitted with a code multiplexing number that is non-uniform between Doppler multiplexed signals, and the code multiplexing number is included in a range of 1 or more to N_{CM}−1 or less. Accordingly, the setting of the coded Doppler phase rotation amounts illustrated in FIG. 8 is an exemplary configuration that satisfies Condition 2 in both beam direction B1 and beam direction B2.

Hereinafter, an example of reception signals in the outputs of Doppler analyzers 210 when transmission antenna section 109 includes transmission antennas with beam directions B1 and B2 based on the setting of the coded Doppler phase rotation amounts illustrated in FIG. 8, and reception antenna section 202 is an omnidirectional antenna (or an antenna with substantially uniform directional characteristics within a viewing angle covered by both transmission antennas with beam direction B1 and beam direction B2) will be described.

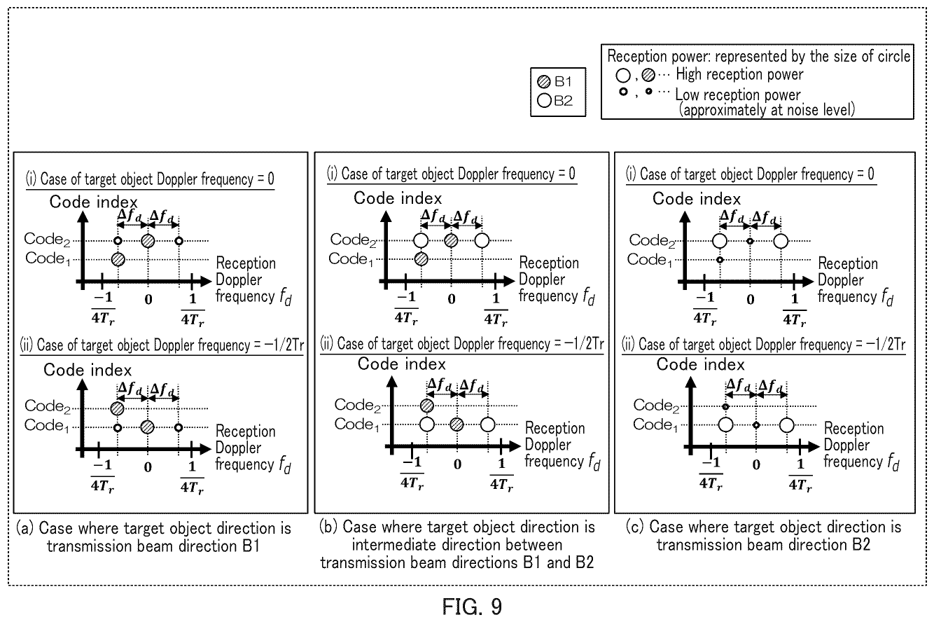

FIG. 9 illustrates an example of the output of Doppler analyzer 210 for a target object reflected wave at a certain distance index. For example, the target object reflected wave includes the Doppler frequency of the target object of fd_{target object}. Accordingly, radar apparatus 10 receives a signal that has been subjected to a Doppler shift of fd_{target object} from the Doppler shift amount set in radar transmitter 100. FIG. 9 illustrates, as an example, a case where Doppler frequency fd_{target object} of the target object reflected wave is 0, and a case where fd_{target object} is 1/(2Tr).

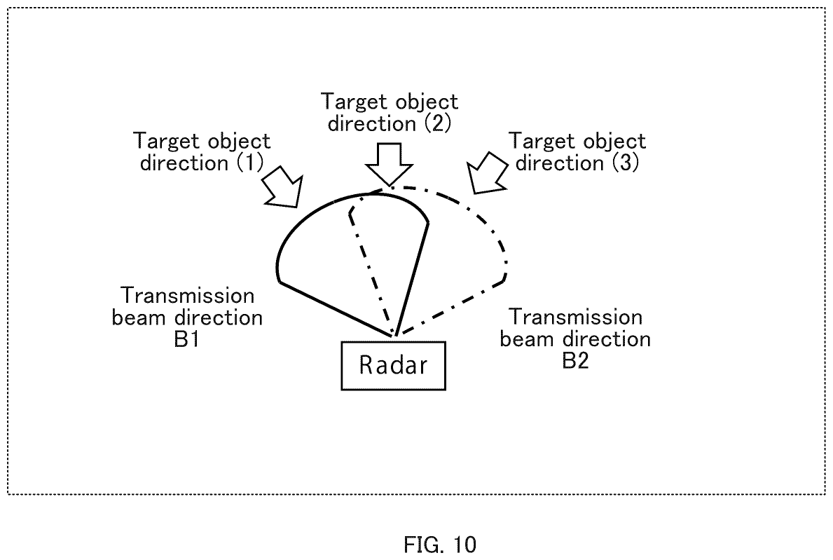

FIG. 10 illustrates an example of a multi-beam transmission MIMO radar (for example, radar apparatus 10) that forms transmission beams in beam direction B1 (Tx Beam #1) and beam direction B2 (Tx Beam #2).

For example, when the target object direction is target object direction (1) illustrated in FIG. 10 (for example, when there is a target object in the periphery of beam direction B1), the radiation direction of the radar transmission waves transmitted from Tx #1 and Tx #2 with beam direction B1 coincides with the target object direction. Therefore, as illustrated at part (a) in FIG. 9, the reception levels of the reception signals of the reflected waves from the target object corresponding to Tx #1 and Tx #2 in radar apparatus 10 become relatively high. On the other hand, when the target object direction is target object direction (1) illustrated in FIG. 10, the radiation direction of the radar transmission waves transmitted from Tx #3 and Tx #4 with beam direction B2 does not coincide with the target object direction, and the target object direction corresponds to the null direction of transmission beam B2. Therefore, as illustrated at part (a) in FIG. 9, the reception levels of the reception signals of the reflected waves from the target object corresponding to Tx #3 and Tx #4 in radar apparatus 10 are lower than the reception levels of the reception signals corresponding to the transmission antennas (for example, Tx #1, Tx #2) with beam direction B1. For example, as illustrated at part (a) in FIG. 9, the reception levels of the reception signals corresponding to Tx #3 and Tx #4 are significantly different from the reception levels of the reception signals corresponding to Tx #1 and Tx #2, and may be 10 dB or more lower depending on the beam direction characteristics in the null directions of Tx #3 and Tx #4. Here, in FIG. 9, the size of the shaded circle or the white circle represents the reception power. A small circle indicates that the reception power is smaller (for example, the reception power is as small as the noise level) than that of a large circle.

Further, for example, when the target object direction is an intermediate direction between beam direction B1 and beam direction B2, and the target object direction is in the direction of an overlapping area (for example, target object direction (2) illustrated in FIG. 10) where the beam widths of both beams (each of which is about 3 dB or 6 dB of the beam) overlap with each other, the reception levels of the reception signals (reflected waves of the radar transmission waves) corresponding to Tx #1 and Tx #2 with beam direction B1 are approximately the same as the reception levels of the reception signals (reflected wave of the radar transmission waves) corresponding to Tx #3 and Tx #4 with beam direction B2, as illustrated at part (b) in FIG. 9.

Further, for example, when the target object direction is target object direction (3) illustrated in FIG. 10 (for example, when there is a target object in the periphery of beam direction B2), the radiation direction of the radar transmission waves transmitted from Tx #3 and Tx #4 with beam direction B2 coincides with the target object direction. Therefore, as illustrated at part (c) in FIG. 9, the reception levels of the reception signals of the reflected waves from the target object corresponding to Tx #3 and Tx #4 in radar apparatus 10 become relatively high. On the other hand, when the target object direction is target object direction (3) illustrated in FIG. 10, the radiation direction of the radar transmission waves transmitted from Tx #1 and Tx #2 with beam direction B1 does not coincide with the target object direction, and the target object direction corresponds to the null direction of transmission beam B1. Therefore, as illustrated at part (c) in FIG. 9, the reception levels of the reception signals of the reflected waves from the target object corresponding to Tx #1 and Tx #2 in radar apparatus 10 are lower than the reception levels of the reception signals corresponding to the transmission antenna (for example, Tx #3, Tx #4) with beam direction B2. For example, as illustrated at part (c) in FIG. 9, the reception levels of the reception signals corresponding to Tx #1 and Tx #2 are significantly different from the reception levels of the reception signals corresponding to Tx #3 and Tx #4, and may be 10 dB or more lower depending on the beam direction characteristics in the null direction of Tx #1 and Tx #2.

For example, when the target object direction is an intermediate direction between beam direction B1 and beam direction B2 (target object direction (2) illustrated in FIG. 10) as illustrated at part (b) in FIG. 9, radar apparatus 10 receives the reception signals corresponding to the transmission antennas in respective beam directions at substantially the same reception level. Accordingly, the signals transmitted from Nt transmission antennas including a transmission antenna with beam direction B1 and a transmission antenna with beam direction B2 are subject to coded Doppler multiplexing transmission using a known configuration of a coded Doppler multiplexed signal. Thus, radar apparatus 10 can separate the coded Doppler multiplexed signals based on a known separation operation of coded Doppler multiplexed signals. The known separation operation of coded Doppler multiplexed signal is disclosed in, for example, PTLs 5 and 6. The same applies to the following embodiments.

Further, when the target object direction is beam direction B1 as illustrated at part (a) in FIG. 9 (target object direction (1) illustrated in FIG. 10) and when the target object direction is beam direction B2 as illustrated at part (c) in FIG. 9 (target object direction (3) illustrated in FIG. 10), radar apparatus 10 receives two Doppler multiplexed signals with substantially the same Doppler interval. Therefore, in radar apparatus 10, it is difficult to discriminate the Doppler multiplexed signals based on the Doppler shift amount. On the other hand, as illustrated at parts (a) and (c) in FIG. 9, the code-multiplexed signals for the Doppler multiplexed signals are different from each other (for example, the code intervals are different from each other, and item B-1 of Condition 1 is satisfied), and thus, radar apparatus 10 receives coded Doppler multiplexed signals different from each other at parts (a) and (c) in FIG. 9.

Thus, when the target object direction is beam direction B1 or B2, radar apparatus 10 can discriminate between a case where the reception level of the reception signal corresponding to the transmission antenna with beam direction B1 decreases and a case where the reception level of the reception signal corresponding to the transmission antenna with beam direction B2 decreases, in coded Doppler demultiplexer 212 described later.

Further, when the discrimination result indicates that the reception signals are from transmission antennas (Tx #1, Tx #2) with beam direction B1, the setting of the coded Doppler multiplexed signals for Tx #1 and Tx #2 with beam direction B1 is known; therefore, radar apparatus 10 can separate the multiplexed signals by performing an operation disclosed in, for example, PTLs 5 and 6. Further, even when the reception signals are determined to be from the transmission antennas (Tx #3, Tx #4) with beam direction B2, the setting of the coded Doppler multiplexed signals for Tx #3, Tx #4 with beam direction B2 is known, and thus, radar apparatus 10 can separate the multiplexed signals in the same manner.

Further, by satisfying Condition 2 in addition to Condition 1, the setting of the coded Doppler phase rotation amounts by phase rotation amount setter 105 can expand the Doppler detection range to a range equivalent to that in the case of one transmission antenna (a range of +1/(2Tr)) (an example will be described later).

By the operation of coded Doppler demultiplexer 212 as described above, radar apparatus 10 can determine Doppler frequency fd of the target object in a range of −1/(2Tr)≤fd<1/(2Tr), and can obtain an output in which each coded Doppler multiplexed signal is associated with its corresponding transmission antenna.

### <Exemplary Configuration 2>

Exemplary configuration 2 is an exemplary configuration of the coded Doppler phase rotation amounts when Condition 1 (a case of satisfying the different code multiplexing pattern condition) and Condition 2 are satisfied.

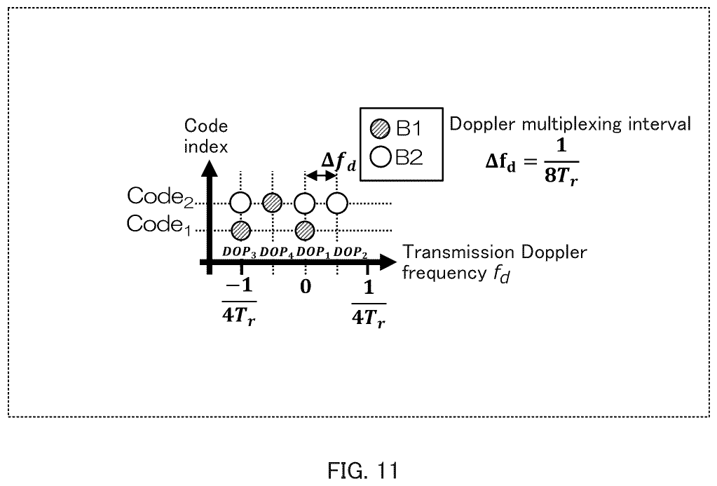

FIG. 11 illustrates an exemplary configuration of the coded Doppler phase rotation amounts in phase rotation amount setter 105 when number Nt of transmission antennas is 6, N_{B1} is 3, and N_{B2} is 3.

In FIGS. 11, Tx #1, Tx #2, and Tx #3 are transmission antennas with beam direction B1, and Tx #4, Tx #5, and Tx #6 are transmission antennas with beam direction B2. In FIG. 11, the shaded circles represent the assignment of the coded Doppler multiplexed signals for the transmission antennas (Tx #1, Tx #2, Tx #3) with beam direction B1, and the white circles represent the assignment of the coded Doppler multiplexed signals for the transmission antennas (Tx #4, Tx #5, Tx #6) with beam direction B2.

Further, in FIG. 11, Doppler multiplexing number N_{DM} is 4, and Doppler shift setter 106 may set four Doppler shift amounts, namely DOP₁=0, DOP₂=Δfd, DOP₃=−2Δfd, and DOP₄=−Δfd, using, for example, the maximum even interval Doppler shift amount setting shown in Expression 5. In FIG. 11, the phase rotation amounts applying Doppler shift amounts DOP₁ to DOP₄ are φ₁=0, φ₂=π/4, φ₃=π/2, and φ₂=3π/4, respectively. As illustrated in FIG. 11, Doppler multiplexing interval Δfd is an even interval, and Δfd=1/(8Tr).

In FIG. 11, number Nt of transmission antennas is 6, Doppler multiplexing number N_{DM} is 4, and code multiplexing number N_{CM} is 2, and since Nₜ<N_{DM}× N_{CM}, phase rotation amount setter 105 can set coded Doppler multiplexing number N_{DOP_CODE}(ndm) for the Doppler multiplexed signal non-uniformly (where ndm=1 to N_{DM}).

As illustrated in FIG. 11, in encoder 107, the setting of the coded Doppler multiplexing numbers for the Doppler multiplexed signals with four Doppler shift amounts DOP₁, DOP₂, DOP₃, and DOP₄ inputted from Doppler shift setter 106 are N_{DOP_CODE}(1)=2, N_{DOP_CODE}(2)=1, N_{DOP_CODE}(3)=2, and N_{DOP_CODE}(4)=1, respectively. As described above, phase rotation amount setter 105 sets non-uniformly the coded Doppler multiplexing numbers for the Doppler multiplexed signals as N_{DOP_CODE}(1)≠N_{DOP_CODE}(2) or N_{DOP_CODE}(3)/N_{DOP_CODE}(4).

Further, in FIG. 11, Doppler shift setter 106 assigns, for transmission antennas Tx #1, Tx #2, and Tx #3 with beam direction B1, Doppler multiplexed signals with, for example, Doppler shift amounts DOP₁, DOP₃, and DOP₄ among the Doppler multiplexed signals with Doppler multiplexing number N_{DM}=4 (N_{DM_B1}=3). Further, encoder 107 assigns Code₁, Code₁, and Code₂ to the Doppler multiplexed signals with Doppler shift amounts DOP₁, DOP₃, and DOP₄, respectively. For example, phase rotation amount setter 105 sets coded Doppler phase rotation amounts ψ_{1,1}(m), ψ_{1,3}(m), and ψ_{2,4}(m) for respective transmission antennas Tx #1, Tx #2, and Tx #3 with beam direction B1.

Further, in FIG. 11, Doppler shift setter 106 assigns, for transmission antennas Tx #4, Tx #5, and Tx #6 with beam direction B2, Doppler multiplexed signals with, for example, Doppler shift amounts DOP₁, DOP₂, and DOP₃ among the Doppler multiplexed signals with Doppler multiplexing number N_{DM}=4 (N_{DM_B2}=3). Further, encoder 107 assigns Code₂, Code₂, and Code₂ to the Doppler multiplexed signals with Doppler shift amounts DOP₁, DOP₂, and DOP₃, respectively. For example, phase rotation amount setter 105 sets coded Doppler phase rotation amounts ψ_{2, 1}(m), ψ_{2, 2}(m), and ψ_{2, 3}(m) for respective transmission antennas Tx #4, Tx #5, and Tx #6 with beam direction B2.

In FIG. 11, the Doppler multiplexing numbers that Doppler shift setter 106 assigns to the transmission antennas with beam direction B1 and the transmission antennas with beam direction B2 are N_{DM_B1}=N_{DM_B2}=3, which are the same. Further, the Doppler intervals of the Doppler multiplexed signals assigned to transmission antennas Tx #1, Tx #2, and Tx #3 with beam direction B1 are Δfd(1,3)=2Δfd, Δfd(3,4)=Δfd, and Δfd(4,1)=Δfd, and the Doppler intervals of the Doppler multiplexed signals assigned to transmission antennas Tx #4, Tx #5, and Tx #6 with beam direction B2 are Δfd(1,2)=Δfd, Δfd(2,3)=Δfd, and Δfd(3,1)=2Δfd, and the intervals are the same (cyclically matched).

Accordingly, the setting of the coded Doppler phase rotation amounts illustrated in FIG. 11 does not match any of the different Doppler multiplexing pattern conditions in Condition 1A.

Further, in FIG. 11, the code indexes assigned to the transmission antennas with beam direction B1 and to the transmission antennas with beam direction B2 for the Doppler multiplexed signals with Doppler multiplexed signals DOP₁, DOP₂, DOP₃, and DOP₄ are CodeIndex_B1=(1, *, 1, 2) and CodeIndex_B2=(2, 2, 2, *), respectively. The code indexes are cyclically mismatched and the code INDEX intervals are different, and thus, item B-1 of Condition 1 is satisfied.

Further, in FIG. 11, the code multiplexing numbers assigned to the transmission antennas with beam direction B1 and to the transmission antennas with beam direction B2 for the Doppler multiplexed signals with Doppler multiplexed signals DOP₁, DOP₂, DOP₃, and DOP₄ are N_Code_B1=(1, 0, 1, 1) and N_Code_B2=(1, 1, 0, 1), respectively, and include code multiplexing numbers that are cyclically matched, and the code multiplexing numbers are the same, and thus, item B-2 of Condition 1 is not satisfied.

Further, when the Doppler frequency of the target object is −1/(2Tr)≤fdtarget object<−1/(4Tr) or 1/(4Tr)≤fdtarget object<1/(2Tr), Doppler analyzer 210 described later observes an aliasing Doppler frequency. In this case, the code indexes are CodeIndex_B1_alias=(2, *, 2, 1) and CodeIndex_B2_alias=(1, 1, 1, *), which are different (cyclically mismatched). Thus, in the example of FIG. 11, the code indexes become cyclically mismatched and the code intervals are different in a range of the Doppler frequency of the target object of −1/(2Tr)≤fdtarget object<−1/(2Tr). Accordingly, item B-1 of Condition 1 is satisfied, and the different code multiplexing pattern condition is met.

Thus, the setting of the coded Doppler phase rotation amounts illustrated in FIG. 11 is an exemplary configuration that satisfies Condition 1.

Further, in FIG. 11, the code multiplexing number assigned to each Doppler multiplexed signal in the transmission antenna with beam direction B1 is N_Code_B1=(1, 0, 1, 1), and the code multiplexing number assigned to each Doppler multiplexed signal in the transmission antenna with beam direction B2 is N_Code_B2=(1, 1, 0, 1). Both are multiplexed and transmitted with a code multiplexing number that is non-uniform between Doppler multiplexed signals, and the code multiplexing number is included in a range of 1 or more to N_{CM}−1 or less.

Thus, in the example of FIG. 11, the signals transmitted from the transmission antennas in the same beam direction (for example, each of beam directions B1 and B2) are multiplexed and transmitted with a code multiplexing number that becomes non-uniform between Doppler multiplexed signals, and the code multiplexing number is included in a range of 1 or more to N_{CM}-1 or less. Accordingly, the setting of the coded Doppler phase rotation amounts illustrated in FIG. 11 is an exemplary configuration that satisfies Condition 2 in both beam direction B1 and beam direction B2.

Hereinafter, an example of reception signals in the outputs of Doppler analyzers 210 when transmission antenna section 109 includes transmission antennas with different beam directions B1 and B2 based on the setting of the Doppler shift amounts illustrated in FIG. 11, and reception antenna section 202 is an omnidirectional antenna (or an antenna having substantially uniform directional characteristics in a viewing angle covered by both transmission antennas with beam direction B1 and beam direction B2) will be described.

For example, when the target object direction is target object direction (1) illustrated in FIG. 10 (for example, when there is a target object in the periphery of beam direction B1), or when the target object direction is target object direction (3) illustrated in FIG. 10 (for example, when there is a target object in the periphery of beam direction B2), the Doppler multiplexed signal number, the code interval, and the code multiplexing number vary between the transmission antenna with beam direction B1 and the transmission antenna with beam direction B2. Therefore, in coded Doppler demultiplexer 212 to be described later, radar apparatus 10 can discriminate between a case where the reception level of the reception signal corresponding to the transmission antenna with beam direction B1 decreases and a case where the reception level of the reception signal corresponding to the transmission antenna with beam direction B2 decreases.

Further, when the discrimination result indicates that the reception signals are from the transmission antennas (Tx #1, Tx #2, Tx #3) with beam direction B1, the setting of the coded Doppler multiplexed signals for Tx #1, Tx #2, and Tx #3 with beam direction B1 is known. Therefore, radar apparatus 10 can separate the multiplexed signals by performing the operation disclosed in, for example, PTLs 5 and 6. Further, when the reception signals are determined to be from transmission antennas (Tx #4, Tx #5, Tx #6) with beam direction B2, the setting of the coded Doppler multiplexed signals for Tx #4, Tx #5, and Tx #6 with beam direction B2 is known, and thus, radar apparatus 10 can separate the multiplexed signals in the same manner.

Further, by satisfying Condition 2 in addition to Condition 1, the setting of the coded Doppler phase rotation amounts by phase rotation amount setter 105 can expand the Doppler detection range to a range equivalent to that in the case of one transmission antenna (a range of +1/(2Tr)) (an example will be described later).

By the operation of coded Doppler demultiplexer 212 as described above, radar apparatus 10 can determine Doppler frequency fd of the target object in a range of −1/(2Tr)≤fd<1/(2Tr), and can obtain an output in which each coded Doppler multiplexed signal is associated with its corresponding transmission antenna.

### <Exemplary Configuration 3>

Exemplary configuration 3 is an exemplary configuration of the coded Doppler phase rotation amounts when Condition 1 (a case of satisfying different code multiplexing pattern condition and Doppler multiplexing pattern condition) and Condition 2 are satisfied.

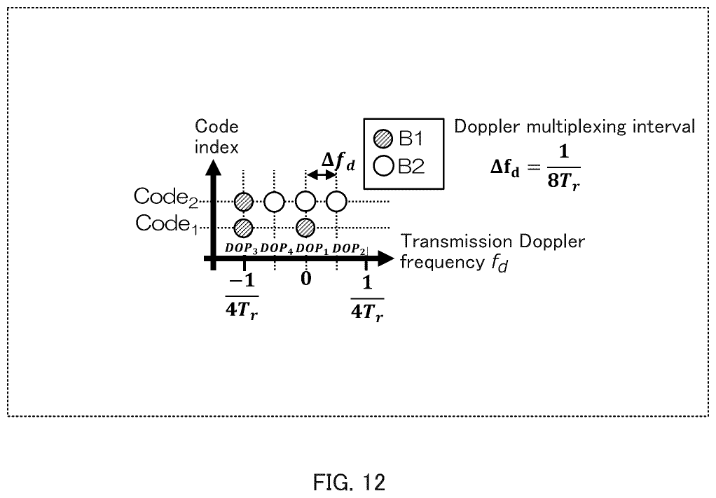

FIG. 12 illustrates an exemplary configuration of the coded Doppler phase rotation amounts in phase rotation amount setter 105 when number Nt of transmission antennas is 6, N_{B1} is 3, and N_{B2} is 3.

In FIGS. 12, Tx #1, Tx #2, and Tx #3 are transmission antennas with beam direction B1, and Tx #4, Tx #5, and Tx #6 are transmission antennas with beam direction B2. In FIG. 12, the shaded circles represent the assignment of the coded Doppler multiplexed signals for the transmission antennas (Tx #1, Tx #2, Tx #3) with beam direction B1, and the white circles represent the assignment of the coded Doppler multiplexed signals for the transmission antennas (Tx #4, Tx #5, Tx #6) with beam direction B2.

Further, in FIG. 12, Doppler multiplexing number N_{DM} is 4, and Doppler shift setter 106 may set four Doppler shift amounts DOP₁ to DOP₄ using, for example, the maximum even interval Doppler shift amount setting shown in Expression 5. In FIG. 12, the phase rotation amounts applying Doppler shift amounts DOP₁=0, DOP₂=Δfd, DOP₃=−2Δfd, and DOP₄=−Δfd are φ₁=0, φ₂=π/4, φ₃=π/2, and φ2=3π/4, respectively. As illustrated in FIG. 12, Doppler multiplexing interval Δfd is an even interval, and Δfd=1/(8Tr).

In FIG. 12, number Nt of transmission antennas is 6, Doppler multiplexing number N_{DM} is 4, and code multiplexing number Ncm is 2, and since Nₜ<N_{DM}×N_{CM}, phase rotation amount setter 105 can set coded Doppler multiplexing number N_{DOP_CODE}(ndm) for the Doppler multiplexed signal non-uniformly (where ndm=1 to N_{DM}).

As illustrated in FIG. 12, in encoder 107, the setting of the coded Doppler multiplexing numbers for the Doppler multiplexed signals with four Doppler shift amounts DOP₁ to DOP₄ inputted from Doppler shift setter 106 are N_{DOP_CODE}(1)=2, N_{DOP_CODE}(2)=1, N_{DOP_CODE}(3)=2, and N_{DOP_CODE}(4)=1, respectively. As described above, phase rotation amount setter 105 sets non-uniformly the coded Doppler multiplexing numbers for the Doppler multiplexed signals as N_{DOP_CODE}(1)≠N_{DOP_CODE}(2) or N_{DOP_CODE}(3)≠N_{DOP_CODE}(4).

Further, in FIG. 12, Doppler shift setter 106 assigns, for transmission antennas Tx #1, Tx #2, and Tx #3 with beam direction B1, Doppler multiplexed signals with, for example, Doppler shift amounts DOP₁ and DOP₃ among the Doppler multiplexed signals with Doppler multiplexing number N_{DM}=4 (N_{DM_B1}=2). Further, encoder 107 assigns Code₁, Code₁, and Code₂ to the Doppler multiplexed signals with Doppler shift amounts DOP₁ and DOP₃, respectively (for example, using two codes). For example, phase rotation amount setter 105 sets coded Doppler phase rotation amounts ψ_{1,1}(m), ψ_{1,3}(m), and ψ_{2,3}(m) for respective transmission antennas Tx #1, Tx #2, and Tx #3 with beam direction B1.

Further, in FIG. 12, Doppler shift setter 106 assigns, for transmission antennas Tx #4, Tx #5, and Tx #6 with beam direction B2, Doppler multiplexed signals with, for example, Doppler shift amounts DOP₁, DOP₂, and DOP₄ among the Doppler multiplexed signals with Doppler multiplexing number N_{DM}=4 (N_{DM_B2}=3). Further, encoder 107 assigns Code₂, Code₂, and Code₂ to the Doppler multiplexed signals with Doppler shift amounts DOP₁, DOP₂, and DOP₄, respectively (for example, using one code). For example, phase rotation amount setter 105 sets coded Doppler phase rotation amounts ψ_{2,1}(m), ψ_{2,2}(m), and ψ_{2,4}(m) for respective transmission antennas Tx #4, Tx #5, and Tx #6 with beam direction B2.

In FIG. 12, the Doppler multiplexing numbers that Doppler shift setter 106 assigns to the transmission antennas with beam direction B1 and the transmission antennas with beam direction B2 are different Doppler multiplexing numbers of N_{DM_B1}=2 and N_{DM_B2}=3, respectively, and thus, item A-2 of Condition 1 is satisfied.

Further, in FIG. 12, the code indexes assigned to the transmission antennas with beam direction B1 and to the transmission antennas with beam direction B2 for the Doppler multiplexed signals with Doppler multiplexed signals DOP₁ to DOP₄ are CodeIndex_B1=(1, *, 1&2, *) and CodeIndex_B2=(2, 2, *, 2), respectively. The code indexes are cyclically mismatched and the code INDEX intervals are different, and thus item B-1 of Condition 1 is satisfied.

Further, in FIG. 12, the code multiplexing numbers assigned to the transmission antennas with beam direction B1 and to the transmission antennas with beam direction B2 for the Doppler multiplexed signals with Doppler multiplexed signals DOP₁ to DOP₄ are N_Code_B1=(1, 0, 2, 0) and N_Code_B2=(1, 1, 0, 1), respectively, and the code multiplexing numbers are different, and thus item B-2 of Condition 1 is satisfied.

Note that, when the Doppler frequency of the target object is −1/(2Tr)≤fdtarget object<−1/(4Tr) or 1/(4Tr)≤fdtarget object<1/(2Tr), Doppler analyzer 210 described later observes an aliasing Doppler frequency. In this case, the code indexes become CodeIndex_B1_alias=(2, *, 1&2, *) and CodeIndex_B2_alias=(1, 1, *, 1), which are different (cyclically mismatched). Thus, in the example of FIG. 12, the code indexes become cyclically mismatched and the code intervals are different in a range of the Doppler frequency of the target object of −1/(2Tr)≤fdtarget object<−1/(2Tr). Accordingly, item B-1 of Condition 1 is satisfied, and the different code multiplexing pattern condition is met.

Thus, the setting of the coded Doppler phase rotation amounts illustrated in FIG. 12 is an exemplary configuration that satisfies Condition 1.

Further, in FIG. 12, the code multiplexing numbers assigned to Doppler multiplexed signals in the transmission antennas with beam direction B1 and beam direction B2 are N_Code_B1=(1, 0, 2, 0) and N_Code_B2=(1, 1, 0, 1), respectively. Thus, in the example of FIG. 12, the signals transmitted from the transmission antennas in the same beam direction are multiplexed and transmitted with a code multiplexing number that is non-uniform between Doppler multiplexed signals, and the code multiplexing numbers are included in a range of 1 or more to N_{CM}−1 or less. Accordingly, the setting of the coded Doppler phase rotation amounts illustrated in FIG. 12 is an exemplary configuration that satisfies Condition 2 in both beam direction B1 and beam direction B2.

Hereinafter, an example of reception signals in the outputs of Doppler analyzers 210 when transmission antenna section 109 includes transmission antennas with different beams directions B1 and B2 based on the setting of the Doppler shift amounts illustrated in FIG. 12, and reception antenna section 202 is an omnidirectional antenna (or an antenna having substantially uniform directional characteristics in a viewing angle covered by both transmission antennas with beam direction B1 and beam direction B2) will be described.

For example, when the target object direction is target object direction (1) illustrated in FIG. 10 (for example, when there is a target object in the periphery of beam direction B1), or when the target object direction is target object direction (3) illustrated in FIG. 10 (for example, when there is a target object in the periphery of beam direction B2), the Doppler multiplexed signal number, the code interval, and the code multiplexing number a vary between the transmission antenna with beam direction B1 and the transmission antenna with beam direction B2. Therefore, in coded Doppler demultiplexer 212 to be described later, radar apparatus 10 can discriminate between a case where the reception level of the reception signal corresponding to the transmission antenna with beam direction B1 decreases and a case where the reception level of the reception signal corresponding to the transmission antenna with beam direction B2 decreases.

Further, when the discrimination result indicates that the reception signals are from the transmission antennas (Tx #1, Tx #2, and Tx #3) with beam direction B1, the setting of the coded Doppler multiplexed signals for Tx #1, Tx #2, and Tx #3 with beam direction B1 is known. Therefore, radar apparatus 10 can separate the multiplexed signals by performing the operation disclosed in, for example, PTLs 5 and 6. Further, when the reception signals are determined to be from transmission antennas (Tx #4, Tx #5, Tx #6) with beam direction B2, the setting of the coded Doppler multiplexed signals for Tx #4, Tx #5, and Tx #6 with beam direction B2 is known, and thus, radar apparatus 10 can separate the multiplexed signals in the same manner.

Further, by satisfying Condition 2 in addition to Condition 1, the setting of the coded Doppler phase rotation amounts by phase rotation amount setter 105 can expand the Doppler detection range to a range equivalent to that in the case of one transmission antenna (a range of +1/(2Tr)) (an example will be described later).

By the operation of coded Doppler demultiplexer 212 as described above, radar apparatus 10 can determine Doppler frequency fd of the target object in a range of −1/(2Tr)≤fd<1/(2Tr), and can obtain an output in which each coded Doppler multiplexed signal is associated with its corresponding transmission antenna.

### <Exemplary Configuration 4>

Exemplary configuration 4 is an exemplary configuration of the coded Doppler phase rotation amounts when Condition 1 (different code multiplexing pattern condition) is satisfied and Condition 2 is not satisfied.

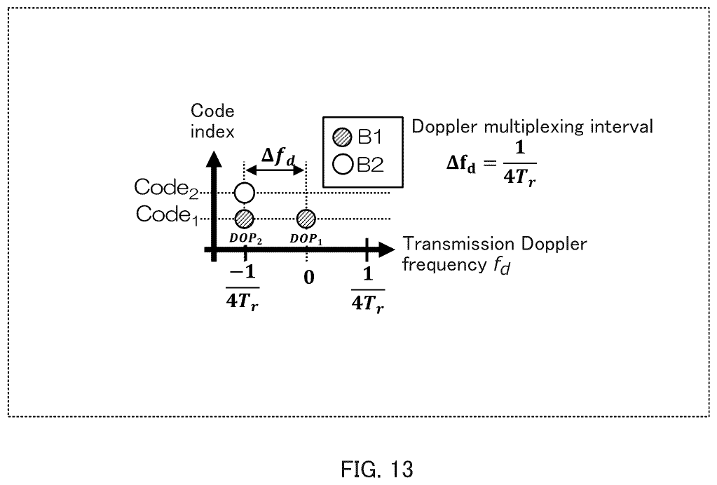

FIG. 13 illustrates an exemplary configuration of the coded Doppler phase rotation amounts in phase rotation amount setter 105 when number Nt of transmission antennas is 3, N_{B1} is 2, and N_{B2} is 1.

In FIGS. 13, Tx #1 and Tx #2 are transmission antennas with beam direction B1, and Tx #3 is a transmission antenna with beam direction B2. In FIG. 13, the shaded circles represent the assignment of coded Doppler multiplexed signals for the transmission antennas (Tx #1 and Tx #2) with beam direction B1, and the white circle represents the assignment of a coded Doppler multiplexed signal for the transmission antenna (Tx #3) with beam direction B2.

Further, in FIG. 13, Doppler multiplexing number N_{DM} is 2, and Doppler shift setter 106 may set two Doppler shift amounts DOP₁ and DOP₂ using, for example, the maximum even interval Doppler shift amount setting shown in Expression 5. In FIG. 13, phase rotation amount φ₁ applying Doppler shift amount DOP₁=0 is 0, and phase rotation amount φ₂ applying Doppler shift amount DOP₂=−Δfd is π. As illustrated in FIG. 13, Doppler multiplexing interval Δfd is an even interval, and Δfd=1/(4Tr).

In FIG. 13, number Nt of transmission antennas is 3, Doppler multiplexing number N_{DM} is 2, and code multiplexing number N_{CM} is 2, and since Nₜ<N_{DM}× N_{CM}, phase rotation amount setter 105 can set coded Doppler multiplexing number N_{DOP_CODE}(ndm) for the Doppler multiplexed signal non-uniformly (where ndm=1 to N_{DM}).

As illustrated in FIG. 13, in encoder 107, the coded Doppler multiplexing numbers for the Doppler multiplexed signals with two Doppler shift amounts DOP₁ and DOP₂ inputted from Doppler shift setter 106 are N_{DOP_CODE}(1)=1 and N_{DOP_CODE}(2)=2, respectively. As described above, phase rotation amount setter 105 sets non-uniformly the coded Doppler multiplexing numbers for the Doppler multiplexed signals as N_{DOP_CODE}(1) #N_{DOP_CODE}(2).

Further, in FIG. 13, Doppler shift setter 106 assigns, for transmission antennas Tx #1 and Tx #2 with beam direction B1, Doppler multiplexed signals with, for example, Doppler shift amounts DOP₁ and DOP₂ among the Doppler multiplexed signals with Doppler multiplexing number N_{DM}=2 (N_{DM_B1}=2). Further, encoder 107 assigns Code₁ and Code₁ to the Doppler multiplexed signals with Doppler shift amounts DOP₁ and DOP₂ assigned to transmission antennas Tx #1 and Tx #2 with beam direction B1, respectively. For example, phase rotation amount setter 105 sets coded Doppler phase rotation amounts ψ_{1,1}(m) and ψ_{1,2}(m) for respective transmission antennas Tx #1 and Tx #2 with beam direction B1.

Further, in FIG. 13, Doppler shift setter 106 assigns, for transmission antenna Tx #3 with beam direction B2, Doppler multiplexed signal with, for example, Doppler shift amount DOP₂ among the Doppler multiplexed signals with Doppler multiplexing number N_{DM}=2 (N_{DM_B2}=1). Further, encoder 107 assigns Code₂ to the Doppler multiplexed signal with Doppler shift amount DOP₂ assigned to transmission antenna Tx #3 with beam direction B2. For example, phase rotation amount setter 105 sets coded Doppler phase rotation amount ψ_{2,2} (m) for transmission antenna Tx #3 with beam direction B2.

In FIG. 13, the Doppler multiplexing numbers that Doppler shift setter 106 assigns to the transmission antennas with beam direction B1 and the transmission antennas with beam direction B2 are different Doppler multiplexing numbers of N_{DM_B1}=2 and N_{DM_B2}=1, respectively, and thus, item A-2 of Condition 1 is satisfied.

Further, in FIG. 13, the code indexes assigned to the transmission antennas with beam direction B1 and to the transmission antennas with beam direction B2 for each of Doppler multiplexed signals DOP₁ and DOP₂ is CodeIndex_B1=(1, 1) and CodeIndex_B2=(*, 2), respectively. The code indexes are cyclically mismatched and the code INDEX intervals are different, thus satisfying item B-1 of Condition 1.

Further, in FIG. 13, the code multiplexing numbers assigned to the transmission antennas with beam direction B1 and to the transmission antennas with beam direction B2 for Doppler multiplexed signals DOP₁ and DOP₂ are N_Code_B1=(1,1) and N_Code_B2=(0,1), respectively, and the code multiplexing numbers are different, and thus item B-2 of Condition 1 is satisfied.

Note that, when the Doppler frequency of the target object is −1/(2Tr)≤fdtarget object<−1/(4Tr) or 1/(4Tr)≤fdtarget object<1/(2Tr), Doppler analyzer 210 described later observes an aliasing Doppler frequency. In this case, the code Indexes are CodeIndex_B1_alias=(2, 2) and CodeIndex_B2_alias=(*, 1), which are different (cyclically mismatched). Thus, in the example of FIG. 13, in a range of the Doppler frequency of the target object of −1/(2Tr)≤fdtarget object<−1/(2Tr), the code indexes become cyclically mismatched, and the code intervals are different. Accordingly, items B-1 and B-2 of Condition 1 are satisfied, and the different code multiplexing pattern condition is met.

Thus, the setting of the coded Doppler phase rotation amounts illustrated in FIG. 13 is an exemplary configuration that satisfies Condition 1.

Further, in FIG. 13, the code multiplexing number assigned to Doppler multiplexed signals in the transmission antennas with beam direction B1 is N_Code_B1=(1, 1), and the Doppler multiplexed signals are multiplexed and transmitted with a code multiplexing number that is uniform between the Doppler multiplexed signals, and thus, Condition 2 is not satisfied.

On the other hand, in FIG. 13, the code multiplexing number assigned to Doppler multiplexed signals in the transmission antennas with beam direction B2 is N_Code_B2=(0, 1), and the Doppler multiplexed signals are multiplexed and transmitted with a code multiplexing number that is non-uniform between the Doppler multiplexed signals, and the code multiplexing number is included in a range of 1 or more to N_{CM}−1 or less. Accordingly, the setting of the coded Doppler phase rotation amounts illustrated in FIG. 12 is an exemplary configuration that satisfies Condition 2.

Thus, the setting of the coded Doppler phase rotation amounts illustrated in FIG. 13 is an exemplary configuration that does not satisfy Condition 2 for the transmission antennas with beam direction B1 and satisfies Condition 2 for the transmission antennas with beam direction B2.

Hereinafter, an example of reception signals in the outputs of Doppler analyzers 210 when transmission antenna section 109 includes transmission antennas with different beam directions B1 and B2 based on the setting of the Doppler shift amounts illustrated in FIG. 13, and reception antenna section 202 is an omnidirectional antenna (or an antenna having substantially uniform directional characteristics within a viewing angle covered by both transmission antennas with beam direction B1 and beam direction B2) will be described.

For example, when the target object direction is target object direction (1) illustrated in FIG. 10 (for example, when there is a target object in the periphery of beam direction B1), or when the target object direction is target object direction (3) illustrated in FIG. 10 (for example, when there is a target object in the periphery of beam direction B2), the code multiplexing number varies between the transmission antenna with beam direction B1 and the transmission antenna with beam direction B2. Therefore, in coded Doppler demultiplexer 212 to be described later, radar apparatus 10 can discriminate between a case where the reception level of the reception signal corresponding to the transmission antenna with beam direction B1 decreases and a case where the reception level of the reception signal corresponding to the transmission antenna with beam direction B2 decreases.

Further, when the discrimination result indicates that the reception signals are from the transmission antennas (Tx #1 and Tx #2) with beam direction B1, the setting of the coded Doppler multiplexed signals for Tx #1 and Tx #2 with beam direction B1 is known. Therefore, radar apparatus 10 can separate the multiplexed signal by performing an operation disclosed in, for example, PTLs 5 and 6. Further, when the reception signals are determined to be from transmission antenna (Tx #3) with beam direction B2, the setting of the coded Doppler multiplexed signal for Tx #3 with beam direction B2 is known, and thus, radar apparatus 10 can separate the multiplexed signals in the same manner.

Further, in exemplary configuration 4, the setting of the coded Doppler phase rotation amounts by phase rotation amount setter 105 does not satisfy Condition 2 with respect to beam direction B1. In this case, the detectable Doppler frequency range fd is, depending on the target object direction, in the range of −1/(2Tr)≤fd<1/(2Tr) or in the range of −1/(2Loc N_{DM_B1}Tr)≤fd<1/(2Loc N_{DM_B1}Tr), and an effect of expanding the Doppler detection range depending on the target object direction can be obtained, compared to the Doppler detection range of the even interval DDM, which is −1/(6Tr)≤fd<1/(6Tr).

### <Exemplary Configuration 5>

Exemplary configuration 5 is an exemplary configuration of the coded Doppler phase rotation amounts when Condition 1 (different Doppler multiplexing pattern condition and code multiplexing pattern condition) is satisfied and Condition 2 is not satisfied.

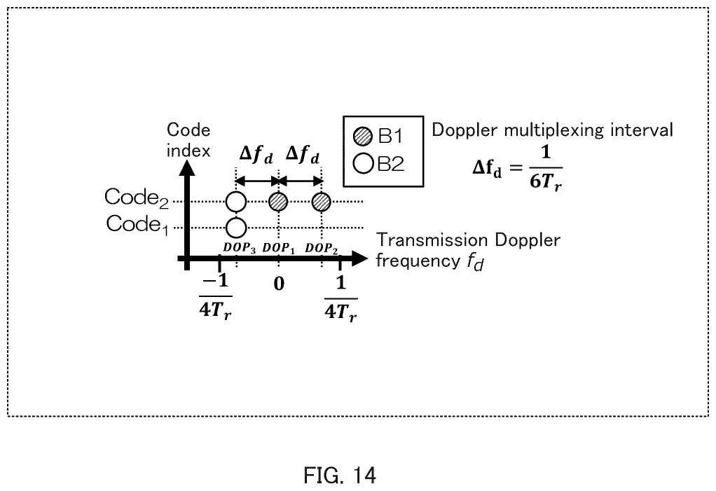

FIG. 14 illustrates an exemplary configuration of the coded Doppler phase rotation amounts in phase rotation amount setter 105 when number Nt of transmission antennas is 4, N_{B1} is 2, and N_{B2} is 2.

In FIGS. 14, Tx #1 and Tx #2 are transmission antennas with beam direction B1, and Tx #3 and Tx #4 are transmission antennas with beam direction B2. In FIG. 14, the shaded circles represent the assignment of the coded Doppler multiplexed signals for the transmission antennas (Tx #1 and Tx #2) with beam direction B1, and the white circles represent the assignment of the coded Doppler multiplexed signals for the transmission antennas (Tx #3 and Tx #4) with beam direction B2.

Further, in FIG. 14, Doppler multiplexing number N_{DM} is 3, and Doppler shift setter 106 may set three Doppler shift amounts DOP₁, DOP₂, and DOP₃ using, for example, the maximum even interval Doppler shift amount setting shown in Expression 5. In FIG. 14, the phase rotation amounts applying Doppler shift amounts DOP₁=0, DOP₂=Δfd, and DOP₃=−Δfd are φ₁=0, φ₂=2π/3, and φ₃=4π/3 (or φ₃=−2π/3), respectively. As illustrated in FIG. 14, Doppler multiplexing interval Δfd is an even interval, and Δfd=1/(6Tr).

In FIG. 14, number Nt of transmission antennas is 4, Doppler multiplexing number N_{DM} is 3, and code multiplexing number N_{CM} is 2, and since Nₜ<N_{DM}×N_{CM}, phase rotation amount setter 105 can set coded Doppler multiplexing number N_{DOP_CODE}(ndm) for the Doppler multiplexed signal non-uniformly (where ndm=1 to N_{DM}).

As illustrated in FIG. 14, the coded Doppler multiplexing numbers for the Doppler multiplexed signals with three Doppler shift amounts DOP₁, DOP₂, and DOP₃ inputted from Doppler shift setter 106 in encoder 107 are N_{DOP_CODE}(1)=1, N_{DOP_CODE}(2)=1, and N_{DOP_CODE}(3)=2, respectively. As described above, phase rotation amount setter 105 sets non-uniformly the coded Doppler multiplexing numbers for the Doppler multiplexed signals as N_{DOP_CODE}(1)=N_{DOP_CODE}(2)≠N_{DOP_CODE}(3).

Further, in FIG. 14, Doppler shift setter 106 assigns, for transmission antennas Tx #1 and Tx #2 with beam direction B1, Doppler multiplexed signals with, for example, Doppler shift amounts DOP₁ and DOP₂ among the Doppler multiplexed signals with Doppler multiplexing number N_{DM}=3 (N_{DM_B1}=2). Further, encoder 107 assigns Code₂ and Code₂ to the Doppler multiplexed signals with Doppler shift amounts DOP₁ and DOP₂ assigned to transmission antennas Tx #1 and Tx #2 with beam direction B1, respectively. For example, phase rotation amount setter 105 sets coded Doppler phase rotation amounts ψ_{2,1}(m) and ψ_{2,2}(m) for respective transmission antennas Tx #1 and Tx #2 with beam direction B1.

Further, in FIG. 14, Doppler shift setter 106 assigns, for transmission antennas Tx #3 and Tx #4 with beam direction B2, Doppler multiplexed signals with, for example, Doppler shift amount DOP₃ among the Doppler multiplexed signals with Doppler multiplexing number N_{DM}=3 (N_{DM_B2}=1). Further, encoder 107 assigns two codes, Code₁ and Code₂, to the Doppler multiplexed signals with Doppler shift amount DOP₃ assigned to transmission antennas Tx #3 and Tx #4 with beam direction B2. For example, phase rotation amount setter 105 sets coded Doppler phase rotation amounts ψ_{1,3}(m) and ψ_{2,3}(m) for transmission antennas Tx #3 and Tx #4 with beam direction B2.

In FIG. 14, the Doppler multiplexing numbers that Doppler shift setter 106 assigns to the transmission antennas with beam direction B1 and the transmission antennas with beam direction B2 are different Doppler multiplexing numbers of N_{DM_B1}=2 and N_{DM_B2}=1, respectively, and thus, item A-2 of Condition 1 is satisfied.

Further, in FIG. 14, the code indexes assigned to the transmission antennas with beam direction B1 and to the transmission antennas with beam direction B2 for the Doppler multiplexed signals with Doppler multiplexed signals DOP₁, DOP₂, and DOP₃ are CodeIndex_B1=(1, 1, *) and CodeIndex_B2=(*, *, 1&2), respectively. The code indexes are cyclically mismatched and the code INDEX intervals are different, and thus item B-1 of Condition 1 is satisfied.

Further, in FIG. 14, the code multiplexing numbers assigned to the transmission antennas with beam direction B1 and to the transmission antennas with beam direction B2 for the Doppler multiplexed signals DOP₁, DOP₂, and DOP₃ are N_Code_B1=(1, 1, 0) and N_Code_B2=(0, 0, 2), respectively, and the code multiplexing numbers are different, and thus item B-2 of Condition 1 is satisfied.

Note that, when the Doppler frequency of the target object is −1/(2Tr)≤fdtarget object<−1/(4Tr) or 1/(4Tr)≤fdtarget object<1/(2Tr), Doppler analyzer 210 described later observes an aliasing Doppler frequency. In this case, the code indexes are CodeIndex_B1_alias=(2, 2, *), and CodeIndex_B2_alias=(*, *, 1&2), which are different (cyclically mismatched). Thus, in the example of FIG. 14, in a range of −1/(2Tr)≤fdtarget object<−1/(2Tr) of the Doppler frequency of the target object, the code indexes become cyclically mismatched, and the code intervals are different. Accordingly, items B-1 and B-2 of Condition 1 are satisfied, and the different code multiplexing pattern condition is met.

Thus, the setting of the coded Doppler phase rotation amounts illustrated in FIG. 14 is an exemplary configuration that satisfies Condition 1.

Further, in FIG. 14, the code multiplexing number assigned to each Doppler multiplexed signal in the transmission antennas with beam direction B1 is N_Code_B1=(1, 1, 0), and the Doppler multiplexed signals are multiplexed and transmitted with a code multiplexing number that is non-uniform between the Doppler multiplexed signals, and the code multiplexing number is included in a range of 1 or more to N_{CM}−1 or less, and thus, Condition 2 is satisfied.

On the other hand, in FIG. 14, the code multiplexing number assigned to each Doppler multiplexed signal in the transmission antennas with beam direction B2 is N_Code_B2=(0, 0, 2), and the Doppler multiplexed signals are multiplexed and transmitted with a code multiplexing number that is non-uniform between the Doppler multiplexed signals, and the code multiplexing number is not included in a range of 1 or more to N_{CM}−1 or less, and thus, Condition 2 is not satisfied.

Thus, the setting of the coded Doppler phase rotation amounts illustrated in FIG. 14 is an exemplary configuration that satisfies Condition 2 for the transmission antennas with beam direction B1 and does not satisfy Condition 2 for the transmission antennas with beam direction B2.

Hereinafter, an example of reception signals in the outputs of Doppler analyzers 210 when transmission antenna section 109 includes transmission antennas with different beam directions B1 and B2 based on the setting of the Doppler shift amounts illustrated in FIG. 14, and reception antenna section 202 is an omnidirectional antenna (or an antenna having substantially uniform directional characteristics in a viewing angle covered by both transmission antennas with beam direction B1 and beam direction B2) will be described. For example, when the target object direction is target object direction (1)

illustrated in FIG. 10 (for example, when there is a target object in the periphery of beam direction B1), or when the target object direction is target object direction (3) illustrated in FIG. 10 (for example, when there is a target object in the periphery of beam direction B2), the code multiplexing number varies between the transmission antenna with beam direction B1 and the transmission antenna with beam direction B2. Therefore, in coded Doppler demultiplexer 212 to be described later, radar apparatus 10 can discriminate between a case where the reception level of the reception signal corresponding to the transmission antenna with beam direction B1 decreases and a case where the reception level of the reception signal corresponding to the transmission antenna with beam direction B2 decreases.

Further, when the discrimination result indicates that the reception signals are from the transmission antennas (Tx #1 and Tx #2) with beam direction B1, the setting of the coded Doppler multiplexed signals for Tx #1 and Tx #2 with beam direction B1 is known. Therefore, radar apparatus 10 can separate the multiplexed signals by performing an operation disclosed in, for example, PTLs 5 and 6. Further, when the reception signals are determined to be from the transmission antennas (Tx #3 and Tx #4) with beam direction B2, the setting of the coded Doppler multiplexed signals for Tx #3 and Tx #4 with beam direction B2 is known, and thus, radar apparatus 10 can separate the multiplexed signals in the same manner.

Further, in exemplary configuration 5, the setting of the coded Doppler phase rotation amounts by phase rotation amount setter 105 does not satisfy Condition 2 with respect to beam direction B2. In this case, the detectable Doppler frequency range fd is, depending on the target object direction, in the range of −1/(2Tr)≤fd<1/(2Tr) or in the range of −1/(2Loc N_{DM_B2}Tr)≤fd<1/(2Loc N_{DM_B2}Tr), and an effect of expanding the Doppler detection range depending on the target object direction can be obtained, compared to the Doppler detection range of the even interval DDM, which is −1/(6Tr)≤fd<1/(6Tr).

The above describes exemplary configurations of coded Doppler phase rotation amounts in phase rotation amount setter 105.

Note that the setting of the coded Doppler phase rotation amounts is not limited to the above-described exemplary configurations 1 to 5. For example, at least one of number Nt of transmission antennas, number N_{B1} of transmission antennas with beam direction B1, number N_{B2} of transmission antennas with beam direction B2, the Doppler multiplexing numbers (N_{DM}, N_{DM_B1}, and N_{DM_B2}), the code multiplexing numbers (N_{CM}, N_{CM_B1}, and N_{CM_B2}), multi-beam number NB, the code intervals, and the Doppler shift intervals may be another value.

Note that, the above-described exemplary configurations 1 to 5 illustrate the exemplary configurations using a code with code multiplexing number N_{CM}=2, but are not limited thereto, and the same setting of coded Doppler phase rotation amounts is possible even when code multiplexing number Ncm is set to, for example, N_{CM}≥3. [Configuration of Radar Receiver 200]

In FIG. 5, radar receiver 200 includes reception antenna section 202 including Na reception antennas Rx #1 to Rx #Na. Further, radar receiver 200 includes Na antenna system processors 201-1 to 201-Na, Constant False Alarm Rate (CFAR) section 211, coded Doppler demultiplexer 212, and direction estimator 213. Note that, Na antenna system processors 201-1 to 201-Na, CFAR section 211, coded Doppler demultiplexer 212, and direction estimator 213 may be collectively referred to as reception circuitry. The reception circuitry performs direction estimation of a target (target object) by using reflected wave signals resulted from the transmission signals being reflected by the target.

Reception antennas Rx #1 to Rx #Na of reception antenna section 202 each receive a reflected wave signal resulted from a radar transmission signal being reflected by a target object (target), and output the received reflected wave signal to the corresponding one of antenna system processors 201 as a reception signal.

Each of antenna system processors 201 includes reception radio 203 and signal processor 206.

Signals received by Na reception antennas Rx #1 to Rx #Na are output respectively to Na reception radios 203. Further, the output signals from Na reception radios 203 are output respectively to Na signal processors 206.

Each of reception radios 203 includes mixer 204 and low pass filter (LPF) 205. Mixer 204 mixes the received reflected wave signal with a chirp signal (which is a transmission signal) input from radar transmission signal generator 101. Reception radio 203, for example, cause the output of mixer 204 to pass through LPF 205. As a result, a beat signal, which has a frequency depending on a delay time of the reflected wave signal, is output. For example, the difference in frequency between the transmission chirp signal (transmission frequency modulated wave), which is the transmission signal (radar transmission wave), and the reception chirp signal (reception frequency modulated wave), which is the reception signal (radar reflected wave), is obtained as the beat frequency.

Signal processor 206 of each antenna system processor 201-z (where z is any one of 1 to Na) includes AD converter 207, beat frequency analyzer 208, output switch 209, and Doppler analyzer 210.

The signal (for example, beat signal) outputted from LPF 205 is converted into discretely sampled data by AD converter 207 in signal processor 206.

Beat frequency analyzer 208 performs frequency analysis processing (for example, FFT processing) on the N_{data} pieces of discrete sample data obtained within a specified time range (range gate) for each transmission period Tr. Signal processor 206 thus outputs a frequency spectrum in which a peak appears at a beat frequency dependent on the delay time of the reflected wave signal (radar reflected wave).

Here, the beat frequency response output from beat frequency analyzer 208 in zth signal processor 206 obtained by the mth chirp pulse transmission is denoted as “RFT_{z}(f_{b}, m).” Here, f_{b} denotes the beat frequency index and corresponds to an FFT index (bin number). For example, f_{b}=0, . . . , (N_{data}/2)−1, z=1 to Na, and m=1 to N_{C}. A beat frequency having smaller beat frequency index f_{b} indicates a shorter delay time of the reflected wave signal (for example, a shorter distance to the target object).

Further, beat frequency index f_{b} can be converted into distance information R(f_{b}) using following Expression 10. Thus, in the following, beat frequency index fb is also referred to as “distance index f_{b}.”

$$\begin{matrix}[ 10 ] & \\ R ( {f}_{b} ) = \frac{{C}_{0} {f}_{b}}{2 {B}_{w}} & ( Expression 10 )\end{matrix}$$

Here, B_{w} denotes a frequency-modulation bandwidth within the range gate for a chirp signal, and C₀ denotes the speed of light. Also, in Expression 10, C₀/(2B_{w}) represents the distance resolution.

Output switch 209 selectively switches to output the output of beat frequency analyzer 208 for each transmission period to OC_INDEX-th Doppler analyzer 210 among Loc Doppler analyzers 210, based on orthogonal code element index OC_INDEX inputted from encoder 107 of phase rotation amount setter 105, and outputs the output. For example, output switch 209 selects the OC_INDEX-th Doppler analyzer 210 obtained by Expression 8 in the mth transmission period Tr.

Signal processor 206 includes Loc Doppler analyzers 210-1 to 210-Loc. For example, data is inputted by output switch 209 to nocth Doppler analyzer 210 for each of Loc transmission periods (Loc×Tr). Therefore, nocth Doppler analyzer 210 performs Doppler analysis for each distance index fb using data (for example, beat frequency response RFT_{z}(f_{b}, m) inputted from beat frequency analyzer 208) of Ncode transmission periods out of Nc transmission periods. Here, noc is an index of the code element, and noc=1 to Loc.

For example, when Ncode is a power of 2, FFT processing is applicable in the Doppler analysis. In this case, the FFT size is Ncode, and a maximum Doppler frequency that is derived from the sampling theorem and in which no aliasing occurs is +1/(2Loc×Tr). Further, the Doppler frequency interval of Doppler frequency index fₛ is 1/(Ncode×Loc×Tr), and the range of Doppler frequency index fₛ is fₛ=−Ncode/2, . . . , 0, . . . , Ncode/2−1.

The following description will be given of a case where Ncode is a power of 2, as an example. Note that, when Ncode is not a power of 2, FFT processing can be performed with a data size (FFT size) that is a power of 2 by including zero-padded data, for example.

For example, output VFT_{z}^{noc}(f_{b}, fₛ) of Doppler analyzer 210 in zth signal processor 206 is represented by the following Expression 11. Note that j is an imaginary unit, and z=1 to Na.

$$\begin{matrix}[ 11 ] & \\ {VFT}_{z}^{n o c} ( {f}_{b} , {f}_{s} ) = {\sum }_{s = 0}^{{N}_{code} - 1} {RFT}_{z} ( {f}_{b} , {L}_{OC} \times s + noc ) exp [ - j \frac{2 π {sf}_{s}}{{N}_{code}} ] & ( Expression 11 )\end{matrix}$$

The processing in each component of signal processor 206 has been described above.

### [Exemplary Operation of CFAR Section 211]

In FIG. 5, CFAR section 211 performs CFAR processing (for example, adaptive threshold determination) using the outputs of Loc Doppler analyzers 210 of each of first to Nath signal processors 206, and extracts distance index f_{b_cfar} and Doppler frequency index f_{s_cfar} that give the peak signal.

CFAR section 211 performs, for example, CFAR processing in which the outputs VFT_{z}^{noc} (f_{b}, fₛ) of Doppler analyzers 210 of first to Nath signal processors 206 are power-added and two-dimensional CFAR processing including a distance axis and a Doppler frequency axis (corresponding to a relative velocity) or one-dimensional CFAR processes are combined, as in the following Expression 12 (for example, the processing disclosed in NPL 2 may be applied).

$$\begin{matrix}[ 12 ] & \\ PowerFT ( {f}_{b} , {f}_{s} ) = {\sum }_{z = 1}^{{N}_{a}} {\sum }_{noc = 1}^{{L}_{oc}} {\vert {VFT}_{z}^{noc} ( {f}_{b} , {f}_{s} ) \vert}^{2} & ( Expression 12 )\end{matrix}$$

CFAR section 211 adaptively sets a threshold, and outputs, to coded Doppler demultiplexer 212, distance index f_{b_cfar}, Doppler frequency index f_{s_cfar}, and reception power information PowerFT (f_{b_cfar}, f_{s_cfar}) that provide reception power larger than the threshold.

Note that, when, for example, Expression 5 is used as phase rotation amount φ_{ndm} for applying Doppler shift amount DOP_{ndm}, the interval of the Doppler shift amounts in the Doppler frequency domain in the outputs of Doppler analyzers 210 is even, and when the interval ΔFD of the Doppler shift amounts is represented by the interval of the Doppler frequency index, ΔFD=Ncode/N_{DM}. Accordingly, in the outputs of Doppler analyzers 210, a peak is detected for each Doppler-shift multiplexed signal at an interval of ΔFD in the Doppler frequency domain.

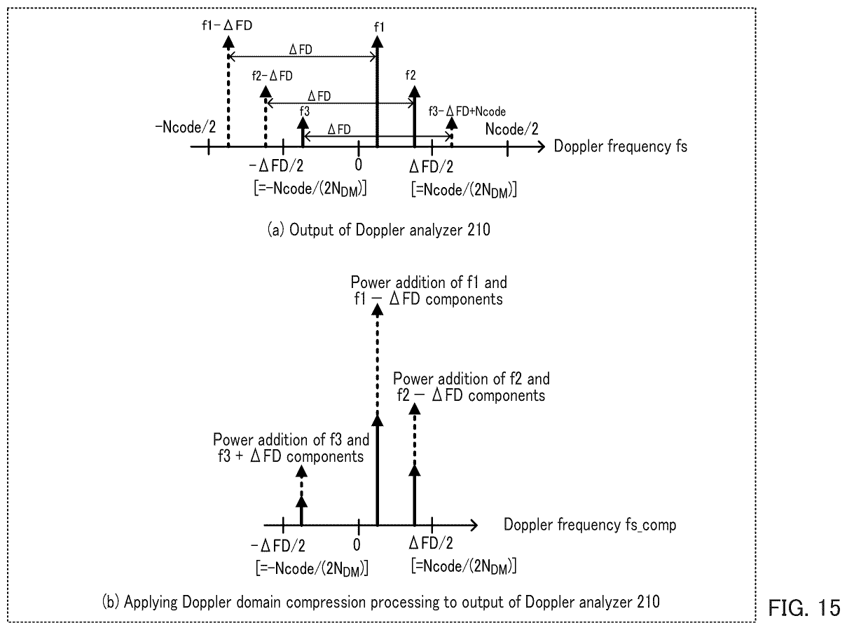

The part (a) in FIG. 15 illustrates an example of the outputs of Doppler analyzers 210 at a distance where the reflected waves of three targets are present in the case of N_{DM}=2. For example, as illustrated at part (a) in FIG. 15, when reflected waves from the three targets are observed at Doppler frequency indexes f1, f2, and f3, the reflected waves are also observed at the respective Doppler frequency indexes at interval ΔFD (for example, f1−ΔFD, f2−ΔFD, and f3−ΔFD+Ncode).

Accordingly, CFAR section 211 may divide each output of Doppler analyzer 210 into ranges of interval ΔFD of the Doppler shift amount, and may perform CFAR processing (for example, referred to as “Doppler domain compression CFAR processing”) after power addition (for example, referred to as “Doppler domain compression”) of each signal peak position subjected to Doppler multiplexing for each divided range, as shown in the following Expression 13. Here, f_{s_comp}=−ΔFD/2, . . . , −ΔFD/2−1. For example, when ΔFD=Ncode/N_{DM}, f_{s_comp}=Ncode/(2N_{DM}), . . . , Ncode/(2N_{DM})−1.

$$\begin{matrix}[ 13 ] & \\ {PowerFT}_{comp} ( {f}_{b} , {f}_{s \_ comp} ) = {\sum }_{nfd = 1}^{{N}_{DM}} PowerFT ( {f}_{b} , {f}_{s \_ comp} + ( nfd - ceil ( \frac{{N}_{DM}}{2} ) - 1 \times Δ FD ) & ( Expression 13 )\end{matrix}$$

In Expression 13, however, in the case of the following:

$$[ 14 ]$$

$${f}_{s \_ comp} + ( nfd - ceil ( \frac{{N}_{DM}}{2} ) - 1 ) \times Δ FD < - Ncode / 2 ,$$

the Doppler frequency index to which Ncode is added is used.

Similarly, in Expression 13, in the case of the following:

$$[ 15 ]$$

$${f}_{s \_ comp} + ( nfd - ceil ( \frac{{N}_{DM}}{2} ) - 1 ) \times Δ FD > \frac{Ncode}{2} - 1 ,$$

the Doppler frequency index from which Ncode is further subtracted is used.

The part (b) in FIG. 15 illustrates an example of the output after applying the Doppler domain compression processing shown in Expression 13 to the outputs of Doppler analyzers 210 illustrated at part (a) in FIG. 15. As illustrated at part (b) in FIG. 15, in the case of N_{DM}=2, CFAR section 211 adds the power component of Doppler frequency index f1 to the power component of f1−ΔFD by the Doppler domain compression processing and outputs the result. In the same manner, as illustrated at part (b) in FIG. 15, CFAR section 211 adds the power component of Doppler frequency index f2 with the power component of f2−ΔFD and outputs the result. Further, for the power component of Doppler frequency index f3, since f3−ΔFD is smaller than-Ncode/2, CFAR section 211 adds the power component of Doppler frequency index f3 to the power component of f3−ΔFD+Ncode (for example, f3+ΔFD in the case of N_{DM}=2) and outputs the result.

As a result of the Doppler domain compression, the range of Doppler frequency index fs_comp in the Doppler frequency domain is reduced to −ΔFD/2 or more to ΔFD/2−1 or less (in the case of ΔFD=Ncode/N_{DM}, −Ncode/(2N_{DM}) or more to Ncode/(2N_{DM})−1 or less).

CFAR section 211 using the Doppler domain compression CFAR processing, for example, adaptively sets a threshold and outputs, to coded Doppler demultiplexer 212, distance index f_{b_cfar}, Doppler frequency indexes f_{s_comp_cfar}, and reception power information PowerFT (f_{b_cfar}, f_{s_comp_cfar}+(nfd−ceil(N_{DM}/2)−1)×ΔFD), nfd=1, . . . , N_{DM} at N_{DM} Doppler frequency indexes (f_{s_comp_cfar}+ (nfd−ceil(N_{DM}/2)−1)×ΔFD) that provide reception power larger than the threshold.

### [Exemplary Operation of Coded Doppler Demultiplexer 212]

Next, an exemplary operation of coded Doppler demultiplexer 212 illustrated in FIG. 5 will be described.

The following describes an example of processing performed by coded Doppler demultiplexer 212 when CFAR section 211 uses the Doppler domain compression CFAR processing. Further, the operation of coded Doppler demultiplexer 212 when omnidirectional antennas (or antennas with substantially uniform directional characteristics over the entire viewing angle covered by a plurality of transmission antennas with different beam directions) are used as a plurality of reception antennas will be described.

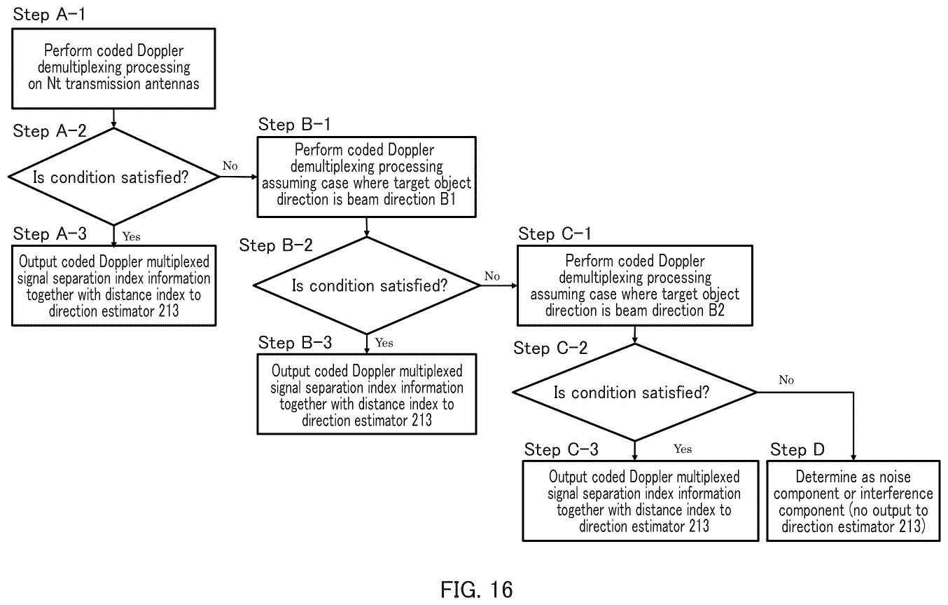

FIG. 16 is a flowchart illustrating an example of the separation operation in coded Doppler demultiplexer 212.

### <Step A-1>

Coded Doppler demultiplexer 212 performs coded Doppler demultiplexing processing for Nt coded Doppler multiplexed signals.

For example, coded Doppler demultiplexer 212 separates Nt coded Doppler multiplexed signals using the outputs of Doppler analyzers 210 based on the distance index f_{b_cfar}, Doppler frequency indexes f_{s_comp_cfar}, reception power information (PowerFT(f_{b_cfar}, f_{s_comp_cfar}+(nfd−ceil(N_{DM}/2)−1)×ΔFD), nfd=1 to N_{DM}) at Doppler frequency indexes of N_{DM} Doppler multiplexed signals (f_{s_comp_cfar}+(nfd−ceil (N_{DM}/2)−1)×ΔFD) inputted from CFAR section 211, and discriminates (e.g., determines or identifies) the transmission antennas and discriminates the Doppler frequencies (e.g., Doppler velocity or relative velocity).

As described above, when using the setting of the even interval Doppler shift amount including the setting of the maximum even interval Doppler shift amount, encoder 107 of phase rotation amount setter 105 utilizes, for example, not setting all N_{DM} coded Doppler multiplexing numbers N_{DOP_CODE}(1), N_{DOP_CODE}(2), . . . , N_{DOP_CODE}(N_{DM}) to N_{CM}, but setting at least one coded Doppler multiplex number to a value smaller than NCM (setting non-uniformly).

For example, coded Doppler demultiplexer 212(1) performs code separation processing, detects an coded Doppler multiplexed signal in which the coded Doppler multiplexing number is set to be smaller than N_{CM} (for example, detects an unused coded Doppler multiplexed signal that is not used for multiplexing transmission), and performs aliasing determination. Thereafter, coded Doppler demultiplexer 212(2) performs Doppler code separation processing on coded Doppler multiplexed signals used for multiplexing transmission based on the aliasing determination result.

Such operation of coded Doppler demultiplexer 212 as described above is the same as the operation of an coded Doppler demultiplexer in a MIMO radar using known coded Doppler multiplexing transmission, and is described in, for example, PTLs 5 and 6, and thus, a detailed description of the operation will be omitted.

Note that, as the even interval Doppler shift amount setting including the maximum even interval Doppler shift amount setting, for example, when not all of N_{DM} coded Doppler multiplexing numbers N_{DOP_CODE}(1), N_{DOP_CODE}(2), . . . , and N_{DOP_CODE}(N_{DM}) are set to N_{CM}, and at least one coded Doppler multiplexing number is set to a value smaller than N_{CM}, the Doppler frequency of the target object estimated in the range of −1/(2Tr)≤fd<1/(2Tr) is detectable by the operation of coded Doppler demultiplexer 212 described above (for example, PTLs 5 and 6).

### <Step A-2>

Coded Doppler demultiplexer 212 determines whether Nt coded Doppler multiplexed signals have been detected normally. When Nt coded Doppler multiplexed signals are normally detected, coded Doppler demultiplexer 212 performs the processing in step A-3, and when Nt coded Doppler multiplexed signals are not normally detected, coded Doppler demultiplexer 212 performs the processing in step B-1.

For example, in the processing of step A-1, there may be a case where Nt coded Doppler multiplexed signals are not detected normally depending on the consistency between the main beam direction of the multi-beam and the target object direction.

For example, the following is assumed: a multi-beam MIMO radar is configured using transmission antennas with two beam directions B1 and B2, and the setting of phase rotation amount setter 105 is N_{DM}>N_{DM_B1} or N_{DM}>N_{DM_B2} (where N_{DM_B1}, and N_{DM_B2}<N_{DM}). In this case, when the main beam direction of the multi-beam does not coincide with the target object direction, and there is a target object in the null direction, the reception power varies by more than a predetermined value, or a component with a reception power as small as the noise level is included between the reception powers PowerFT (f_{b_cfar}, f_{s_comp_cfar}+(nfd-ceil (N_{DM}/2)−1)×ΔFD) at Doppler frequency indexes (f_{s_comp_cfar}+(nfd-ceil (N_{DM}/2)−1)×ΔFD) of N_{DM} Doppler multiplexed signals. In such a case, coded Doppler demultiplexer 212 detects a coded Doppler multiplexed signal that is less than N_{DM}, and thus, determines that the detection is not normal, and performs the processing in step B-1.

Further, for example, when the setting of phase rotation amount setter 105 is N_{DM}=N_{DM_B1} for the transmission antenna with beam direction B1, the main beam direction B2 of the multi-beam does not coincide with the target object direction, and the target object direction is in the null direction, or when the setting of phase rotation amount setter 105 is N_{DM}=N_{DM_B2} for the transmission antenna with beam direction B2, the main beam direction B2 of the multi-beam does not coincide with the target object direction, and the target object direction is in the null direction, the reception power within a predetermined range is received between the reception powers PowerFT (f_{b_cfar}, f_{s_comp_cfar}+(nfd-ceil(N_{DM}/2)−1)×ΔFD) at Doppler frequency indexes (f_{s_comp_cfar}+(nfd-ceil(N_{DM}/2)−1)×ΔFD) of the N_{DM} Doppler multiplexed signals. In this case, the number of unused coded Doppler multiplexed signals that are not used for multiplexing transmission becomes larger than the assumed number of (N_{DM}−Nₜ) signals during the code separation processing. As a result, coded Doppler demultiplexer 212 fails in the aliasing determination, making it difficult to detect Nt coded Doppler multiplexed signals normally. Accordingly, since the number of unused coded Doppler multiplexed signals that are not used for multiplexing transmission is detected to be larger than the assumed number of (N_{DM}−Nₜ) signals, coded Doppler demultiplexer 212 determines that the detection is not normal and performs the processing in step B-1.

### <Step A-3>

Based on the aliasing determination result, coded Doppler demultiplexer 212 outputs, to direction estimator 213, reception signal Y_{z}(f_{b_cfar}, f_{s_comp_cfar}, ncm, ndm) subjected to the coded Doppler demultiplexing processing of the coded Doppler multiplexed signal used for the multiplexing transmission together with distance index f_{b_cfar} and Doppler frequency index f_{s_comp_cfar}.

Here, Y_{z}(f_{b_cfar}, f_{s_comp_cfar}, ndop_code(ndm), ndm) is the separated output (for example, the coded Doppler demultiplexing result) of the coded Doppler multiplexed signals with Doppler shift amount DOP_{ndm} and orthogonal code Code_{ndop_code(ndm)} at distance index f_{b_cfar} and Doppler frequency index f_{s_comp_cfar} of Doppler analyzer 210 in zth antenna system processor 201. For example, Y_{z}(f_{b_cfar}, f_{s_comp_cfar}, ndop_code(ndm), ndm) represents a reception signal that is transmitted from transmission antenna Tx #[ndop_code(ndm), ndm], is reflected by the target object, and is received by zth antenna system processor 201. Note that z=1 to Na, and ncm=1 to N_{CM}. Further, ndm=1 to N_{DM}, and ndop_code(ndm)=1 to N_{DOP_CODE}(ndm).

Further, coded Doppler demultiplexer 212 may, for example, output information on the Doppler frequency of the detected target object to direction estimator 213.

When Condition 2 is satisfied, coded Doppler demultiplexer 212 can detect the Doppler frequency of the target object estimated in the range of −1/(2Tr)≤fd<1/(2Tr) by using the aliasing determination result.

### <Step B-1>

Coded Doppler demultiplexer 212 performs coded Doppler demultiplexing processing for N_{B1} coded Doppler multiplexed signals, assuming that the target object direction is beam direction B1.

For example, coded Doppler demultiplexer 212 separates N_{B1} coded Doppler multiplexed signals using the outputs of Doppler analyzers 210 based on the distance index f_{b_cfar}, Doppler frequency indexes f_{s_comp_cfar}, reception power information (PowerFT(f_{b_cfar}, f_{s_comp_cfar}+(nfd-ceil(N_{DM}/2)−1)×ΔFD), nfd=1 to N_{DM}) at Doppler frequency indexes of N_{DM} Doppler multiplexed signals (f_{s_comp_cfar}+(nfd-ceil(N_{DM}/2)−1)×ΔFD) inputted from CFAR section 211, and discriminates (e.g., determines or identifies) the transmission antennas and discriminates the Doppler frequencies (e.g., Doppler velocity or relative velocity).

There are cases where the reception power varies by a predetermined value or more between the reception powers PowerFT (f_{b_cfar}, f_{s_comp_cfar}+ (nfd-ceil (N_{DM}/2)−1)×ΔFD) at Doppler frequency indexes (f_{s_comp_cfar}+(nfd-ceil (N_{DM}/2)−1)×ΔFD) of the N_{DM} Doppler multiplexed signals, or where (N_{DM}−N_{DM_B1}) components with reception power as small as the noise level are included. Note that, when the setting of phase rotation amount setter 105 is N_{DM}=N_{DM_B1}, (N_{DM}−N_{DM_B1})=0, and a component with reception power as small as the noise level is not included. These Doppler multiplexed signals are unused Doppler multiplexed signals that are not used for multiplexed transmission.

Accordingly, coded Doppler demultiplexer 212 extracts, for example, N_{DM_B1} Doppler multiplexed signals with the highest power among the reception powers PowerFT(f_{b_cfar}, f_{s_comp_cfar}+(nfd-ceil(N_{DM}/2)−1)×ΔFD) at Doppler frequency indexes (f_{s_comp_cfar}+(nfd-ceil (N_{DM}/2)−1)×ΔFD) of N_{DM} Doppler multiplexed signals.

For example, when the Doppler multiplexing interval of the extracted N_{DM_B1} Doppler multiplexed signals with the highest power matches the Doppler multiplexing interval assigned to the transmission antennas with beam direction B1, coded Doppler demultiplexer 212(1) performs code separation processing, detects an coded Doppler multiplexed signal with the coded Doppler multiplexing number set to be smaller than N_{CM} from the coded Doppler multiplexed signals assigned to the transmission antennas with beam direction B1 (for example, detects an unused coded Doppler multiplexed signal that is not used for multiplexing transmission), and performs an aliasing determination. Thereafter, coded Doppler demultiplexer 212(2) performs Doppler code separation processing on coded Doppler multiplexed signals used for multiplexing transmission based on the aliasing determination result.

Such operation of coded Doppler demultiplexer 212 as described above is the same as the operation of an coded Doppler demultiplexer in a MIMO radar using known coded Doppler multiplexing transmission, and is described in, for example, PTLs 5 and 6, and thus, a detailed description of the operation will be omitted.

Note that, by satisfying Condition 2 with the setting of the coded Doppler phase rotation amount, the Doppler frequency of the target object estimated in the range of −1/(2Tr)≤fd<1/(2Tr) can be detected by, for example, the operation of coded Doppler demultiplexer 212 described above (for example, PTLs 5 and 6).

### <Step B-2>

Coded Doppler demultiplexer 212 determines whether N_{B1} coded Doppler multiplexed signals assigned to N_{B1} transmission antennas included in beam direction B1 are normally detected. When N_{B1} coded Doppler multiplexed signals are normally detected, coded Doppler demultiplexer 212 performs the processing in step B-3, and when the N_{B1} coded Doppler multiplexed signals are not normally detected, coded Doppler demultiplexer 212 performs the processing in step C-1.

For example, in the processing of step B-1, there may be a case where N_{B1} coded Doppler multiplexed signals are not detected normally depending on the consistency between the main beam direction of the multi-beam and the target object direction.

Coded Doppler demultiplexer 212, for example, determines that the target object direction is not beam direction B1 and performs the processing in step C-1 when the power difference (or power ratio) between the extracted N_{DM} B1 Doppler multiplexed signals with the highest power and the other (N_{DM}−N_{DM_B1}) Doppler multiplexed signals with lower power is not equal to or greater than a predetermined level.

Further, when the extracted Doppler multiplexing interval of the extracted N_{DM_B1} Doppler multiplexed signals with the highest power does not coincide with the Doppler multiplexing interval assigned to the transmission antennas with beam direction B1, coded Doppler demultiplexer 212 determines that the target object direction is not beam direction B1 and performs the processing in step C-1.

Further, for example, the setting of phase rotation amount setter 105 is assumed to be N_{DM_B1}=N_{DM_B2} with respect to beam direction B1. In this case, when the main beam direction B2 of the multi-beam and the target object direction do not coincide with each other and the target object is present in the null direction, the reception power within a predetermined range is received between the reception powers PowerFT (f_{b_cfar}, f_{s_comp_cfar}+(nfd-ceil(N_{DM}/2)−1)×ΔFD) at Doppler frequency indexes (f_{s_comp_cfar}+(nfd-ceil(N_{DM}/2)−1)×ΔFD) of the N_{DM} Doppler multiplexed signals. In such a case, unused coded Doppler multiplexed signals that are not used for the multiplexing transmission have a code interval different from the code interval of the N_{B1} coded Doppler multiplexed signals assumed in the code separation processing. Therefore, coded Doppler demultiplexer 212 fails in the aliasing determination, and it becomes difficult to normally detect N_{B1} coded Doppler multiplexed signals. In such a case, coded Doppler demultiplexer 212 determines that the detection for the N_{B1} coded Doppler multiplexed signals is not normal, and performs the processing in step C-1.

### <Step B-3>

Coded Doppler demultiplexer 212 outputs, to direction estimator 213, reception signals YB1_{z}(f_{b_cfar}, f_{s_comp_cfar}, ncm, ndm) subjected to the coded Doppler demultiplexing processing of the coded Doppler multiplexed signals used for the multiplexing transmission of N_{B1} transmission antennas with beam direction B1, based on the processing result in step B-2 together with distance index f_{b_cfar} and Doppler frequency index f_{s_comp_cfar}.

Here, YB1_{z}(f_{b_cfar}, f_{s_comp_cfar}, ndop_code(ndm), ndm) is the separated output (for example, the coded Doppler demultiplexing result) of the coded Doppler multiplexed signals with Doppler shift amount DOP_{ndm} and orthogonal code Code_{ndop_code(ndm)} at distance index f_{b_cfar} and Doppler frequency index f_{s_comp_cfar} in Doppler analyzer 210 in zth antenna system processor 201. For example, YB1_{z}(f_{b_cfar}, f_{s_comp_cfar}, ndop_code(ndm), ndm) represents a reception signal that is transmitted from N_{B1} transmission antennas Tx #[ndop_code(ndm), ndm] with beam direction B1, is reflected by the target object, and is received by zth antenna system processor 201. Note that z=1 to Na. Further, ndm=1 to N_{DM}, ndop_code(ndm)=1 to N_{DOP_CODE}(ndm), and signals other than those assigned to N_{B1} transmission antennas with beam direction B1 are output as zero.

Further, coded Doppler demultiplexer 212 may output the Doppler frequency of the detected target object to direction estimator 213.

Note that, when Condition 2 is satisfied, coded Doppler demultiplexer 212 can detect the Doppler frequency of the target object estimated in the range of −1/(2Tr)≤fd<1/(2Tr) by using the aliasing determination result.

### <Step C-1>

Coded Doppler demultiplexer 212 performs coded Doppler demultiplexing processing for N_{B2} coded Doppler multiplexed signals, assuming that the target object direction is beam direction B2.

For example, coded Doppler demultiplexer 212 separates N_{B2} coded Doppler multiplexed signals using the outputs of Doppler analyzer 210 based on distance index f_{b_cfar}, Doppler frequency index f_{s_comp_cfar}, and reception power information (PowerFT(f_{b_cfar}, f_{s_comp_cfar}+(nfd-ceil(N_{DM}/2)−1)×ΔFD), nfd=1 to N_{DM}) at Doppler frequency indexes (f_{s_comp_cfar}+(nfd-ceil (N_{DM}/2)−1)×ΔFD) of N_{DM} Doppler multiplexed signals (which are the outputs of CFAR section 211), and discriminates (e.g., determines or identifies) the transmission antennas and discriminates the Doppler frequencies (e.g., Doppler velocity or relative velocity).

There are cases where the reception power varies by a predetermined value or more between the reception powers PowerFT (f_{b_cfar}, f_{s_comp_cfar}+(nfd-ceil(N_{DM}/2)−1)×ΔFD) at Doppler frequency indexes (f_{s_comp_cfar}+(nfd-ceil (N_{DM}/2)−1)×ΔFD) of the N_{DM} Doppler multiplexed signals, or where (N_{DM}−N_{DM_B2}) components with reception power as small as the noise level are included. Note that, when the setting of phase rotation amount setter 105 is N_{DM}=N_{DM_B2}, (N_{DM}−N_{DM_B2})=0, and a component with reception power as small as the noise level is not included. These Doppler multiplexed signals are unused Doppler multiplexed signals that are not used for multiplexed transmission.

Accordingly, coded Doppler demultiplexer 212 extracts, for example, N_{DM_B2} Doppler multiplexed signals with the highest power among the reception powers PowerFT(f_{b_cfar}, f_{s_comp_cfar}+(nfd-ceil(N_{DM}/2)−1)×ΔFD) at Doppler frequency indexes (f_{s_comp_cfar}+(nfd-ceil(N_{DM}/2)−1)×ΔFD) of N_{DM} Doppler multiplexed signals.

For example, when the Doppler multiplexing interval of the extracted N_{DM_B2} Doppler multiplexed signals with the highest power matches the Doppler multiplexing interval assigned to the transmission antennas with beam direction B2, coded Doppler demultiplexer 212(1) performs code separation processing, detects an coded Doppler multiplexed signal with the coded Doppler multiplexing number set to be smaller than N_{CM} from the coded Doppler multiplexed signals assigned to the transmission antennas with beam direction B2 (for example, detects an unused coded Doppler multiplexed signal that is not used for multiplexing transmission), and performs aliasing determination. Thereafter, coded Doppler demultiplexer 212(2) performs Doppler code separation processing on coded Doppler multiplexed signals used for multiplexing transmission based on the aliasing determination result.

Such operation of coded Doppler demultiplexer 212 as described above is the same as the operation of an coded Doppler demultiplexer in a MIMO radar using known coded Doppler multiplexing transmission, and is described in, for example, PTLs 5 and 6, and thus, a detailed description of the operation will be omitted.

Note that, by satisfying Condition 2 with the setting of the coded Doppler phase rotation amount, the Doppler frequency of the target object estimated in the range of −1/(2Tr)≤fd<1/(2Tr) can be detected by, for example, the operation of coded Doppler demultiplexer 212 described above (for example, PTLs 5 and 6).

### <Step C-2>

Coded Doppler demultiplexer 212 determines whether N_{B2} coded Doppler multiplexed signals assigned to N_{B2} transmission antennas included in beam direction B2 are detected normally. When N_{B2} coded Doppler multiplexed signals are normally detected, coded Doppler demultiplexer 212 performs the processing in step C-3, and when the N_{B2} coded Doppler multiplexed signals are not normally detected, coded Doppler demultiplexer 212 performs the processing in step D.

For example, in the processing of step C-1, there may be a case where N_{B2} coded Doppler multiplexed signals are not normally detected depending on the consistency between the main beam direction of the multi-beam and the target object direction.

Coded Doppler demultiplexer 212, for example, determines that the target object direction is not beam direction B2 and performs the processing in step D when the power difference (or power ratio) between the extracted N_{DM} B2 Doppler multiplexed signals with the highest power and the other (N_{DM}−N_{DM_B2}) Doppler multiplexed signals with the lowest power is not equal to or greater than a predetermined level.

Further, when the Doppler multiplexing interval of the extracted N_{DM_B2} Doppler multiplexed signals with the highest power does not coincide with the Doppler multiplexing interval assigned to the transmission antennas with beam direction B2, coded Doppler demultiplexer 212 determines that the target object direction is not beam direction B2 and performs the processing in step D.

Further, for example, the setting of phase rotation amount setter 105 is assumed to be N_{DM} B1=N_{DM_B2} with respect to beam direction B2. In this case, when the main beam direction B2 of the multi-beam and the target object direction do not coincide with each other and the target object is present in the null direction, the reception power within a predetermined range is received between the reception powers PowerFT(f_{b_cfar}, f_{s_comp_cfar}+(nfd-ceil(N_{DM}/2)−1)×ΔFD) at Doppler frequency indexes (f_{s_comp_cfar}+(nfd-ceil(N_{DM}/2)−1)×ΔFD) of the N_{DM} Doppler multiplexed signals. In such a case, the unused coded Doppler multiplexed signal that is not used for multiplexing transmission has a code interval different from the code interval of the N_{B2} coded Doppler multiplexed signals assumed in the code separation processing. Therefore, coded Doppler demultiplexer 212 fails in the aliasing determination, and it becomes difficult to normally detect N_{B2} coded Doppler multiplexed signals. In such a case, coded Doppler demultiplexer 212 determines that the detection for the N_{B2} coded Doppler multiplexed signals is not normal, and performs the processing in step D.

### <Step C-3>

Coded Doppler demultiplexer 212 outputs, to direction estimator 213, reception signals YB2_{z}(f_{b_cfar}, f_{s_comp_cfar}, ncm, ndm) subjected to the coded Doppler demultiplexing processing of the coded Doppler multiplexed signals used for the multiplexing transmission of N_{B2} transmission antennas with beam direction B2, based on the processing result in step C-2 together with distance index f_{b_cfar} and Doppler frequency index f_{s_comp_cfar}.

Here, YB2_{z}(f_{b_cfar}, f_{s_comp_cfar}, ndop_code(ndm), ndm) is the separated output (for example, the coded Doppler demultiplexing result) of the coded Doppler multiplexed signals with Doppler shift amount DOP_{ndm} and orthogonal code Code_{ndop_code}(ndm) in distance index f_{b_cfar} and Doppler frequency index f_{s_comp_cfar} in Doppler analyzer 210 in zth antenna system processor 201. For example, YB2_{z}(f_{b_cfar}, f_{s_comp_cfar}, ndop_code(ndm), ndm) represents a reception signal that is transmitted from N_{B2} transmission antennas Tx #[ndop_code(ndm), ndm] with beam direction B2, is reflected by the target object, and is received by zth antenna system processor 201. Note that z=1 to Na. Further, ndm=1 to N_{DM}, ndop_code(ndm)=1 to N_{DOP_CODE}(ndm), and signals other than those assigned to N_{B2} transmission antennas with beam direction B2 are output as zero.

Further, coded Doppler demultiplexer 212 may output the Doppler frequency of the detected target object to direction estimator 213.

Note that, when Condition 2 is satisfied, coded Doppler demultiplexer 212 can detect the Doppler frequency of the target object estimated in the range of −1/(2Tr)≤fd<1/(2Tr) by using the aliasing determination result.

### <Step D>

When the condition in step C-2 is not satisfied, coded Doppler demultiplexer 212 may determine that the reception signal is a noise component or an interference component, and does not have to output the reception signal to direction estimator 213.

Note that, in the exemplary operation of coded Doppler demultiplexer 212 described above, the case where multi-beam number NB is 2 has been described, but multi-beam number NB is not limited thereto, and may be, for example, 3 or more. For example, when multi-beam number NB is 3, Doppler demultiplexer 212 may continue to perform Doppler demultiplexing processing for a beam direction different from beam directions B1 and B2 (or an overlapping beam range or a different beam, for example, beam direction B3) in step D (or between step C-2 and step D). This enables a similar Doppler demultiplexing operation even when the multi-beam number is further increased.

The exemplary operation of coded Doppler demultiplexer 212 has been described above.

Note that, when there are a plurality of distance indexes f_{b_cfar}, Doppler frequency indexes f_{sddm_cfar}, and a plurality of pieces of reception power information (PowerFT(f_{b_cfar}, f_{sddm_cfar}+(ndm−1)×N_{Δfa})) inputted from CFAR section 211, coded Doppler demultiplexer 212 may perform the above-described operation of coded Doppler demultiplexing a plurality of times for each of the distance index, the Doppler frequency index, and the reception power information, for example.

### [Exemplary Operation of Direction Estimator 213]

Next, an exemplary operation of direction estimator 213 illustrated in FIG. 5 will be described.

The following describes an exemplary operation of direction estimator 213 in the case where a plurality of reception antennas of reception antenna section 202 are the same omnidirectional antenna or antennas having substantially uniform directional characteristics within the viewing angle of reception antennas with the plurality of different beam directions.

Direction estimator 213 performs, for example, direction estimation processing of a target object based on a signal inputted from coded Doppler demultiplexer 212 (for example, distance index f_{b_cfar}, or reception signal Y_{z}(f_{b_cfar}, f_{s_comp_cfar}, ndop_code(ndm), ndm) or YBq_{z}(f_{b_cfar}, f_{s_comp_cfar}, ndop_code(ndm), ndm) subjected to the coded Doppler demultiplexing processing). Here, q=1 to NB. When the multi-beam number is two (NB=2), q is 1 or 2.

Note that, since reception signals Y_{z}(f_{b_cfar}, f_{s_comp_cfar}, ndop_code(ndm), ndm) to be subjected to the coded Doppler demultiplexing processing are reception signals from transmission antennas using coded Doppler phase rotation amount ψ_{ndop_code(ndm), ndm}(m), and thus the reception signals can be associated with transmission antennas Tx #1, Tx #2, . . . , and Tx #Nt.

Accordingly, in the following, notation YT_{z}(f_{b_cfar}, f_{s_comp_cfar}, nt) associated with any one of transmission antennas Tx #1 to Tx #Nt is used for coded Doppler phase rotation amount ψ_{ndop_code(ndm), ndm}(m) in reception signal Y_{z}(f_{b_cfar}, f_{s_comp_cfar}, ndop_code(ndm), ndm). Here, nt=1 to Nt.

Similarly, notation YBT_{z}(f_{b_cfar}, f_{s_comp_cfar}, nt) associated with any one of transmission antennas Tx #1 to Tx #Nt is used for coded Doppler phase rotation amount ψ_{ndop_code(ndm), ndm}(m) in reception signal YBq_{z}(f_{b_cfar}, f_{s_comp_cfar}, ndop_code(ndm), ndm). Here, nt=1 to Nt, and q=1 to NB. When the multi-beam number is two (NB=2), q is 1 or 2.

Hereinafter, exemplary operation 1 and exemplary operation 2 of direction estimator 213 will be described.

### <Exemplary Operation 1 of Direction Estimator 213>

In exemplary operation 1, for example, direction estimator 213 generates virtual reception array correlation vector h(f_{b_cfar}, f_{s_comp_cfar}) of direction estimator 213 as shown in the following Expression 14, based on distance index f_{b_cfar} and reception signal Y_{z}(f_{b_cfar}, f_{s_comp_cfar}, ndop_code(ndm), ndm) subjected to the coded Doppler demultiplexing processing, and performs the direction estimation processing.

Here, when information inputted from coded Doppler demultiplexer 212 includes reception signal Y_{z}(f_{b_cfar}, f_{s_comp_cfar}, ndop_code(ndm), ndm) subjected to coded Doppler demultiplexing processing, the information includes coded Doppler demultiplexing reception signals for Nt transmission antennas. Thus, virtual reception array correlation vector h(f_{b_cfar}, f_{s_comp_cfar}) of direction estimator 213 includes Nt×Na elements, which is the product of number Nt of transmission antennas and number Na of reception antennas, as shown in Expression 14. Direction estimator 213 uses virtual reception array correlation vector h(f_{b_cfar}, f_{s_comp_cfar}) to perform direction estimation based on the phase difference between transmission and reception antennas for the reflected wave signal from the target object.

$$\begin{matrix}[ 16 ] & \\ h ( {f}_{b \_ cfar} , {f}_{s \_ comp \_ cfar} ) = [ \begin{matrix}{h}_{cal [ 1 ]} {YT}_{1} ( {f}_{b \_ cfar} , {f}_{s \_ comp \_ cfar} , 1 ) \\ {h}_{cal [ 2 ]} {YT}_{2} ( {f}_{b \_ cfar} , {f}_{s \_ comp \_ cfar} , 1 ) \\ ⋮ \\ {h}_{cal [ {N}_{a} ]} {YT}_{{N}_{a}} ( {f}_{b \_ cfar} , {f}_{s \_ comp \_ cfar} , 1 ) \\ {h}_{cal [ {N}_{a} + 1 ]} {YT}_{1} ( {f}_{b \_ cfar} , {f}_{s \_ comp \_ cfar} , 2 ) \\ {h}_{cal [ {N}_{a} + 2 ]} {YT}_{2} ( {f}_{b \_ cfar} , {f}_{s \_ comp \_ cfar} , 2 ) \\ ⋮ \\ {h}_{cal [ 2 {N}_{a} ]} {YT}_{{N}_{a}} ( {f}_{b \_ cfar} , {f}_{s \_ comp \_ cfar} , 2 ) \\ ⋮ \\ {h}_{cal [ {N}_{a} ( {N}_{t} - 1 ) + 1 ]} {YT}_{1} ( {f}_{b \_ cfar} , {f}_{s \_ comp \_ cfar} , {N}_{t} ) \\ {h}_{cal [ {N}_{a} ( {N}_{t} - 1 ) + 2 ]} {YT}_{2} ( {f}_{b \_ cfar} , {f}_{s \_ comp \_ cfar} , {N}_{t} ) \\ ⋮ \\ {h}_{cal [ {N}_{a} {N}_{t} ]} {YT}_{{N}_{a}} ( {f}_{b \_ cfar} , {f}_{s \_ comp \_ cfar} , {N}_{t} )\end{matrix} ] & ( Expression 14 )\end{matrix}$$

In Expression 14, h_{cal[b]} is an array correction value that corrects the phase deviation and the amplitude deviation between transmission antennas and between reception antennas. Here, b is an integer of 1 to (Nt×Na).

Direction estimator 213, for example, uses virtual reception array correlation vector h(f_{b_cfar}, f_{s_comp_cfar}) to calculate a spatial profile by varying azimuth direction θᵤ within a predetermined angle range in direction estimation evaluation function P_{H}(θᵤ, f_{b_cfar}, f_{s_comp_cfar}).

Direction estimator 213 may extract a predetermined number of maximum peaks of the calculated spatial profile in descending order, and may output the azimuth direction of the maximum peak as an direction-of-arrival estimation value (for example, a positioning output).

Note that there are various methods for direction estimation evaluation function value P_{H}(θᵤ, f_{b_cfar}, f_{s_comp_cfar}) depending on the direction-of-arrival estimation algorithm. For example, an estimation method using an array antenna disclosed in NPL 3 may be used.

Further, in the example described above, an example in which direction estimator 213 calculates the azimuth direction as the direction-of-arrival estimation value has been described, but the present disclosure is not limited thereto. The arrival direction estimation in the elevation direction is possible, or the arrival direction estimation in the azimuth and elevation directions is also possible by using a MIMO antennas arranged in the elevation direction in a rectangular lattice shape. For example, direction estimator 213 may calculate the azimuth direction and the elevation angle direction as the direction-of-arrival estimation value for each of the transmission antennas with different beam directions, and output them as positioning outputs. Note that, the same application is possible in exemplary operation 2 of direction estimator 213 described later.

Through the above operations, the direction estimator of radar apparatus 10 may, for example, output, as the positioning outputs, the direction-of-arrival estimation value based on distance index f_{b_cfar} and reception signal Y_{z}(f_{b_cfar}, f_{s_comp_cfar}, ndop_code(ndm), ndm) subjected to the coded Doppler demultiplexing processing. Further, direction estimator 213 may output, as the positioning outputs, distance index f_{b_cfar} and the Doppler frequency estimation value of the target object.

Further, distance index f_{b_cfar} may be converted into distance information using Expression 10 and outputted. Note that, the same application is possible in exemplary operation 2 of direction estimator 213 described later.

Further, when there are a plurality of information inputs (for example, distance index f_{b_cfar} and reception signal Y_{z}(f_{b_cfar}, f_{s_comp_cfar}, ndop_code(ndm), ndm) subjected to coded Doppler demultiplexing processing) inputted from coded Doppler demultiplexer 212, direction estimator 213 may calculate the direction-of-arrival estimation values for the inputs in the same manner as the processing described above and may output the positioning results.

### <Exemplary Operation 2 of Direction Estimator 213>

In exemplary operation 2, for example, direction estimator 213 generates virtual reception array correlation vector hq(f_{b_cfar}, f_{s_comp_cfar}, ndop_code(ndm), ndm) of direction estimator 213 shown in the following Expression 15 based on distance index f_{b_cfar} and reception signal YBq_{z}(f_{b_cfar}, f_{s_comp_cfar}, ndop_code(ndm), ndm) subjected to the coded Doppler demultiplexing processing, and performs the direction estimation processing based on the reception signals from the transmission antennas with beam direction Bq.

Here, q=1 to NB. For example, when multi-beam number NB is 2, q is 1 or 2. Hereinafter, the operation in the case of NB=2 will be described as an example, but the value of NB is not limited thereto.

Direction estimator 213 performs direction estimation processing of beam direction Bq corresponding to q that matches reception signal YBq_{z}(f_{b_cfar}, f_{s_comp_cfar}, ndop_code(ndm), ndm) subjected to the coded Doppler demultiplexing processing.

Here, when information inputted from coded Doppler demultiplexer 212 includes reception signal YBq_{z}(f_{b_cfar}, f_{s_comp_cfar}, ndop_code(ndm), ndm) subjected to coded Doppler demultiplexing processing, the information includes coded Doppler demultiplexing reception signals for Nt transmission antennas, but the information inputted includes a signal with a zero value, because the reception signal is not obtained except for the coded Doppler demultiplexing reception signals for N_{Bq} transmission antennas. Thus, virtual reception array correlation vector hq(f_{b_cfar}, f_{s_comp_cfar}) of direction estimator 213 includes Nt×Na elements, which is the product of number Nt of transmission antennas and number Na of reception antennas, as shown in Expression 15. Direction estimator 213 uses virtual reception array correlation vector hq(f_{b_cfar}, f_{s_comp_cfar}) to perform direction estimation based on the phase difference between transmission and reception antennas for the reflected wave signal from the target object.

$$\begin{matrix}[ 17 ] & \\ {h}_{q} ( {f}_{b \_ cfar} , {f}_{s \_ comp \_ cfar} ) = [ \begin{matrix}{h}_{cal [ 1 ]} {YBTq}_{1} ( {f}_{b \_ cfar} , {f}_{s \_ comp \_ cfar} , 1 ) \\ {h}_{cal [ 2 ]} {YBTq}_{2} ( {f}_{b \_ cfar} , {f}_{s \_ comp \_ cfar} , 1 ) \\ ⋮ \\ {h}_{cal [ {N}_{a} ]} {YBTq}_{Na} ( {f}_{b \_ cfar} , {f}_{s \_ comp \_ cfar} , 1 ) \\ {h}_{cal [ {N}_{a} + 1 ]} {YBTq}_{1} ( {f}_{b \_ cfar} , {f}_{s \_ comp \_ cfar} , 2 ) \\ {h}_{cal [ {N}_{a} + 2 ]} {YBTq}_{2} ( {f}_{b \_ cfar} , {f}_{s \_ comp \_ cfar} , 2 ) \\ ⋮ \\ {h}_{cal [ 2 {N}_{a} ]} {YBTq}_{{N}_{a}} ( {f}_{b \_ cfar} , {f}_{s \_ comp \_ cfar} , 2 ) \\ ⋮ \\ {h}_{cal [ {N}_{a} ( {N}_{t} - 1 ) + 1 ] ]} {YBTq}_{1} ( {f}_{b \_ cfar} , {f}_{s \_ comp \_ cfar} , {N}_{t} ) \\ {h}_{cal [ {N}_{a} ( {N}_{t} - 1 ) + 2 ]} {YBTq}_{2} ( {f}_{b \_ cfar} , {f}_{s \_ comp \_ cfar} , {N}_{t} ) \\ ⋮ \\ {h}_{cal [ {N}_{a} {N}_{t} ]} {YBTq}_{{N}_{a}} ( {f}_{b \_ cfar} , {f}_{s \_ comp \_ cfar} , {N}_{t} )\end{matrix} ] & ( Expression 15 )\end{matrix}$$

For example, when the transmission antennas with beam direction B1 are Tx #1 and Tx #3, the transmission antennas with beam direction B2 are Tx #2 and Tx #4, N_{B1}=2, N_{B2}=2, Nₜ=4, and the number of reception antennas Na is 4, B1 beam antenna extraction vector SP_{B1} for extracting reception signals corresponding to the transmission antennas with beam direction B1, and B2 beam antenna extraction vector SP_{B2} for extracting reception signals corresponding to the transmission antennas with beam direction B2 may be represented by 16 (=Nₜ×Na)-th order column vectors as in the following Expressions 16 and 17. Here, superscript T denotes vector transposition.

$$\begin{matrix}[ 18 ] & \\ {SP}_{B 1} = {[ 1 , 1 , 1 , 1 , 0 , 0 , 0 , 0 , 1 , 1 , 1 , 1 , 0 , 0 , 0 , 0 ]}^{T} & ( Expression 16 )\end{matrix}$$

$$\begin{matrix}[ 19 ] & \\ {SP}_{B 2} = {[ 0 , 0 , 0 , 0 , 1 , 1 , 1 , 1 , 0 , 0 , 0 , 0 , 1 , 1 , 1 , 1 ]}^{T} & ( Expression 17 )\end{matrix}$$

Direction estimator 213, for example, uses the element index whose element is 1 in B1 beam antenna extraction vector SP_{B1} to extract the element component of the element index from virtual reception array correlation vector h₁(f_{b_cfar}, f_{s_comp_cfar}), and generates a column vector in which the element components are arranged in ascending order of the element index as virtual reception array correlation vector h_{B1}(f_{b_cfar}, f_{s_comp_cfar}) by the B1 beam antenna. For example, B1 beam antenna extraction vector SP_{B1} shown in Expression 16 has elements that are 1 at the first to fourth and ninth to twelfth element indexes. In this case, direction estimator 213 extracts element components from virtual reception array correlation vector h₁(f_{b_cfar}, f_{s_comp_cfar}) in the order of the first to fourth and ninth to twelfth element indexes, and generates B1 beam antenna virtual reception array correlation vector h_{B1}(f_{b_cfar}, f_{s_comp_cfar}).

Similarly, direction estimator 213, for example, uses the element index whose element is 1 in B2 beam antenna extraction vector SP_{B2} to extract the element component of the element index from virtual reception array correlation vector h₂(f_{b_cfar}, f_{s_comp_cfar}), and generates a column vector in which the element components of the element index are arranged in ascending order of the element index as virtual reception array correlation vector h_{B2} (f_{b_cfar}, f_{s_comp_cfar}) by the B2 beam antenna. For example, B2 beam antenna extraction vector SP_{B2} shown in Expression 17 has elements that are 1 at the fifth to eighth and thirteenth to sixteenth element indexes. In this case, direction estimator 213 extracts element components from virtual reception array correlation vector h₂(f_{b_cfar}, f_{s_comp_cfar}) in the order of the fifth to eighth and thirteenth to sixteenth element indexes, and generates B2 beam antenna virtual reception array correlation vector h_{B2}(f_{b_cfar}, f_{s_comp_cfar}).

Direction estimator 213 calculates the spatial profile for each Bq beam by varying azimuth direction θᵤ within a predetermined angle range in direction estimation evaluation function P_{H-Bq}(θᵤ, f_{b_cfar}, f_{s_comp_cfar}) using, for example, Bq beam antenna virtual reception array correlation vector h_{Bq}(f_{b_cfar}, f_{s_comp_cfar}). Here, q=1 or 2.

Direction estimator 213 may extract a predetermined number of maximum peaks of the spatial profile based on the calculated reception signal corresponding to the transmission antenna in beam direction Bq in descending order, and may output the azimuth direction of the maximum peak as an direction-of-arrival estimation value (for example, a positioning output) by the Bq beam.

Note that, there are various methods for direction estimation evaluation function value P_{H-Bq}(θᵤ, f_{b_cfar}, f_{s_comp_cfar}) depending on the direction-of-arrival estimation algorithm. For example, an estimation method using an array antenna disclosed in NPL 3 may be used.

By the above operation, direction estimator 213 of radar apparatus 10 may output, for example, the direction-of-arrival estimation value by the Bq beam based on distance index f_{b_cfar} and reception signal YB_{z}(f_{b_cfar}, f_{s_comp_cfar}, ndop_code(ndm), ndm) subjected to the coded Doppler demultiplexing processing, which is a reception signal from the transmission antenna with beam direction Bq, as the positioning output. Further, direction estimator 213 may output, as the positioning output, distance index f_{b_cfar} and the Doppler frequency estimation value of the target object.

Further, when there are a plurality of information inputs (for example, distance index f_{b_cfar} and reception signal YBq_{z}(f_{b_cfar}, f_{s_comp_cfar}, ndop_code(ndm), ndm) subjected to the coded Doppler demultiplexing processing) inputted from coded Doppler demultiplexer 212, direction estimator 213 may calculate the direction-of-arrival estimation values for the inputs in the same manner as the processing described above and may output the positioning results.

The above describes exemplary operation 1 and exemplary operation 2 of direction estimator 213.

Next, an arrangement example of a MIMO antennas and an exemplary operation of direction estimator 213 when the arrangement of the MIMO antennas is used will be described. In the following, a transmission antenna and a reception antenna in a MIMO radar are collectively referred to as a MIMO antenna.

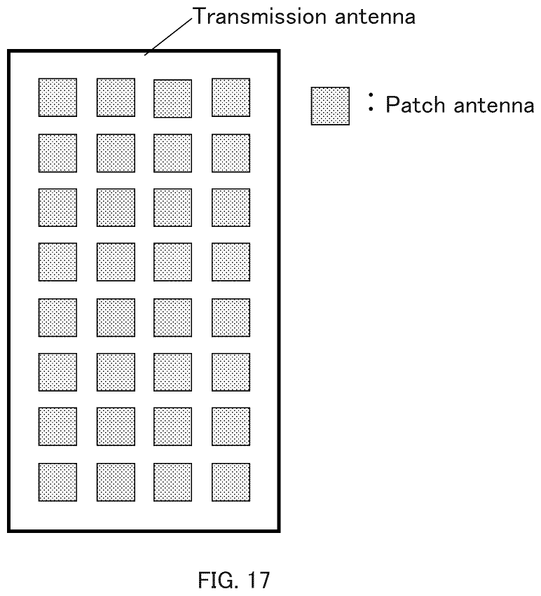

Note that, in the following description, each transmission antenna included in transmission antenna section 109 may be, for example, of a sub-array configuration in which a plurality of planar patch antennas is arranged in the longitudinal and lateral directions, as illustrated in FIG. 17. In the example of FIG. 17, the transmission antenna consists of eight planar patch antennas longitudinally and four planar patch antennas laterally. For example, by changing the feeding potential phase for each patch antenna included in one transmission antenna, it is possible to form a beam pattern directed in a desired direction (element pattern of the transmission antenna). Further, for example, as the number of planar patch antennas in the horizontal (or vertical) direction forming one transmission antenna increases, directional beams in the horizontal (or vertical) direction can be formed sharply. One transmission antenna may consist of, for example, the number of planar patches to meet the desired beamwidth.

Note that the configuration of one transmission antenna is not limited to the example illustrated in FIG. 17, and the number of patch antennas constituting one transmission antenna (for example, at least one of the total number, the number in the lateral direction, or the number in the longitudinal direction) is not limited to the number illustrated in FIG. 17. Further, the one transmission antenna is not limited to planar patch antennas, it may be a configuration in which patch antennas are arranged in either the longitudinal or lateral direction. Further, for example, the configurations of patch antennas of the plurality of transmission antennas may be different.

Hereinafter, an arrangement example of MIMO antennas in a case where two transmission antennas correspond to each transmission beam will be described. Each transmission beam may be formed by, for example, two transmission antennas.

In the following, as an example, the antenna arrangement of a MIMO radar with transmission antennas (number thereof being Nt=4) (e.g., Tx #1, Tx #2, Tx #3, and Tx #4) and reception antenna number Na being 3 (e.g., Rx #1, Rx #2, and Rx #3) will be described.

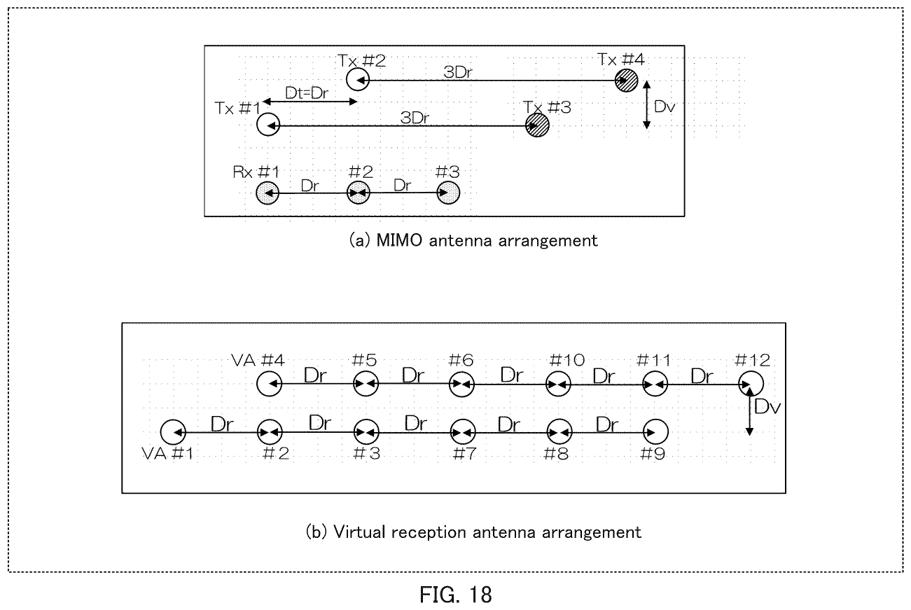

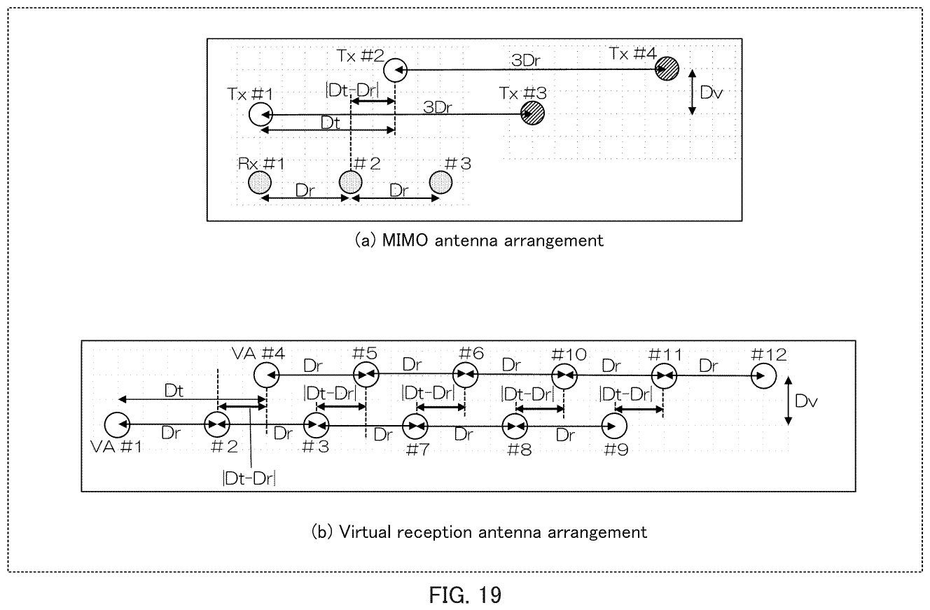

For example, as illustrated in FIG. 18 or FIG. 19, transmission antennas Tx #1, Tx #2, Tx #3, and Tx #4 have directional patterns in which the transmission beam directions (or the directional beam directions) are different. In FIGS. 18 and 19, Tx #1 and Tx #2 have a directional pattern of beam direction B1 (beam B1), and Tx #3 and Tx #4 have a directional pattern of beam direction B2 (beam B2). As illustrated in FIGS. 18 and 19, the number of transmission antennas having each one of directional patterns with beam direction B1 and beam direction B2 is two, N_{B1}=2 and N_{B2}=2.

Further, in the following, the directivity of the reception antenna (for example, Rx #1, Rx #2, Rx #3) may be omnidirectional or may have substantially uniform directional characteristics within the viewing angle of the transmission antennas with a plurality of beam directions (for example, Tx #1, Tx #2, Tx #3, Tx #4).

For example, when number Nt of transmission antennas used for the multiple transmission is 4, radar apparatus 10 transmits radar transmission signals with a coded Doppler multiplexed signals (Doppler multiplexing number N_{DM}=3, code multiplexing number N_{CM}=2) with exemplary configuration 1 as the setting of the coded Doppler phase rotation amount in phase rotation amount setter 105. In this case, for example, in the configuration for Doppler shift amounts described above, it is possible to apply the assignment of Doppler multiplexed signals of N_{B1}=2 and N_{B2}=2.

Further, for example, arrangements VA #1 to VA #12 of virtual reception antennas (or MIMO virtual antennas) are configured from the arrangements of transmission antennas Tx #1, Tx #2, Tx #3, and Tx #4 and reception antennas Rx #1, Rx #2, and Rx #3.

Here, the arrangement of the virtual reception antennas (virtual reception array) may be represented as follows in Expression 18, for example, based on the positions (for example, the position of the feeding point) of the transmission antennas that constitutes transmission antenna section 109 and the position (for example, the positions of the feeding point) of the reception antennas that constitutes reception antenna section 202.

$$\begin{matrix}[ 20 ] & \\ & ( Expression 18 )\end{matrix}$$

$$\{ \begin{matrix}{X}_{V \_ \# b} = ( {X}_{T \_ \# [ ceil ( b / Na ) ]} - {X}_{T \_ \#1} ) + ( {X}_{R \_ \# [ mod ( b - 1 , Na ) + 1 ]} - {X}_{R \_ \#1} ) \\ {Y}_{V \_ \# b} = ( {Y}_{T \_ \# [ ceil ( b / Na ) ]} - {Y}_{T \_ \#1} ) + ( {Y}_{R \_ \# [ mod ( b - 1 , Na ) + 1 ]} - {Y}_{R \_ \#1} )\end{matrix}$$

Here, the position coordinates of the transmission antenna (for example, Tx #n) that constitutes transmission antenna section 109 are represented as (X_{T_#n}, Y_{T_#n}) (for example, n=1 to Nt), the position coordinates of the reception antenna (for example, Rx #z) that constitutes reception antenna section 202 are represented as (X_{R_#z}, Y_{R_#z}) (for example, z=1 to Na), and the position coordinates of virtual antenna VA #b that constitutes the virtual reception array antenna are represented as (X_{V_#b}, Y_{V_#b}) (for example, b=1 to Nt×Na).

Note that, in Expression 18, VA #1 is represented as the position reference (0,0) of the virtual reception array, for example.

Hereinafter, an arrangement example of MIMO antennas will be described. The following is described as X_{T_#n} representing the horizontal position coordinates, and Y_{T_#n} representing the vertical position coordinates, but the configuration is not limited thereto.

FIGS. 18 and 19 illustrate examples of transmission antenna and reception antenna arrangements (MIMO antenna arrangements) used in a MIMO radar. Hereinafter, the example of the MIMO antenna arrangement illustrated in FIG. 18 will be referred to as “arrangement example A,” and the example of the MIMO antenna arrangement illustrated in FIG. 19 will be referred to as “arrangement example B.” Parts (a) in FIG. 18 and FIG. 19 illustrate an arrangement example of MIMO antennas (Tx #1, Tx #2, Tx #3, Tx #4, Rx #1, Rx #2, Rx #3), and parts (b) in FIG. 18 and FIG. 19 illustrate an arrangement example of virtual reception antennas (VA #1 to VA #12) configured by the MIMO antenna arrangement in parts (a) in FIG. 18 and FIG. 19.

As illustrated in parts (a) in FIG. 18 and FIG. 19, in arrangement example A and arrangement example B, reception antennas Rx #1, Rx #2, and Rx #3 are disposed at intervals of Dr in the horizontal direction (the lateral direction in FIGS. 18 and 19). Further, in arrangement example A and arrangement example B, transmission antennas Tx #1 and Tx #2 corresponding to beam direction B1 are disposed at an interval Dr (Dt=Dr) in the horizontal direction and are disposed at different positions (for example, interval Dv) in the vertical direction (the longitudinal direction in FIGS. 18 and 19). Further, in arrangement example A and arrangement example B, transmission antennas Tx #3 and Tx #4 corresponding to beam direction B2 are disposed at interval Dt in the horizontal direction and are disposed at different positions (for example, interval Dv) in the vertical direction. Further, as illustrated in parts (a) in FIG. 18 and FIG. 19, transmission antennas Tx #1 and Tx #3 (or Tx #2 and Tx #4) are disposed at the same position in the vertical direction, and are disposed apart from each other in the horizontal direction at an interval larger than the aperture (2Dr) of reception antennas Rx #1, Rx #2, and Rx #3 (for example, an interval of 3Dr).

For example, as shown in parts (a) in FIG. 18 and FIG. 19, in the case of the arrangement of transmission antennas Tx #1, Tx #2, Tx #3, and Tx #4, namely (X_{T_#1}, Y_{T_#1})=(0, 0), (X_{T_#2}, Y_{T_#2})=(Dᵣ, D_{V}), (X_{T_#3}, Y_{T_#3})=(3Dᵣ, 0), (X_{T_#4}, Y_{T_#4})=(Dₜ+3Dᵣ, D_{V}), and the arrangement of reception antennas Rx #1, Rx #2, and Rx #3, namely (X_{R_#1}, Y_{R_#1})=(ax, ay), (X_{R_#2}, Y_{R_#2})=(ax+Dᵣ, ay), (X_{R_#3}, Y_{R_#3})=(ax+2Dᵣ, ay), the position coordinates of virtual antennas VA #1 to VA #12 that constitute the virtual reception antennas are calculated from Expression 18. Here, ax and ay are arbitrary constants.

For example, the position coordinates of virtual antennas VA #1 to VA #12 become (X_{V_#1}, Y_{V_#1})=(0, 0), (X_{V_#2}, Y_{V_#2})=(Dᵣ, 0), (X_{V_#3}, Y_{V_#3})=(2Dᵣ, 0), (X_{V_#4}, Y_{V_#4})=(Dₜ, D_{V}), (X_{V_#5}, Y_{V_#5})=(Dₜ+Dᵣ, D_{V}), (X_{V_#6}, Y_{V_#6})=(Dₜ+2Dᵣ, D_{V}), (X_{V_#7}, Y_{V_#7})=(3Dᵣ, 0), (X_{V_#8}, Y_{V_#8})=(4Dᵣ, 0), (X_{V_#9}, Y_{V_#9})=(5Dᵣ, 0), (X_{V_#10}, Y_{V_#10})=(Dₜ+3Dᵣ, D_{V}), (X_{V_#11}, Y_{V_#11})=(Dₜ+4Dᵣ, D_{V}), and (X_{V_#12}, Y_{V_#12})=(Dₜ+5Dᵣ, D_{V}) regardless of ax and ay, as illustrated in parts (b) in FIG. 18 and FIG. 19.

Here, arrangement example A (FIG. 18) illustrates an arrangement example using Dt=Dr. Further, arrangement example B (FIG. 19) illustrates an arrangement example using Dr and Dt providing the absolute value of the difference between Dt and Dr of approximately 0.5 wavelengths (|Dt−Dr|≈0.5). For example, FIG. 19 illustrates an arrangement example in which Dt=1.5Dr, and an example in which Dt−Dr=Dr/2. This is, for example, an arrangement in which Dt=1.5 wavelengths and Dr=1 wavelength are assumed, resulting in Dt−Dr=Dr/2=0.5 wavelengths.

For example, in exemplary operation 1 of direction estimator 213 described above, when the information inputted from coded Doppler demultiplexer 212 includes reception signal Y_{z}(f_{b_cfar}, f_{s_comp_cfar}, ndop_code(ndm), ndm) subjected to the coded Doppler demultiplexing processing, direction estimator 213 generates virtual reception array correlation vector h(f_{b_cfar}, f_{s_comp_cfar}) shown in Expression 14 and performs the direction estimation processing.

Here, the reception signal by bth virtual antenna VA #b is represented by the bth element of virtual reception array correlation vector h(f_{b_cfar}, f_{s_comp_cfar}). Here, b is an integer of 1 to (Nt×Na).

Further, reception signals Y_{z}(f_{b_cfar}, f_{s_comp_cfar}, ndop_code(ndm), ndm) subjected to coded Doppler demultiplexing processing and inputted from coded Doppler demultiplexer 212 include coded Doppler separation signals for Nt transmission antennas. This is a case where the target object direction is, for example, target object direction (2) illustrated in FIG. 10, and corresponds to a case where the beam directions of transmission antennas Tx #1, Tx #2, Tx #3, and Tx #4 correspond to the overlapping area. In this case, the radar transmission signals from transmission antennas Tx #1, Tx #2, Tx #3, and Tx #4 are reflected by the target object and received by reception antennas Rx #1, Rx #2, and Rx #3. Accordingly, in this case, direction estimator 213 can perform direction estimation using the reception signals of virtual antennas VA #1 to VA #12 corresponding to Tx #1, Tx #2, Tx #3, and Tx #4.

In the MIMO antenna arrangement in parts (a) in FIG. 18 and FIGS. 19, Tx #1 and Tx #2 have directional characteristics of beam direction B1, and Tx #3 and Tx #4 have directional characteristics of beam direction B2, corresponding to different beam directions from each other. Further, as illustrated in FIG. 10, beam direction B1 and beam direction B2 overlap with each other in an angle region within about a beam width. Here, as illustrated in parts (a) in FIG. 18 and FIG. 19, in each of the arrangement of Tx #1 and Tx #2 and the arrangement of Tx #3 and Tx #4, the arrangement is offset in the vertical direction (for example, offset value Dv), and allow direction estimator 213 to perform angle measurement in the vertical direction in addition to the horizontal direction. Further, each of the arrangement of Tx #1 and Tx #2, and the arrangement of Tx #3 and Tx #4 is an arrangement in which, when there is a target object in an overlapping region between beam direction B1 and beam direction B2 (for example, target object direction (2) illustrated in FIG. 10), the aperture length of the virtual reception antenna can be extended in the horizontal direction, and the estimation accuracy and the angle resolution in the horizontal direction can be improved in the angle measurement processing of direction estimator 213.

Further, in arrangement example A, as illustrated in the arrangement of Tx #1 and Tx #2 (or the arrangement of Tx #3 and Tx #4) at part (a) in FIG. 18, the offset Dt in the horizontal direction is Dt=Dr. As described above, Tx #1 and Tx #2 (or Tx #3 and Tx #4) are disposed to be offset from each other in the horizontal direction with an element interval equal to element interval Dr between reception antennas Rx #1, Rx #2, and Rx #3. Therefore, as illustrated at part (b) in FIG. 18, the virtual reception antenna arrangement includes an arrangement such that the horizontal positions of a plurality of virtual antennas (for example, VA #2 and VA #4, or VA #3 and VA #5) is the same, but the vertical positions thereof are different by Dv. By arranging the virtual reception antennas in this manner, direction estimator 213 can easily perform angle measurement in the vertical direction based on the reception phase difference between two virtual antennas (for example, VA #2 and VA #4, or VA #3 and VA #5) that have the same horizontal position.

Further, arrangement example B is an arrangement using Dr and Dt providing the absolute value of the difference between Dt and Dr of approximately 0.5 wavelengths (|Dt−Dr|≈0.5), as shown in the arrangement of Tx #1 and Tx #2 (or the arrangement of Tx #3 and Tx #4) at part (a) in FIG. 19. In this arrangement, for example, as illustrated at part (b) in FIG. 19, the distance between virtual antennas VA #2 and VA #4 (or the distance between VA #3 and VA #5, the distance between VA #7 and VA #6, the distance between VA #8 and VA #10, and the distance between VA #9 and VA #11) is Dt−Dr in the case of Dt>Dr, and is Dr−Dt in the case of Dr>Dt. For example, when the absolute value of the difference between transmission antenna interval Dt and the reception antenna interval Dr, |Dt-Dr|, is set to a half wavelength, radar apparatus 10 can suppress the grating lobe within a viewing angle in the range of ±90°. For example, in the case of Dt=1.52 and Dr=1λ, |Dt−Dr| is 0.5λ.

Although a case where the difference between Dt and Dr, namely |Dt−Dr| (specified value), is set to half-wavelength (0.5λ) has been described, the configuration is not limited thereto. For example, |Dt−Dr| may be set to any value in the range of about 0.45% to 0.8λ (e.g., any value in the range of 0.5 to 0.8 times the wavelength of the radar transmission signal).

For example, |Dt−Dr| may be set according to the viewing angle of radar apparatus 10 in the horizontal direction, which can suppress grating lobes within the viewing angle. For example, when the viewing angle in the horizontal direction is a wide viewing angle ranging from ±70 degrees to ±90 degrees, |Dt−Dr| may be set to about 0.5λ. Alternatively, when the viewing angle in the horizontal direction is a narrow viewing angle ranging from ±20 degrees to ±40 degrees, |Dt−Dr| may be set as a wider interval, for example, about 0.7λ.

Further, in exemplary operation 2 of direction estimator 213 described above, direction estimator 213 generates virtual reception array correlation vector h_{B1}(f_{b_cfar}, f_{s_comp_cfar}) or h_{B2}(f_{b_cfar}, f_{s_comp_cfar}) based on reception signal YB1_{z}(f_{b_cfar}, f_{s_comp_cfar}, ndop_code(ndm), ndm) or YB2_{z}(f_{b_cfar}, f_{s_comp_cfar}, ndop_code(ndm), ndm) subjected to coded Doppler demultiplexing processing and inputted from coded Doppler demultiplexer 212, and performs the direction estimation processing.

Here, the reception signal by bth virtual antenna VA #b is represented by the bth element of virtual reception array correlation vector hq(f_{b_cfar}, f_{s_comp_cfar}). Here, q is 1 or 2.

Further, reception signals YBq_{z}(f_{b_cfar}, f_{s_comp_cfar}, ndop_code(ndm), ndm) subjected to the coded Doppler demultiplexing processing and inputted from coded Doppler demultiplexer 212 include reception signals for N_{Bq} transmission antennas with beam direction Bq. This is a case where the target object direction is, for example, target object direction (1) (for example, in the case of beam direction B1) or target object direction (3) (for example, in the case of beam direction B2) illustrated in FIG. 10, and corresponds to a region with beam direction Bq. In this case, the radar transmission signals from the transmission antennas with beam direction Bq are reflected by the target object and are received by reception antennas Rx #1, Rx #2, and Rx #3.

Thus, in this case, for example, direction estimator 213 can perform direction estimation using the reception signals of virtual antennas VA #1 to VA #6 corresponding to transmission antennas Tx #1 and Tx #2 included in beam direction B1, in the case of q=1 (when the target object direction is target object direction (1) illustrated in FIG. 10). Further, for example, direction estimator 213 can perform direction estimation using the reception signals of virtual antennas VA #7 to VA #12 corresponding to transmission antennas Tx #3 and Tx #4 included in beam direction B2, in the case of q=2 (when the target object direction is target object direction (3) illustrated in FIG. 10).

Note that, in arrangement example A, Dt and Dr may be set to, for example, one wavelength or more at part (a) in FIG. 18. In this case, as a result of the direction estimation processing in direction estimator 213, a grating lobe may be generated, and ambiguity may occur in the direction estimation in the horizontal direction. On the other hand, direction estimator 213 performs direction estimation processing based on reception signal Y_{z}(f_{b_cfar}, f_{s_comp_cfar}, ndop_code(ndm), ndm), YB1_{z}(f_{b_cfar}, f_{s_comp_cfar}, ndop_code(ndm), ndm), or YB2_{z}(f_{b_cfar}, f_{s_comp_cfar}, ndop_code(ndm), ndm) subjected to the coded Doppler demultiplexing processing inputted from coded Doppler demultiplexer 212. Thus, direction estimator 213 can identify that a target object is in any one of beam direction B1, beam direction B2, and the direction of the overlapping region between beam directions B1 and B2, and thus can detect the true direction even when a grating lobe is generated.

Further, Dv in arrangement examples A and B may be set to, for example, a value of approximately 0.452 to 0.82 (for example, any value in a range of 0.5 times to 0.8 times the wavelength of the radar transmission signal). Dv may be set, for example, according to the viewing angle of radar apparatus 10 in the vertical direction. For example, when the viewing angle in the vertical direction is a wide viewing angle ranging from ±70 degrees to ±90 degrees, Dv may be set to about 0.5λ. Alternatively, when the viewing angle in the vertical direction is a narrow viewing angle ranging from ±20 degrees to ±40 degrees, Dv may be set as a wider interval, for example, about 0.7 2.

Here, A represents the wavelength of the carrier frequency of a radar transmission signal. For example, when a chirp signal is used as the radar transmission signal, λ is the wavelength of the center frequency in the frequency sweep band of the chirp signal.

Note that, in arrangement example A and arrangement example B, the arrangement of the reception antennas (Rx #1, Rx #2, and Rx #3) has been described as having the same position in the vertical direction and being offset by equal intervals Dr in the horizontal direction, but the arrangement of the reception antennas is not limited thereto. For example, in the horizontal arrangement of the reception antennas, the intervals between the reception antennas may be uneven.

The MIMO antenna arrangements described in arrangement example A and arrangement example B are examples, and the arrangement is not limited to the examples. For example, with respect to the MIMO antenna arrangements described in arrangement example A and arrangement example B, other antennas (at least one of the transmission antenna or the reception antenna) may be configured to be further arranged. In addition, the antenna arrangement may be such that the horizontal direction and the vertical direction are switched in arrangement example A and arrangement example B. Further, the interval between the transmission antennas described in arrangement example A and arrangement example B may be applied to the interval between the reception antennas, and the interval between the reception antennas described in arrangement example A and arrangement example B may be applied to the interval between the transmission antennas.

By the above-described operation, direction estimator 213 can perform the direction estimation processing in response to the fact that the separation operation of coded Doppler demultiplexer 212 varies according to the target object direction in the multi-beam transmission.

For example, when coded Doppler demultiplexer 212 can separate Doppler multiplexed signals that are all from transmission antennas (for example, in the case of target object direction (2)), direction estimator 213 can improve the angle measurement accuracy and the angle measurement resolution by performing direction estimation by using the reception signals of Nt×Na virtual reception antennas.

Further, for example, when coded Doppler demultiplexer 212 can separate Doppler multiplexed signal that is from the transmission antenna with beam direction Bq (for example, in the case of target object direction (1) or (3)), direction estimator 213 can improve the angle measurement accuracy and the angle measurement resolution by performing direction estimation by using the reception signals of N_{Bq}×Na virtual reception antennas.

The exemplary operations of direction estimator 213 have been described above.

As described above, in the present embodiment, radar apparatus 10 assigns coded Doppler multiplexed signals that are different between multi-beams that satisfy at least Condition 1 in phase rotation amount setter 105 in a multi-beam transmission MIMO radar using coded Doppler multiplexing (for example, signals in which at least Doppler multiplexing patterns or code multiplexing patterns are different). Thus, even when the reception levels between reflected waves corresponding to transmission antennas having different directional characteristics are significantly different, radar apparatus 10 can discriminate the transmission antennas in coded Doppler demultiplexer 212, enabling coded Doppler multiplexing. Therefore, according to the present embodiment, it is possible to suppress the deterioration of the target object detection performance or the deterioration of the erroneous estimation of the Doppler frequency or the measurement angle performance.

Further, for example, in the assignment of coded Doppler multiplexed signals in phase rotation amount setter 105, when Conditions 1 and 2 described above are satisfied, radar apparatus 10 can expand the detectable Doppler frequency range fd to −1/(2Tr)≤fd<1/(2Tr), even in cases where the reception levels of reflected waves corresponding to transmission antennas with different directional characteristics vary significantly, similar to the case of using one transmission antenna.

Further, in radar apparatus 10 according to the present embodiment, Doppler demultiplexing can be performed without using the beam direction determining processing using the reception antenna having directivity (or the directional receiving processing using the reception array antenna) as the multi-beam transmission and reception MIMO radar configuration, so that the reception processing computation quantity can be reduced.

Further, for example, when the reception antennas having the different beam directions are used as the multi-beam transmission and reception MIMO radar configuration, since the number of reception antennas available at the time of angle measurement may be reduced depending on the target object direction, the angle measuring accuracy or the angle measurement resolution of radar apparatus 10 may be reduced. In the present embodiment, for example, since Doppler demultiplexing is possible regardless of the target object direction without using a reception antenna having directivity, a decrease in the angle measurement accuracy and angle measurement resolution can be suppressed.

Therefore, according to the present embodiment, it is possible to improve the detection performance of a multi-beam transmission MIMO radar using coded Doppler multiplexing transmission.

### (Variation 1)

In the above embodiment, the case where multi-beam number NB is 2 has been described, but multi-beam number NB may be 3 or more. In Variation 1, a case where multi-beam number NB is 3 or more will be described.

When multi-beam number NB is equal to or larger than 3, the setting of the coded Doppler phase rotation amount by phase rotation amount setter 105 applies Condition 1-a and Condition 1-b described later instead of Condition 1 described above. This makes it possible to obtain an effect of enabling the separation of Doppler multiplexed signals and suppressing the deterioration of positioning performance and radar detection performance as in the above-described embodiment even when the reception power level of a reflected wave is significantly different between reception signals from transmission antennas with different beam directions.

Hereinafter, an example of the conditions for setting the coded Doppler phase rotation amount by phase rotation amount setter 105 when multi-beam number NB is 3 or more will be described.

For example, transmission antenna section 109 includes N_{B1}, N_{B2}, . . . , and N_{BQ} transmission antennas with different Q beam directions Bq. For example, phase rotation amount setter 105 of radar transmitter 100 in a MIMO radar (for example, radar apparatus 10) that performs multi-beam transmission sets coded Doppler multiplexing number N_{DOP_CODE}(ndm) for the Doppler multiplexed signals to be non-uniform, and further sets coded Doppler phase rotation amount ψ_{ndop_code(ndm), ndm}(m) to satisfy the following <Condition 1-a> and <Condition 1-b>. Here, ndm=1 to N_{DM}, and ndop_code(ndm)=1 to N_{DOP_CODE}(ndm).

<Condition 1-a>

Phase rotation amount setter 105 sets, for each transmission antenna in each beam direction Bq, coded Doppler phase rotation amount ψ_{ndop_code(ndm), ndm}(m) that satisfies a condition of a different Doppler multiplexing pattern, a condition of a different code multiplexing pattern, or a condition of a different pattern of Doppler multiplexing and code multiplexing. Here, q=1 to Q.

<Condition 1-b>

When viewing angle regions overlapping each other are included between beam directions Bq, phase rotation amount setter 105 sets coded Doppler phase rotation amount ψ_{ndop_code(ndm), ndm}(m) that satisfies a condition of a different code multiplexing pattern or a condition of a different pattern of Doppler multiplexing and code multiplexing, with a set of a plurality of transmission antennas (hereinafter, referred to as “transmission antenna set”) included in the overlapping regions (or, referred to as “overlapping beam regions”). Here, q=1 to Q.

The code and the Doppler multiplexed signals assigned to the transmission antenna of each beam Bq and the transmission antenna set included in the overlapping region satisfy at least one of the following conditions.

For example, the different Doppler multiplexing pattern condition may be any one of the following conditions (for example, also referred to as Condition 1A-a):
(A-1) The Doppler multiplexing numbers corresponding to respective beam directions are the same, and include different Doppler intervals in each beam direction (in the case of N_{DM_Bq}≥2);
(A-2) The Doppler multiplexing numbers for respective beam directions are different; and
(A-3) When the Doppler multiplexing numbers are 3 or more, the orders of the Doppler intervals are different (cyclically mismatched) in Doppler shift intervals for respective beam directions when the same Doppler intervals are included.

Alternatively, the different code multiplexing pattern condition may be any one of the following conditions (for example, also referred to as condition 1B-a):
(B-1) The code intervals (code INDEX intervals) assigned to respective Doppler multiplexed signals are different (cyclically mismatched); and
(B-2) The code multiplexing numbers assigned to respective Doppler multiplexed signals are different (cyclically mismatched).

Here, when multi-beam number NB is 3 or more, number Nt of transmission antennas is 4 or more, Doppler multiplexing number N_{DM} is 2 or more, maximum code multiplexing number N_{CM} is 2 or more, and Nt is less than N_{DM}×N_{CM}. Further, the number of transmission antennas with beam direction Bq is denoted as N_{Bq}. N_{Bq}≥1, and the total number of transmission antennas with beam directions Bq is Nt (N_{B1}+N_{B2}+ . . . +N_{BQ}=Nt). Further, Doppler multiplexing number N_{DM_Bq} assigned to the transmission antenna with beam direction Bq is denoted as N_{DM_Bq}. In addition, N_{DM_Bq}<N_{DM}.

Further, in a MIMO radar (for example, radar apparatus 10) that performs multi-beam transmission using N_{B1}, N_{B2}, . . . , and N_{BQ} transmission antennas for each of Q different beam directions B_{q}, phase rotation amount setter 105 of radar transmitter 100 may set coded Doppler phase rotation amount ψ_{ndop_code(ndm), ndm}(m) to satisfy the following Condition 2-a and Condition 2-b in addition to Condition 1-a and Condition 1-b.

<Condition 2-a>

A signal transmitted from the transmission antenna of each beam Bq is multiplexed with a code multiplexing number that is non-uniform between Doppler multiplexed signals, and the code multiplexing number is any number in a range of 1 or more to N_{CM}−1 or less. Here, q=1 to Q.

<Condition 2-b>

When there is an overlapping beam region between beams Bq, signals transmitted from a transmission antenna set included in the overlapping beam region is multiplexed and transmitted with a code multiplexing number that is non-uniform between Doppler multiplexed signals, and the code multiplexing number is any number in a range of 1 or more to N_{CM}−1 or less.

By satisfying Conditions 2-a and 2-b, in addition to Conditions 1-a and 1-b, with the setting of the coded Doppler phase rotation amount by phase rotation amount setter 105, the Doppler detection range detectable by radar apparatus 10 can be expanded to a range equivalent to that in the case of one transmission antenna (for example, a range of ±1/(2Tr)), as in the above-described embodiment. Further, even when Conditions 1-a and 1-b are satisfied but Conditions 2-a and 2-b are not satisfied, the Doppler detection range can be expanded beyond the Doppler detection range of the even interval DDM (for example, −1/(2N(Tr)≤fd<1/(2N+Tr)) in the same manner as in the above embodiment.

Hereinafter, an exemplary operation of radar apparatus 10 will be described.

### <Exemplary Operation 1>

In exemplary operation 1, multi-beam number NB is 3, and no overlapping beam region is included between beam directions Bq.

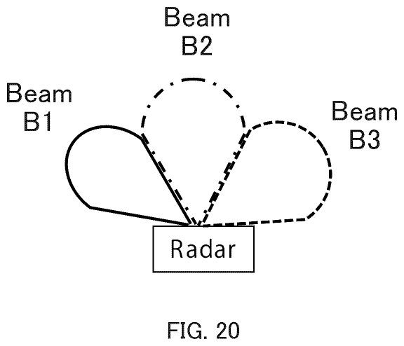

For example, FIG. 20 illustrates an example of a beam pattern of transmission antennas with beam directions B1, B2, and B3 when multi-beam number NB is 3. As illustrated in FIG. 20, when there are no overlapping portions in the beam pattern (or when there are small overlapping portions) of the transmission antennas in respective beam directions, Condition 1-a and Condition 2-a may be applied.

For example, in FIG. 20, when the target object direction is any one of beam direction B1, beam direction B2, and beam direction B3, the assignment of a Doppler multiplexed signal by Doppler shift setter 106 may satisfy Condition 1-a. Thus, radar apparatus 10 can discriminate, in coded Doppler demultiplexer 212, a case where the reception level of the reception signal corresponding to the transmission antenna with beam direction B1 decreases, a case where the reception level of the reception signal corresponding to the transmission antenna with beam direction B2 decreases, and a case where the reception level of the reception signal corresponding to the transmission antenna with beam direction B3 decreases.

Further, when the discrimination result indicates that the reception signal corresponds to the transmission antenna with beam direction B1 (or B2 or B3), as the coded Doppler phase rotation amount is assigned in phase rotation amount setter 105 such that Condition 2-a is satisfied, the coded Doppler multiplexed signal for the transmission antenna with beam direction B1 (or B2 or B3) can be separated by using the operation of a known coded Doppler multiplexed signal separator. By the operation of coded Doppler demultiplexer 212 as described above, radar apparatus 10 can determine Doppler frequency fd of the target object in the range of −1/(2Tr)≤fd<1/(2Tr), and can obtain an output in which each Doppler multiplexed signal is associated with its corresponding transmission antenna.

### <Exemplary Operation 2>

In exemplary operation 2, multi-beam number NB is 3, and an overlapping beam region is included between beam directions Bq.

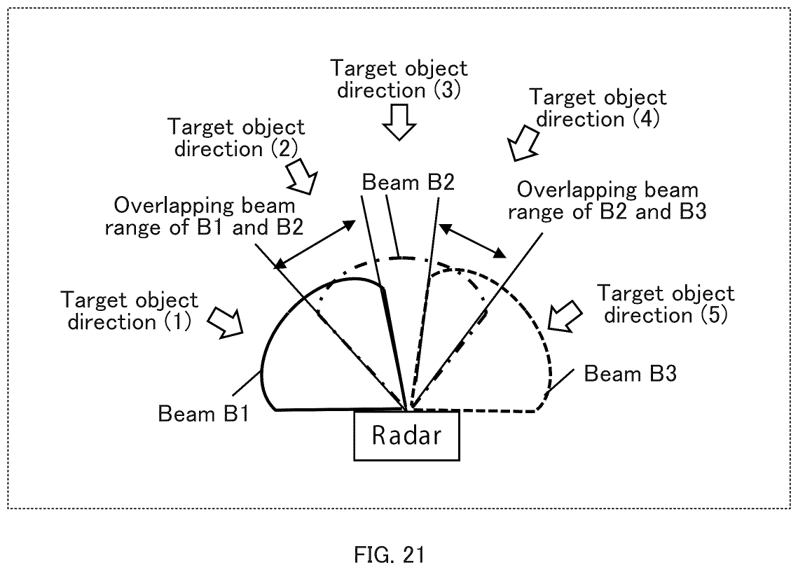

For example, FIG. 21 illustrates an example of a beam pattern of transmission antennas with beam directions B1, B2, and B3 when multi-beam number NB is 3. As illustrated in FIG. 21, when the beam pattern of the transmission antennas in respective beam directions includes overlapping portions (overlapping beam regions), Condition 1-a, Condition 1-b, Condition 2-a, and Condition 2-b may be applied.

For example, in FIG. 21, when the target object direction is transmission beam direction B1, B2, or B3 outside the overlapping beam range (in FIG. 21, in the case of target object direction (1), (3), or (5)), the assignment of the coded Doppler phase rotation amounts by phase rotation amount setter 105 may satisfy Condition 1-a. Thus, radar apparatus 10 can determine in coded Doppler demultiplexer 212 which reception signal corresponds to which transmission antenna in beam directions B1, B2, or B3.

Further, for example, in FIG. 21, when the target object direction is within the overlapping beam range (in the case of target object direction (2) or (4) in FIG. 21), the assignment of the coded Doppler phase rotation amounts by phase rotation amount setter 105 may satisfy Condition 1-a and Condition 1-b. Thus, radar apparatus 10 can determine, in addition to determining which reception signal corresponds to which transmission antenna in beam directions B1, B2, or B3, whether the reception signal is from the overlapping beam region of the transmission antennas with beam directions B1 and B2 or from the overlapping beam region of the transmission antennas with beam directions B2 and B3, in coded Doppler demultiplexer 212.

Further, when the ditermination result indicates that the reception signal corresponds to the transmission antenna with beam direction B1 (or B2 or B3), the coded Doppler phase rotation amount is assigned in phase rotation amount setter 105 such that Condition 2-a is satisfied, and thus, the coded Doppler multiplexed signal for the transmission antenna with beam direction B1 (or B2 or B3) can be separated by using the operation of a known coded Doppler multiplexed signal separator. By the operation of coded Doppler demultiplexer 212 as described above, radar apparatus 10 can determine Doppler frequency fd of the target object in the range of −1/(2Tr)≤fd<1/(2Tr), and can obtain an output in which each Doppler multiplexed signal is associated with its corresponding transmission antenna.

Further, when the reception signal is determined to be from the overlapping beam region of the transmission antennas with beam directions B1 and B2 (or beam directions B2 and B3), the assignment of the coded Doppler multiplexed signals in phase rotation amount setter 105 satisfies Condition 2-b, and thus, the coded Doppler multiplexed signal for the transmission antenna included in the overlapping beam region of the transmission antennas with beam directions B1 and B2 (or beam directions B2 and B3) can be separated by using the operation of a known coded Doppler multiplexed signal separator. By the operation of coded Doppler demultiplexer 212 as described above, radar apparatus 10 can determine Doppler frequency fd of the target object in the range of −1/(2Tr)≤fd<1/(2Tr), and can obtain an output in which each Doppler multiplexed signal is associated with its corresponding transmission antenna.

The exemplary operation of radar apparatus 10 has been described above.

Next, an exemplary configuration a coded Doppler phase rotation amount in phase rotation amount setter 105 will be described.

Hereinafter, an exemplary configuration (in the case of NB=3) of the coded Doppler phase rotation amounts when Condition 1 (for example, Condition 1-a and Condition 1-b) and Condition 2 (for example, Condition 2-a and Condition 2-b) are satisfied will be described.

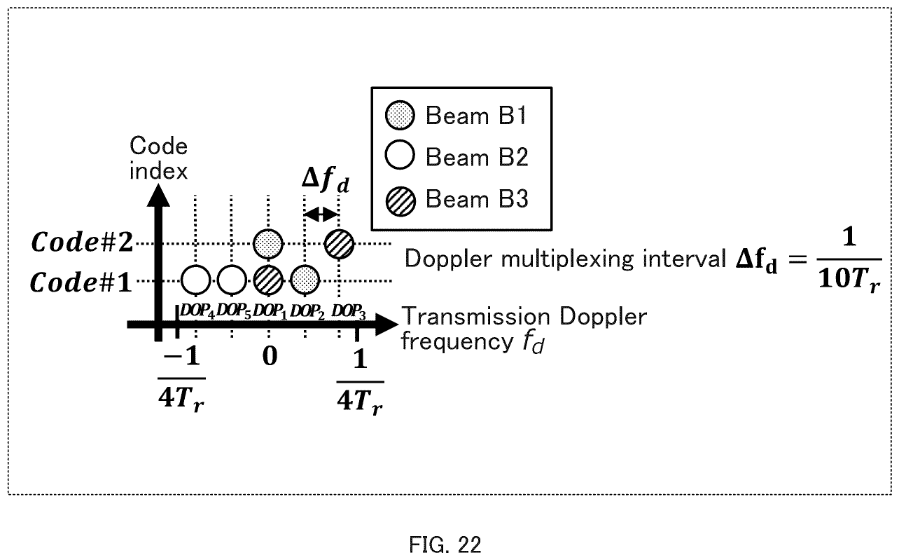

FIG. 22 illustrates an exemplary configuration of the coded Doppler phase rotation amounts in phase rotation amount setter 105 when number Nt of transmission antennas is 6, N_{B1}=2, N_{B2}=2, and N_{B3}=2.

In FIGS. 22, Tx #1 and Tx #2 are transmission antennas with beam direction B1, Tx #3 and Tx #4 are transmission antennas with beam direction B2, and Tx #5 and Tx #6 are transmission antennas with beam direction B3.

Further, in FIG. 22, Doppler multiplexing number N_{DM} is 5, and Doppler shift setter 106 may set five Doppler shift amounts DOP₁ to DOP₅ using, for example, the maximum even interval Doppler shift amount setting shown in Expression 5. In FIG. 22, the phase rotation amounts to which Doppler shift amounts, namely DOP₁=0, DOP₂=Δfd, DOP₃=2Δfd, DOP₄=−2Δfd, and DOP₅=−Δfd, are applied are φ₁=0, φ₂=2π/5, φ₃=4π/5, φ₄=6π/5 (or φ₄=−4π/5), and φ₅=8π/5 (or φ₅=−2π/5), respectively. As illustrated in FIG. 22, Doppler multiplexing interval Δfd is an even interval, and Δfd=1/(10Tr).

Further, in FIG. 22, code multiplexing number Ncm is 2, and encoder 107 uses, for example, Code₁={1, 1} and Code₂={1,−1}, which are orthogonal code sequences of Walsh-Hadamard codes with code length Loc=2.

In FIG. 22, number Nt of transmission antennas is 6, Doppler multiplexing number N_{DM} is 5, and code multiplexing number N_{CM} is 2, and since Nt<N_{DM}× N_{CM}, phase rotation amount setter 105 can set coded Doppler multiplexing number N_{DOP_CODE}(ndm) for the Doppler multiplexed signal non-uniformly (where ndm=1 to N_{DM}).

As illustrated in FIG. 22, in encoder 107, the coded Doppler multiplexing numbers for the Doppler multiplexed signals with five Doppler shift amounts DOP₁ to DOP₅ inputted from Doppler shift setter 106 are N_{DOP_CODE}(1)=2, N_{DOP_CODE} (2)=1, N_{DOP_CODE}(3)=1, N_{DOP_CODE}(4)=1, and N_{DOP_CODE}(5)=1, respectively. As described above, phase rotation amount setter 105 sets non-uniformly the coded Doppler multiplexing numbers for the Doppler multiplexed signals.

Further, in FIG. 22, Doppler shift setter 106 assigns, for transmission antennas Tx #1 and Tx #2 with beam direction B1, Doppler multiplexed signals with, for example, Doppler shift amounts DOP₁ and DOP₂ among the Doppler multiplexed signals with Doppler multiplexing number N_{DM}=5 (N_{DM_B1}=2). Further, encoder 107 assigns Code₂ and Code₁ to the Doppler multiplexed signals with Doppler shift amounts DOP₁ and DOP₂ assigned to transmission antennas Tx #1 and Tx #2 with beam direction B1, respectively. For example, phase rotation amount setter 105 sets coded Doppler phase rotation amounts ψ_{2,1}(m) and ψ_{1,2}(m) for respective transmission antennas Tx #1 and Tx #2 with beam direction B1.

Further, in FIG. 22, Doppler shift setter 106 assigns, to transmission antennas Tx #3 and Tx #4 with beam direction B2, Doppler multiplexed signals with, for example, Doppler shift amounts DOP₄ and DOP₅ among the Doppler multiplexed signals with Doppler multiplexing number N_{DM}=5 (N_{DM_B2}=2). Further, encoder 107 assigns Code₁ and Code₁ to the Doppler multiplexed signals with Doppler shift amounts DOP₄ and DOP₅ assigned to transmission antennas Tx #3 and Tx #4 with beam direction B2, respectively. For example, phase rotation amount setter 105 sets coded Doppler phase rotation amounts ψ_{1,4}(m) and ψ_{1,5}(m) for respective transmission antennas Tx #3 and Tx #4 with beam direction B2.

Further, in FIG. 22, Doppler shift setter 106 assigns, to transmission antennas Tx #5 and Tx #6 with beam direction B3, Doppler multiplexed signals with, for example, Doppler shift amounts DOP₁ and DOP₃ among the Doppler multiplexed signals with Doppler multiplexing number N_{DM}=5 (N_{DM_B3}=2). Further, encoder 107 assigns Code₁ and Code₂ to the Doppler multiplexed signals with Doppler shift amounts DOP₁ and DOP₃ assigned to transmission antennas Tx #5 and Tx #6 with beam direction B3, respectively. For example, phase rotation amount setter 105 sets coded Doppler phase rotation amounts ψ_{1,1} (5) and ψ_{2,3} (m) for respective transmission antennas Tx #5 and Tx #6 with beam direction B3.

In FIG. 22, the Doppler multiplexing numbers that Doppler shift setter 106 assigns to the respective transmission antennas with beam directions B1, B2, and B3 are N_{DM_B1}=N_{DM_B2}=N_{DM_B3}=2, and the numbers are the same. Accordingly, the setting of the coded Doppler phase rotation amounts illustrated in FIG. 22 does not match the different Doppler multiplexing pattern conditions of Condition 1A-a.

Further, in FIG. 22, the code indexes assigned to the transmission antennas with beam direction B1, B2, and B3 for the Doppler multiplexed signals using Doppler multiplexed signals DOP₁ to DOP₅ are CodeIndex_B1=(2, 1, *, *, *), CodeIndex_B2=(*, *, *, 1, 1), and CodeIndex_B3=(1, *, 2, *, *), respectively. The code indexes are cyclically mismatched and the code INDEX intervals are different, and thus, Condition 1B-a (B-1) is satisfied.

Further, in FIG. 22, the code multiplexing numbers assigned to the transmission antennas with beam direction B1, B2, and B3 for the Doppler multiplexed signals using Doppler multiplexed signals DOP₁ to DOP₅ are N_Code_B1=(1, 1, 0, 0, 0), N_Code_B2=(0, 0, 0, 1, 1), and N_Code_B3=(1, 0, 1, 0, 0), respectively, and include code multiplexing numbers that are cyclically matched, and the code multiplexing numbers are the same, and thus, Condition 1B-a (B-2) is not satisfied.

Note that, when the Doppler frequency of the target object is −1/(2Tr)≤fdtarget object<−1/(4Tr) or 1/(4Tr)≤fdtarget object<1/(2Tr), Doppler analyzer 210 observes an aliasing Doppler frequency. In this case, the indexes are CodeIndex_B1_alias=(1, 2, *, *, *), CodeIndex_B2_alias=(*, *, *, 2, 2), and CodeIndex_B3_alias=(2, *, 1, *, *), which are different (cyclically mismatched). Thus, in the example of FIG. 22, in a range of the Doppler frequency of the target object of −1/(2Tr)≤fdtarget object<−1/(2Tr), the code indexes become cyclically mismatched, and the code INDEX intervals are different. Accordingly, Condition 1-a is satisfied, and the different code multiplexing pattern condition is met.

Thus, the setting of the coded Doppler phase rotation amounts illustrated in FIG. 22 is an exemplary configuration that satisfies Condition 1-a.

Further, in FIG. 22, the code indexes assigned to the overlapping beam region (transmission antenna set) in beam directions B1 and B2 and the overlapping beam region (transmission antenna set) in beam directions B2 and B3 for the Doppler multiplexed signals using Doppler multiplexed signals DOP₁ to DOP₅ are CodeIndex_B1&B2=(2, 1, *, 1, 1) and CodeIndex_B2&B3=(1, *, 2, 1, 1), respectively, and the code indexes are cyclically mismatched. Further, even when CodeIndex_B1, CodeIndex_B2, and CodeIndex_B3 are included in addition to CodeIndex_B1&B2 and CodeIndex_B2&B3, the relationship is such that the code INDEX intervals are different (cyclically mismatched), and thus, Condition 1-b is satisfied.

Note that, when the Doppler frequency of the target object is −1/(2Tr)≤fdtarget object<−1/(4Tr) or 1/(4Tr)≤fdtarget object<1/(2Tr), Doppler analyzer 210 observes an aliasing Doppler frequency. In this case, the code indexes are CodeIndex_B1&B2_alias=(1, 2, *, 2, 2) and CodeIndex_B2&B3_alias=(2, *, 1, 2, 2), which are different (cyclically mismatched). Thus, in the example of FIG. 22, in a range of the Doppler frequency of the target object of −1/(2Tr)≤fdtarget object<−1/(2Tr), the code indexes becomes cyclically mismatched even when CodeIndex_B1_alias, CodeIndex_B2_alias, and CodeIndex_B3_alias are included, and the code INDEX intervals are different. Accordingly, Condition 1-b is satisfied.

Thus, the setting of the coded Doppler phase rotation amounts illustrated in FIG. 22 is an exemplary configuration that satisfies Condition 1-b.

Further, in FIG. 22, the code multiplexing numbers assigned to Doppler multiplexed signals in the transmission antennas with beam directions B1, B2, and B3 are N_Code_B1=(1,1,0, 0, 0), N_Code_B2=(0, 0, 0, 1, 1), and N_Code_B3=(1, 0, 1, 0, 0), respectively, and the Doppler multiplexed signals are multiplexed with code multiplexing numbers (included in a range of 1 or more to N_{CM}−1 or less) that are non-uniform between the Doppler multiplexed signals. Accordingly, the setting of the coded Doppler phase rotation amounts illustrated in FIG. 22 is an exemplary configuration that satisfies Condition 2-a.

Further, in FIG. 22, the code multiplexing numbers assigned to Doppler multiplexed signals in the transmission antennas in the overlapping beam region of beam directions B1 and B2 and the overlapping beam region of beam directions B2 and B3 are N_Code_B1&B2=(1, 1,0, 1, 1) and N_Code_B2&B3=(1, 0, 1, 1, 1), respectively, and the Doppler multiplexed signals are multiplexed with code multiplexing numbers (included in a range of 1 or more to N_{CM}-1 or less) that are non-uniform between the Doppler multiplexed signals. Accordingly, the setting of the coded Doppler phase rotation amounts illustrated in FIG. 22 is an exemplary configuration that satisfies Condition 2-b.

Hereinafter, an example of reception signals in the outputs of Doppler analyzers 210 when transmission antenna section 109 includes transmission antennas with different beam directions B1, B2, and B3 based on the setting of the Doppler shift amounts illustrated in FIG. 22, and reception antenna section 202 is an omnidirectional antenna (or an antenna with substantially uniform directional characteristics within a viewing angle covered by both transmission antennas with beam direction B1 and beam direction B2) will be described.

For example, when the target object direction is target object direction (1), (3), or (5) illustrated in FIG. 21 (for example, when there is a target object in the periphery of beam direction B1, B2, or B3), or when the target object direction is target object direction (2) or (4) (for example, when there is a target object in the periphery of overlapping beam region B1&B2 or B2&B3), the code intervals are different in the transmission antennas for respective beam directions and the transmission antenna sets for respective overlapping beam directions. Thus, radar apparatus 10 can determine a decrease in the reception level of a reception signal corresponding to a transmission antenna included in any one of beam directions B1, B2, or B3, and overlapping beam regions B2&B3 and B2&B3 in coded Doppler demultiplexer 212.

When the determination result indicates that the reception signal is from a transmission antenna with beam direction Bq or an overlapping beam region (for example, B2&B3 or B2&B3), the setting of the coded Doppler multiplexed signal for the transmission antenna with beam direction Bq or the overlapping beam region (B2&B3 or B2&B3) is known. Therefore, radar apparatus 10 can separate the multiplexed signal by performing an operation disclosed in, for example, PTLs 5 and 6.

Further, in the example of FIG. 22, the setting of the coded Doppler phase rotation amounts by phase rotation amount setter 105 satisfies Condition 2-a and Condition 2-b, and thus, the detectable Doppler frequency range fd becomes a range of −1/(2Tr)≤fd<1/(2Tr) depending on the target object direction, and the Doppler detection range can be expanded beyond the Doppler detection range of the even interval Doppler multiplexing.

### (Variation 2)

In the above-described embodiment and variation, a case where beam directions in the multi-beam are different from each other has been described as illustrated in FIGS. 10, 20, and 21, but the setting of the multi-beam (for example, the beam direction and the beam width) is not limited thereto. For example, beams constituting the multi-beam may differ in at least one of a beam direction or a beam width. In addition, multi-beam number NB≥2 may be used.

Hereinafter, an exemplary configuration of a multi-beam will be described.

### <Exemplary Configuration 1 of Multi-Beam>

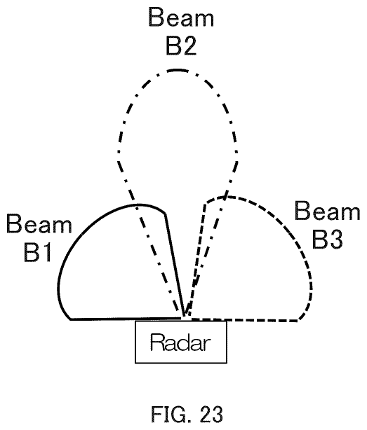

In exemplary configuration 1, for example, as illustrated in FIG. 23, the beam directions in a multi-beam (for example, beam directions B1, B2, and B3) may be different from each other, and the beam widths may also be different. In a multi-beam (for example, beam directions B1, B2, and B3), the beam directions in the horizontal direction (or the horizontal plane) may be different from each other, and the beam widths in the horizontal direction (or the horizontal plane) may also be different. In addition, the beam directions may be different from each other in the horizontal direction (or horizontal plane) and different from each other in the vertical direction (or vertical plane).

### <Exemplary Configuration 2 of Multi-Beam>

In the above embodiment, an example in which the beam directions are different in the horizontal direction (or the horizontal plane) has been described as illustrated in FIG. 10, but the configuration is not limited thereto. In exemplary configuration 2, for example, the beam directions may be different from each other in the vertical direction (or vertical plane).

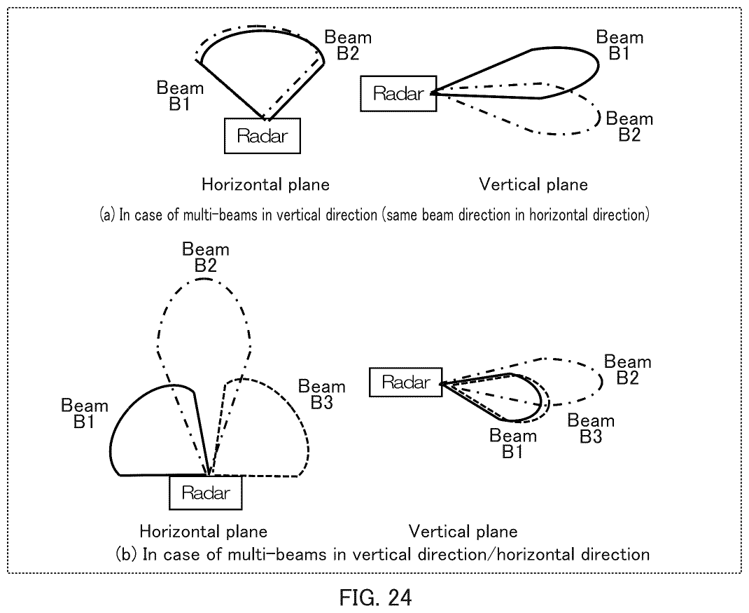

For example, as illustrated at part (a) in FIG. 24, in a multi-beam (for example, beam directions B1 and B2), the beam directions may be substantially the same in the horizontal direction (or horizontal plane), and the beam directions may be different in the vertical direction (or vertical plane).

Further, for example, as illustrated at part (b) in FIG. 24, in a multi-beam (for example, beam directions B1, B2, and B3), the beam directions may be different in both the horizontal direction (or horizontal plane) and the vertical direction (or vertical plane).

### <Exemplary Configuration 3 of Multi-Beam>

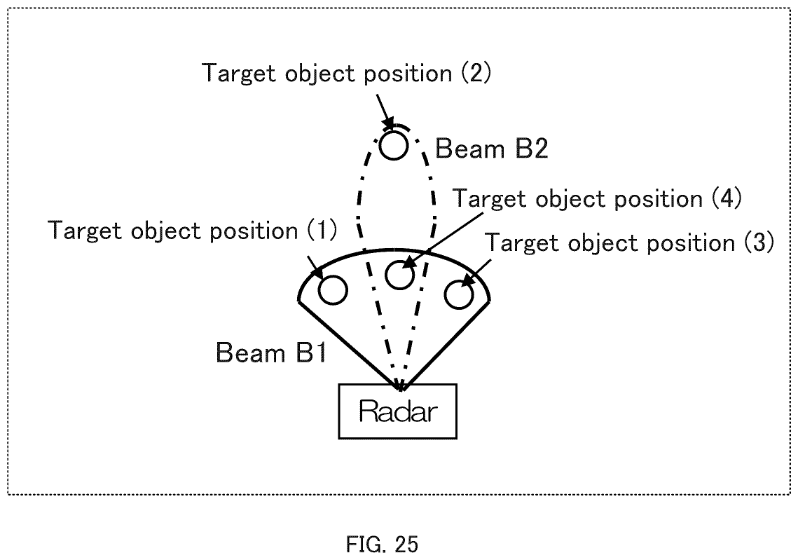

In exemplary configuration 3, for example, as illustrated in FIG. 25, the beam directions in a multi-beam (for example, beam directions B1 and B2) may be substantially the same, and the beam widths may be different. In a multi-beam (for example, beam directions B1 and B2), the beam directions in the horizontal direction (or the horizontal plane) may be substantially the same, and the beam widths in the horizontal direction (or the horizontal plane) may be different. In a multi-beam (for example, beam directions B1 and B2), the beam directions in the vertical direction (or vertical plane) may be substantially the same, and the beam widths in the vertical direction (or vertical plane) may be different.

In the exemplary configuration 3, for example, by replacing the phrase “transmission antennas with different beam directions” described in the above embodiment with the phrase “transmission antennas with different beam widths” (hereinafter, referred to as “beams are different”), the configuration thereof can be applied in the same manner as in the above embodiment.

Hereinafter, as an example, an exemplary operation of radar apparatus 10 in the case where the beam directions are the same and the beam widths are different will be described using exemplary configuration 1 of the coded Doppler phase rotation amounts. Note that the setting of the coded Doppler phase rotation amounts is not limited to exemplary configuration 1, and the same operation can be performed and the same effect as in the above-described embodiment can be obtained even when another exemplary configuration of the coded Doppler phase rotation amount is used.

For example, when number Nt of transmission antennas is 4 (for example, Tx #1, Tx #2, Tx #3, and Tx #4), NB1=2, and NB2=2, exemplary configuration 1 of the setting of the coded Doppler phase rotation amounts in phase rotation amount setter 105 described above is applied. Note that, for example, Tx #1 and Tx #2 are transmission antennas with beam width B1 (for example, beam B1) illustrated in FIG. 25, and Tx #3 and Tx #4 are transmission antennas with beam width B2 (for example, beam B2) illustrated in FIG. 25. FIG. 25 illustrates an example in which the beam width of beam B1 is wider than the beam width of beam B2. Here, the beam widths of beam B1 and beam B2 may be horizontal (or horizontal plane), or vertical (or vertical plane), or both horizontal (or horizontal plane) and vertical (or vertical plane), and similar effects can be obtained.

In addition, in radar apparatus 10, the reception antenna may be an omnidirectional antenna (or an antenna having substantially uniform directional characteristics within the viewing angle covered by both the transmission antenna with beam B1 and the transmission antenna with beam B2).

For example, when a target object position is target object position (1) or target object position (3) illustrated in FIG. 25, the target object position is within the beam width of beam B1 and within the viewing angle, and thus, the reception levels of the reflected waves corresponding to the radar transmission waves transmitted from Tx #1 and Tx #2 of beam B1 become relatively high. On the other hand, target object position (1) and target object position (3) are outside the beam width of beam B2 and are outside the viewing angle, and thus, the radiation direction of the radar transmission waves transmitted from Tx #3 and Tx #4 of beam B2 does not coincide with the direction of target object position (1) or target object position (3), and target object position (1) and target object position (3) correspond to the null direction of transmission antenna Tx #3 of beam B2. Therefore, the reception levels of the reception signals corresponding to Tx #3 and Tx #4 in radar apparatus 10 are lower than the reception levels of the reception signals corresponding to Tx #1 and Tx #2. For example, the reception levels of the reception signals corresponding to Tx #3 and Tx #4 are significantly different from the reception levels of the reception signals corresponding to Tx #1 and Tx #2, and may be, for example, 10 dB or more lower depending on the beam direction characteristics in the null directions of Tx #3 and Tx #4. In such a case, the reception signal received by radar apparatus 10 becomes the reception signal illustrated at part (a) in FIG. 9.

Further, for example, when a target object position is in a region in which the viewing angles of both beam B1 and beam B2 overlap with each other as in target object position (4) illustrated in FIG. 25 (for example, when the target object position is at a short distance), radar apparatus 10 receives reflected waves corresponding to radar transmission waves transmitted from Tx #1 and Tx #2 of beam B1, and reflected waves corresponding to radar transmission waves transmitted from Tx #3 and Tx #4 of beam B2. In this case, the reception signals received by radar apparatus 10 may be, for example, the reception signals as illustrated at part (b) in FIG. 9. Alternatively, for example, when the directional gain of beam B2 is higher than that of beam B1 by approximately 10 dB or more, the reception signals received by radar apparatus 10 may be, for example, the reception signals as illustrated at part (c) in FIG. 9.

Further, for example, when a target object position is within the viewing angle of beam B2 and outside the viewing angle of beam B1 as in target object position (2), as illustrated in FIG. 25 (for example, when the target object is at a far distance), the reception level of reflected waves corresponding to radar transmission waves transmitted from Tx #3 and Tx #4 of beam B2 becomes relatively high. On the other hand, since the directional gain of beam B1 is smaller than the directional gain of beam B2, the reception levels of the reflected waves corresponding to the radar transmission waves transmitted from Tx #1 and Tx #2 of beam B1 is lower than the reception levels of the reception signals corresponding to Tx #3 and Tx #4. For example, the reception levels of the reception signals corresponding to Tx #1 and Tx #2 are significantly different from the reception levels of the reception signals corresponding to Tx #3 and Tx #4, and may be, for example, 10 dB or more lower depending on the beam directional characteristics of Tx #1 and Tx #2. In such a case, the reception signal received by radar apparatus 10 becomes the reception signals illustrated at part (c) in FIG. 9.

For example, as illustrated at part (b) in FIG. 9, when radar apparatus 10 receives reception signals corresponding to the transmission antennas of the respective beams at substantially the same reception level, the signals transmitted from Nt transmission antennas including the transmission antennas of beam B1 and beam B2 are subjected to coded Doppler multiplexing with the coded Doppler multiplexing numbers for the Doppler multiplexed signals being set non-uniformly. Thus, radar apparatus 10 can separate the coded Doppler multiplexed signals based on the known separation operation of coded Doppler multiplexed signals.

Further, as illustrated at parts (a) and (c) in FIG. 9, when radar apparatus 10 receives reflected waves from either beam B1 or beam B2 (when the the reception level difference is large), radar apparatus 10 receives different coded Doppler multiplexed signals (for example, Doppler multiplexed signals satisfying Condition 1) depending on the target object position. Therefore, radar apparatus 10 can determine in coded Doppler demultiplexer 212 whether a decrease in the reception level of the reception signal corresponding to the transmission antenna of beam B1 has occurred or whether a decrease in the reception level of the reception signal corresponding to the transmission antenna of beam B2 has occurred.

For example, coded Doppler multiplexed signals transmitted from the transmission antennas of beam B1 (or beam B2) are subjected to coded Doppler multiplexing with the coded Doppler multiplexing numbers for the Doppler multiplexed signals being set non-uniformly. Thus, for example, when the reception signal is determined to be a reception signal corresponding to the transmission antenna of beam B1 (or beam B2) based on the determination result of coded Doppler demultiplexer 212, radar apparatus 10 can separate the coded Doppler multiplexed signals based on the known separation operation of coded Doppler multiplexed signals.

By the operation of coded Doppler demultiplexer 212 as described above, radar apparatus 10 can determine Doppler frequency fd of the target object in a range of −1/(2Tr)≤fd<1/(2Tr), and can obtain an output in which each Doppler multiplexed signal is associated with its corresponding transmission antenna.

The embodiments of the present disclosure have been described above.

### OTHER EMBODIMENTS

(1) In a radar apparatus according to an exemplary embodiment of the present disclosure, the radar transmitter and the radar receiver may be individually arranged in physically separate locations from each other. In addition, in the radar receiver according an exemplary embodiment of the present disclosure, the direction estimator and any other component may be individually arranged in physically separate locations from one another.

(2) The numerical values of parameters used in an exemplary embodiment of the present disclosure, such as number Nt of transmission antennas, number Na of reception antennas, Doppler multiplexing number N_{DM}, number NB of beams in a multi-beam, number NB_{q} of transmission antennas in a beam direction, the Doppler shift amount, the Doppler shift interval, code multiplexing number N_{CM}, and the code interval (code index), are examples and are not limited to those values. Further, for example, some of the transmission antennas included in the radar apparatus may be used as Nt transmission antennas, and some of the transmission antennas included in the radar apparatus may be used as Na reception antennas.

(3) The MIMO antenna arrangement example used in an exemplary embodiment of the present disclosure (e.g., arrangement example A and arrangement example B) has been described as a case where a radar transmission signals are transmitted from a plurality of transmission antennas using the coded Doppler multiplexing transmission, but the configuration is not limited thereto. For example, the arrangement can also be applied to a case where radar transmission signals are transmitted from a plurality of transmission antennas using time-division multiplexing or code multiplexing, and the effects from the disclosed MIMO antenna arrangement can also be obtained in such a case.

(4) In the above embodiment, in a multi-beam transmission MIMO radar using the coded Doppler multiplexing transmission, the following precondition is used: in order to expand the detectable Doppler frequency range to the ±1/(2Tr) range for the transmission antennas including Nt different directionalities, the code multiplexing number between Doppler multiplexed signals is set non-uniformly, and the coded Doppler multiplexing transmission is performed from a plurality of transmission antennas. In the above embodiment, a method for improving the detection performance of a multi-beam transmission MIMO radar by applying coded Doppler multiplexing transmission that satisfies Condition 1 and Condition 2 has been described. However, for example, when the movement velocity of an assumed target object is relatively low, or when the relative velocity between the radar apparatus and a target object is limited to a narrow range, the above-described precondition does not have to be applied.

For example, encoder 107 may set coded Doppler multiplexing numbers N_{DOP_CODE}(1), N_{DOP_CODE}(2), . . . , N_{DOP_CODE}(N_{DM}) to include the same number of coded Doppler multiplexing numbers in a range of one or more and Ncm or less by using an even interval Doppler shift amount setting with an interval narrower than the maximum even interval Doppler shift amount setting. For example, encoder 107 may set code number N_{CM} for all the coded Doppler multiplexing numbers. Thus, in a plurality of combinations of Doppler shift amounts DOP_{ndm} and orthogonal code sequences, the multiplexing numbers (coded Doppler multiplexing number) N_{DOP_CODE}(ndm) by the orthogonal code sequences associated with corresponding Doppler shift amounts DOP_{ndm} may be the same. For example, encoder 107 may set the coded Doppler multiplexing numbers for the Doppler multiplexed signals uniformly. With this setting, the Doppler multiplexed signals are for uneven interval Doppler multiplexing, and thus, radar apparatus 10 can individually separate and receive signals, to which the coded Doppler multiplexing transmission is performed, from a plurality of transmission antennas over a Doppler range of ±1/(2×Loc×Tr). By applying such a configuration of coded Doppler multiplexing transmission and further applying coded Doppler multiplexing transmission that satisfies Condition 1, it is possible to improve the detection performance of a multi-beam transmission MIMO radar.

Alternatively, encoder 107 may, for example, set coded Doppler multiplexing numbers N_{DOP_CODE}(1), N_{DOP_CODE}(2), . . . , N_{DOP_CODE}(N_{DM}) to include the same number of coded Doppler multiplexing numbers in a range of one or more and Ncm or less by using the maximum even interval Doppler shift amount setting. For example, encoder 107 may set code number Ncm for all the coded Doppler multiplexing numbers. In this case, the number of combinations of Doppler shift amounts DOP_{ndm} and orthogonal code sequences may be the same as number Nt of transmission antennas (for example, N_{DM}×N_{CM}=Nt). For example, encoder 107 may set the coded Doppler multiplexing number for Doppler multiplexed signals uniformly. In this setting, the aliasing determination processing in the reception processing of radar apparatus 10 is not applied. Further, radar apparatus 10 can individually separate and receive signals, to which the coded Doppler multiplexing transmission is performed, from a plurality of transmission antennas over a Doppler range of, for example, ±1/(2Loc×N_{DM}×Tr). By applying such a configuration of coded Doppler multiplexing transmission and further applying coded Doppler multiplexing transmission that satisfies Condition 1, it is possible to improve the detection performance of a multi-beam transmission MIMO radar.

(5) In an embodiment of the present disclosure, the code multiplexing transmission may be performed using some, rather than all, of the Nt transmission antennas included in radar apparatus 10.

Further, when the code multiplexing transmission is performed using some, rather than all, of the Nt transmission antennas included in radar apparatus 10, radar apparatus 10 may set (or change) at least one of a combination of transmission antennas used for code Doppler multiplexing transmission and the multiplexing transmission number in a time division manner and transmit the same. In this case, for example, radar apparatus 10 may time-divisionally switch the combination of transmission antennas for each transmission period or for each code transmission period (for example, a period corresponding to the code length of a code sequence). Alternatively, for example, radar apparatus 10 may switch the combination of transmission antennas or the number of transmission antennas to be multiplexed for each measurement period (for each of the Nc radar-transmission-signal transmission times). Even when such an operation is applied, the effects of the embodiment described above can be obtained equally.

Further, when the code multiplexing transmission is performed using some, rather than all, of the Nt transmission antennas included in radar apparatus 10, radar apparatus 10 may set (for example, change) the combination of transmission antennas used for code Doppler multiplexing transmission in a time division manner and may transmit the same using different chirp signals. For example, radar apparatus 10 may transmit different chirp signals by changing at least one of the transmission band, the frequency sweep time, and the center frequency of the chirp signals, or by combining a plurality of these parameters.

(6) A radar apparatus according to an exemplary embodiment of the present disclosure includes, for example, a central processing unit (CPU), a storage medium such as a read only memory (ROM) that stores a control program, and a work memory such as a random access memory (RAM), which are not illustrated. In this case, the functions of the sections described above are implemented by the CPU executing the control program.

However, the hardware configuration of the radar apparatus is not limited to that in this example. For example, the functional sections of the radar apparatus may be implemented as an integrated circuit (IC). Each functional section may be formed as an individual chip, or some or all of them may be formed into a single chip.

Various embodiments have been described with reference to the drawings hereinabove. Obviously, the present disclosure is not limited to these examples. Obviously, a person skilled in the art would arrive at variations and modification examples within a scope described in claims, and it is understood that these variations and modifications are within the technical scope of the present disclosure. Each constituent element of the above-mentioned embodiments may be combined optionally without departing from the spirit of the disclosure.

The expression “section” used in the above-described embodiments may be replaced with another expression such as “circuit (circuitry),” “assembly,” “device,” “unit,” or “module.”

The above embodiments have been described with an example of a configuration using hardware, but the present disclosure can be realized by software in cooperation with hardware.

Each functional block used in the description of each embodiment described above is typically realized by an LSI, which is an integrated circuit. The integrated circuit controls each functional block used in the description of the above embodiments and may include an input terminal and an output terminal. The LSI may be individually formed as chips, or one chip may be formed so as to include a part or all of the functional blocks. The LSI herein may be referred to as an IC, a system LSI, a super LSI, or an ultra LSI depending on a difference in the degree of integration.

However, the technique of implementing an integrated circuit is not limited to the LSI and may be realized by using a dedicated circuit, a general-purpose processor, or a special-purpose processor. In addition, a Field Programmable Gate Array (FPGA) that can be programmed after the manufacture of the LSI or a reconfigurable processor in which the connections and the settings of circuit cells disposed inside the LSI can be reconfigured may be used.

When future integrated circuit technology replaces LSIs as a result of the advancement of semiconductor technology or other derivative technology, the functional blocks could be integrated using the future integrated circuit technology. Biotechnology can also be applied.

### SUMMARY OF PRESENT DISCLOSURE

A radar apparatus according to one exemplary embodiment of the present disclosure includes: a plurality of transmission antennas including a first transmission antenna that forms a first beam and a second transmission antenna that forms a second beam different from the first beam; and transmission circuitry, which, in operation, performs multiplexing transmission of a transmission signal from the plurality of transmission antennas, the transmission signal being a signal to which a phase rotation corresponding to a combination of a Doppler shift amount and a code sequence has been applied, in which, to each of the plurality of transmission antennas, the combination in which at least one of the Doppler shift amount or the code sequence is different is associated, and a first pattern of the Doppler shift amount and the code sequence that are assigned to the first transmission antenna is different from a second pattern of the Doppler shift amount and the code sequence that are assigned to the second transmission antenna.

In one exemplary embodiment of the present disclosure, the number of the plurality of transmission antennas is less than the total number of the combinations.

In one exemplary embodiment of the present disclosure, the first pattern and the second pattern relate to an interval of the Doppler shift amount; a Doppler multiplexing number by the first transmission antenna and a Doppler multiplexing number by the second transmission antenna are identical to each other; and at least one of a plurality of the intervals of the Doppler shift amount by the first transmission antenna is different from the interval of the Doppler shift amount by the second transmission antenna.

In one exemplary embodiment of the present disclosure, the first pattern and the second pattern relate to a Doppler multiplexing number; and the Doppler multiplexing number by the first transmission antenna is different from the Doppler multiplexing number by the second transmission antenna

In one exemplary embodiment of the present disclosure, the first pattern and the second pattern relate to an order of intervals of a plurality of the Doppler shift amounts; a plurality of first Doppler shift intervals by the first transmission antenna are identical to a plurality of second Doppler shift intervals by the second transmission antenna; and an order of the plurality of first Doppler shift intervals on a Doppler frequency axis is different from an order of the plurality of second Doppler shift intervals on the Doppler frequency axis.

In one exemplary embodiment of the present disclosure, the first pattern and the second pattern relate to the code sequence; and in a plurality of the combinations, an index of the code sequence corresponding to each of the Doppler shift amounts associated with the first transmission antenna is different from an index of the code sequence corresponding to each of the Doppler shift amounts associated with the second transmission antenna.

In one exemplary embodiment of the present disclosure, the first pattern and the second pattern relate to a code multiplexing number by the code sequence; and in a plurality of the combinations, the code multiplexing number by the code sequences corresponding to the respective amounts of Doppler shift associated with the first transmission antenna is different from the code multiplexing number by the code sequences corresponding to the respective amounts of Doppler shift associated with the second transmission antenna.

In one exemplary embodiment of the present disclosure, in a plurality of the combinations, with respect to at least one of the first transmission antenna or the second transmission antenna, a code multiplexing number by the code sequence associated with at least one of a plurality of the Doppler shift amounts is different from the code multiplexing number by the code sequence associated with another Doppler shift amount.

The radar apparatus according to one exemplary embodiment of the present disclosure further includes: a plurality of reception antennas that receive a reflected wave signal resulted from the transmission signal being reflected by a target; and reception circuitry, which, in operation, performs direction estimation of the target using the reflected wave signal.

In one exemplary embodiment of the present disclosure, the radar apparatus according to further includes: a plurality of reception antennas arranged at a first interval in a first direction, in which the first transmission antennas are arranged at the first interval in the first direction and arranged at different positions in a second direction orthogonal to the first direction; the second transmission antennas are arranged at the first interval in the first direction and arranged at different positions in the second direction orthogonal to the first direction; and the first transmission antenna and the second transmission antenna are arranged at an interval larger than an aperture length of the plurality of reception antennas in the first direction.

In one exemplary embodiment of the present disclosure, the radar apparatus according to further includes: a plurality of reception antennas arranged at a first interval in a first direction, in which the first transmission antennas are arranged at a second interval in the first direction and arranged at different positions in a second direction orthogonal to the first direction; the second transmission antennas are arranged at the second interval in the first direction and arranged at different positions in the second direction orthogonal to the first direction; the first transmission antenna and the second transmission antenna are arranged at an interval larger than an aperture length of the plurality of reception antennas in the first direction; and a difference between the first interval and the second interval is a specified value based on a wavelength of the transmission signal.

In one exemplary embodiment of the present disclosure, the specified value is a value in a range of 0.45 times to 0.8 times the wavelength.

In one exemplary embodiment of the present disclosure, the first beam and the second beam are different in at least one of a beam direction or a beam width.

In one exemplary embodiment of the present disclosure, among the plurality of transmission antennas, a combination of transmission antennas used for the multiplexing transmission of the transmission signal is switched for each transmission period of the transmission signal, each period corresponding to a code length of the code sequence, or each measurement period in the radar apparatus.

The disclosure of Japanese Patent Application No. 2022-191347, filed on Nov. 30, 2022, including the specification, drawings and abstract, is incorporated herein by reference in its entirety.

### INDUSTRIAL APPLICABILITY

The present disclosure is suitable as a radar apparatus for wide-angle range sensing.

### REFERENCE SIGNS LIST

10 Radar apparatus
100 Radar transmitter
101 Radar transmission signal generator
102 Transmission signal generation controller
103 Modulation signal generator
104 VCO
105 Phase rotation amount setter
106 Doppler shift setter
107 Encoder
108 Phase rotator
109 Transmission antenna section
200 Radar receiver
201 Antenna system processor
202 Reception antenna section
203 Reception radio
204 Mixer
205 LPF
206 Signal processor
207 AD converter
208 Beat frequency analyzer
209 Output switch
210 Doppler analyzer
211 CFAR section
212 Coded Doppler demultiplexer
213 Direction estimator

1. A radar apparatus comprising:
a plurality of transmission antennas including a first transmission antenna that forms a first beam and a second transmission antenna that forms a second beam different from the first beam; and
transmission circuitry, which, in operation, performs multiplexing transmission of a transmission signal from the plurality of transmission antennas, the transmission signal being a signal to which a phase rotation corresponding to a combination of a Doppler shift amount and a code sequence has been applied,
wherein,
to each of the plurality of transmission antennas, the combination in which at least one of the Doppler shift amount or the code sequence is different is associated, and
a first pattern of the Doppler shift amount and the code sequence that are assigned to the first transmission antenna is different from a second pattern of the Doppler shift amount and the code sequence that are assigned to the second transmission antenna.

2. The radar apparatus according to claim 1, wherein:
the first pattern and the second pattern relate to an interval of the Doppler shift amount;
a Doppler multiplexing number of the transmission signal transmitted by the first transmission antenna and a Doppler multiplexing number of the transmission signal transmitted by the second transmission antenna are identical to each other; and
at least one of a plurality of the intervals of the Doppler shift amount associated with the first transmission antenna is different from the interval of the Doppler shift amount associated with the second transmission antenna.

3. The radar apparatus according to claim 1, wherein:
the first pattern and the second pattern relate to a Doppler multiplexing number; and
the Doppler multiplexing number of the transmission signal transmitted by the first transmission antenna is different from the Doppler multiplexing number of the transmission signal transmitted by the second transmission antenna.

4. The radar apparatus according to claim 1, wherein:
the first pattern and the second pattern relate to an order of intervals of a plurality of the Doppler shift amounts;
a plurality of first Doppler shift intervals between the Doppler shift amounts associated with the first transmission antenna is identical to a plurality of second Doppler shift intervals between the Doppler shift amounts associated with the second transmission antenna; and
an order of the plurality of first Doppler shift intervals on a Doppler frequency axis is different from an order of the plurality of second Doppler shift intervals on the Doppler frequency axis.

5. The radar apparatus according to claim 1, wherein:
the first pattern and the second pattern relate to the code sequence; and
in a plurality of the combinations, an order of a plurality of the code sequences associated with the first transmission antenna on a Doppler frequency axis is different from an order of the plurality of code sequences associated with the second transmission antenna on the Doppler frequency axis.

6. The radar apparatus according to claim 1, wherein:
the first pattern and the second pattern relate to a code multiplexing number by the code sequence; and
in a plurality of the combinations, an order of a plurality of the code multiplexing numbers by the code sequence associated with the first transmission antenna on a Doppler frequency axis is different from an order of the plurality of code multiplexing numbers by the code sequence associated with the second transmission antenna on the Doppler frequency axis.

7. The radar apparatus according to claim 1, wherein
in a plurality of the combinations, with respect to at least one of the first transmission antenna or the second transmission antenna, a code multiplexing number by the code sequence associated with at least one of a plurality of the Doppler shift amounts is different from the code multiplexing number by the code sequence associated with another Doppler shift amount.

8. The radar apparatus according to claim 1, further comprising:
a plurality of reception antennas that receives a reflected wave signal resulted from the transmission signal being reflected by a target; and
reception circuitry, which, in operation, performs direction estimation of the target using the reflected wave signal.

9. The radar apparatus according to claim 1, further comprising:
a plurality of reception antennas arranged at a first interval in a first direction,
wherein
antennas included in the first transmission antenna are arranged at the first interval in the first direction and arranged at different positions in a second direction orthogonal to the first direction,
antennas included in the second transmission antenna are arranged at the first interval in the first direction and arranged at different positions in the second direction orthogonal to the first direction, and
the first transmission antenna and the second transmission antenna are arranged at an interval larger than an aperture length of the plurality of reception antennas in the first direction.

10. The radar apparatus according to claim 1, further comprising:
a plurality of reception antennas arranged at a first interval in a first direction,
wherein
antennas included in the first transmission antenna are arranged at a second interval in the first direction and arranged at different positions in a second direction orthogonal to the first direction,
antennas included in the second transmission antenna are arranged at the second interval in the first direction and arranged at different positions in the second direction orthogonal to the first direction,
the first transmission antenna and the second transmission antenna are arranged at an interval larger than an aperture length of the plurality of reception antennas in the first direction, and
a difference between the first interval and the second interval is a specified value based on a wavelength of the transmission signal.

11. The radar apparatus according to claim 10, wherein
the specified value is a value in a range of 0.45 times to 0.8 times the wavelength.

12. The radar apparatus according to claim 1, wherein
among the plurality of transmission antennas, a combination of transmission antennas used for the multiplexing transmission of the transmission signal is switched for each transmission period of the transmission signal, each period corresponding to a code length of the code sequence, or each measurement period in the radar apparatus.

13. A method for transmitting a radar signal, the method comprising:
applying a phase rotation amount corresponding to a combination of a Doppler shift amount and a code sequence to the radar signal; and
performing, from a plurality of transmission antennas, multiplexing transmission of the radar signal to which the phase rotation amount is applied,
wherein
the plurality of transmission antennas includes a first transmission antenna that forms a first beam and a second transmission antenna that forms a second beam different from the first beam,
to each of the plurality of transmission antennas, the combination in which at least one of the Doppler shift amount or the code sequence is different is associated, and
a first pattern of the Doppler shift amount and the code sequence that are assigned to the first transmission antenna is different from a second pattern of the Doppler shift amount and the code sequence that are assigned to the second transmission antenna.

14. The method according to claim 13, wherein:
the first pattern and the second pattern relate to an interval of the Doppler shift amount;
a Doppler multiplexing number of the radar signal transmitted by the first transmission antenna and a Doppler multiplexing number of the radar signal transmitted by the second transmission antenna are identical to each other; and
at least one of a plurality of the intervals of the Doppler shift amount associated with the first transmission antenna is different from the interval of the Doppler shift amount associated with the second transmission antenna.

15. The method according to claim 13, wherein:
the first pattern and the second pattern relate to a Doppler multiplexing number; and
the Doppler multiplexing number of the radar signal transmitted by the first transmission antenna is different from the Doppler multiplexing number of the radar signal transmitted by the second transmission antenna.

16. The method according to claim 13, wherein:
the first pattern and the second pattern relate to an order of intervals of a plurality of the Doppler shift amounts;
a plurality of first Doppler shift intervals between the Doppler shift amounts associated with the first transmission antenna is identical to a plurality of second Doppler shift intervals between the Doppler shift amounts associated with the second transmission antenna; and
an order of the plurality of first Doppler shift intervals on a Doppler frequency axis is different from an order of the plurality of second Doppler shift intervals on the Doppler frequency axis.

17. A method for receiving a radar signal, the method comprising:
receiving, by a plurality of reception antennas, a reflected wave signal resulted from the radar signal transmitted by the method according to claim 15 being reflected by a target; and
performing direction estimation of the target using the reflected wave signal.

18. A radar signal processing apparatus comprising:
application circuitry, which, in operation, applies a phase rotation amount corresponding to a combination of a Doppler shift amount and a code sequence to a radar signal; and
transmission circuitry, which, in operation, performs, from a plurality of transmission antennas, multiplexing transmission of the radar signal to which the phase rotation amount is applied,
wherein
the plurality of transmission antennas includes a first transmission antenna that forms a first beam and a second transmission antenna that forms a second beam different from the first beam,
to each of the plurality of transmission antennas, the combination in which at least one of the Doppler shift amount or the code sequence is different is associated, and
a first pattern of the Doppler shift amount and the code sequence that are assigned to the first transmission antenna is different from a second pattern of the Doppler shift amount and the code sequence that are assigned to the second transmission antenna.

19. The radar signal processing apparatus according to claim 18, wherein:
the first pattern and the second pattern relate to an interval of the Doppler shift amount;
a Doppler multiplexing number of the radar signal transmitted by the first transmission antenna and a Doppler multiplexing number of the radar signal transmitted by the second transmission antenna are identical to each other; and
at least one of a plurality of the intervals of the Doppler shift amount associated with the first transmission antenna is different from the interval of the Doppler shift amount associated with the second transmission antenna.

20. A radar signal processing apparatus, wherein:
the radar signal processing apparatus receives, by a plurality of reception antennas, a reflected wave signal resulted from the radar signal transmitted from the radar signal processing apparatus according to claim 18 being reflected by a target, and performs direction estimation of the target using the reflected wave signal.
